(19) United States
(12) Patent Application Publication
(10) Pub. No.: US 2006/0131118 A1
(43) Pub. Date: Jun. 22, 2006

(54) Oil shock absorber

(76) Inventor: Tan-Cheng Huang, Taichung City (TW)

Correspondence Address: CHARLES E. BAXLEY, ESQ., 90 JOHN STREET, THIRD FLOOR, NEW YORK, NY, 10038, US

(21) Appl. No.: 11/020,922

(22) Filed: Dec. 22, 2004

(51) Int. Cl. F16F 9/00

(52) U.S. Cl. 188/313

(57) ABSTRACT

An oil shock absorber comprising a control assembly, a moving assembly, a damper assembly and a buffering spring, the buffering spring serving to provide elastic buffering force for respective components of the oil shock absorber, the user can adjust buffering force of the oil shock absorber and also can turn the oil shock absorber on or off according real road condition, at any time.

### BACKGROUND OF THE INVENTION

1. Field of the Invention

The present invention relates to a shock absorber, and more particularly to an oil shock absorber that is used on bicycle or on machinery.

2. Description of the Prior Arts

The conventional shock absorber used on the bike usually uses inner spring cooperating with cylinder base and other components to produce a shock-absorbing effect (whether the operation space for the inner spring is filled with hydraulic oil is not the essential condition of the present invention, further discussions on this matter would be omitted). A conventional shock absorber, used on the bike, includes basement, axial shaft and shock-absorbing spring, which are to be explained below. The basement is mounted to the fork of the bike, while the axial shaft is mounted on the frame of the bike. The shock-absorbing spring is biased between the basement and the axial shaft. This kind of shock absorber has been used on different kinds of mechanisms and bikes, yet there are still some defects need to be improved as follows:

First, the conventional shock absorber only has the buffering function, and the buffering function cannot be disabled. Thereby, when riding up a slope, the up-and-down motion of the shock absorber will increase the drag force because the motion of the shock absorber counteracts the pressing force applied by the user.

Second, the conventional shock absorber only has the buffering function, but the buffering function cannot be disabled. When riding down a slope, the up-and-down motion of the shock absorber will change the front tilt angle of the bike, especially when the front shocker is moving downward, the front tilt angle of the bike is much increased. Thereby, there is a danger of falling over.

Third, the buffering force of the conventional shock absorber is adjusted by an adjusting screw, but it only can be done when the bicycle is not running. That is to say that the buffering force of the conventional shock absorber cannot be adjusted momentarily in response to the real road condition when the bicycle is running.

The present invention has arisen to mitigate and/or obviate the afore-described disadvantages.

### SUMMARY OF THE INVENTION

The primary object of the present invention is to provide an oil shock absorber which enables the user to adjust the buffering force according to the real road condition, when riding on a flat road, the user can adjust the buffering force of the oil shock absorber to a low level by using the steel cord. When ridding on an uneven road, the user can adjust the buffering force of the oil shock absorber to a high level by using the steel cord. If the road surface is more uneven, the user can set the buffering force at higher level by using the steel cord, in this case, when the oil shock absorber moves downward, the downward compressing force will be counteracted by the elastic force of the buffering spring and the oil flow resistance, when the oil shock absorber moves upward, the oil flow resistance is increased so as to absorb the vibration of the bicycle. Through this way, the downward and the upward buffering resistance of the oil shock absorber can enable the rider to ride stably in a more uneven road.

The secondary object of the present invention is to provide an oil shock absorber which can be turned on or off when the bicycle is moving, when riding up a slope, the user can set the oil shock absorber at “off” state so as to prevent the drag force being increased by the up and down motion of the shock absorber. When riding on a flat road, it can be turned on again. When riding a slope, the user can set the oil shock absorber at “off” state so as to prevent the increase of the front tilt angle of the bike and leading to turnover.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of an oil shock absorber in accordance with a first embodiment of the present invention;

FIG. 2 is a cross sectional view of the oil shock absorber in accordance with the first embodiment of the present invention, wherein the valve port is completely opened when the oil shock absorber moves downward;

FIG. 3 is an enlarged cross sectional view of the oil shock absorber in accordance with the first embodiment of the present invention, wherein the valve port is completely opened when the oil shock absorber moves downward;

FIG. 4 is a cross sectional view of the oil shock absorber in accordance with the first embodiment of the present invention, wherein the valve port is completely opened when the oil shock absorber moves upward;

FIG. 5 is an enlarged cross sectional view of the oil shock absorber in accordance with the first embodiment of the present invention, wherein the valve port is completely opened when the oil shock absorber moves upward;

FIG. 6 is a cross sectional view of the oil shock absorber in accordance with the first embodiment of the present invention, wherein the valve port is closed to a certain extent to reduce its opening size when the oil shock absorber moves downward;

FIG. 7 is an enlarged cross sectional view of the oil shock absorber in accordance with the first embodiment of the present invention, wherein the valve port is closed to a certain extent to reduce its opening size when the oil shock absorber moves downward;

FIG. 8 is a cross sectional view of the oil shock absorber in accordance with the first embodiment of the present invention, wherein the valve port is closed to a certain extent to reduce its opening size when the oil shock absorber moves upward;

FIG. 9 is an enlarged cross sectional view of the oil shock absorber in accordance with the first embodiment of the present invention, wherein the valve port is closed to a certain extent to reduce its opening size when the oil shock absorber moves upward;

FIG. 10 is a cross sectional view of the oil shock absorber in accordance with the first embodiment of the present invention, wherein the valve port is closed to a great extent to further reduce its opening size when the oil shock absorber moves downward;

FIG. 11 is an enlarged cross sectional view of the oil shock absorber in accordance with the first embodiment of the present invention, wherein the valve port is closed to a certain extent to reduce its opening size when the oil shock absorber moves downward;

FIG. 12 is a cross sectional view of the oil shock absorber in accordance with the first embodiment of the present invention, wherein the valve port is closed to a great extent to further reduce its opening size when the oil shock absorber moves upward;

FIG. 13 is an enlarged cross sectional view of the oil shock absorber in accordance with the first embodiment of the present invention, wherein the valve port is closed to a certain extent to reduce its opening size when the oil shock absorber moves upward;

FIG. 14 is a cross sectional view of the oil shock absorber in accordance with the first embodiment of the present invention, wherein the oil shock absorber is turned off;

FIG. 15 is an enlarged cross sectional view of the oil shock absorber in accordance with the first embodiment of the present invention, wherein the oil shock absorber is turned off;

FIG. 16 is an exploded view of an oil shock absorber in accordance with a second embodiment of the present invention;

FIG. 17 is a cross sectional view of an oil shock absorber in accordance with the second embodiment of the present invention;

FIG. 18a is an enlarged cross sectional view of showing a control assembly of the oil shock absorber in accordance with the second embodiment of the present invention;

FIG. 18b is an enlarged cross sectional view of showing a damper assembly and a moving assembly of the oil shock absorber in accordance with the second embodiment of the present invention;

FIG. 18c is an enlarged cross sectional view of showing a damper assembly of the oil shock absorber in accordance with the second embodiment of the present invention;

FIG. 19 is a cross sectional view of the oil shock absorber in accordance with the second embodiment of the present invention, wherein the valve port is completely opened when the oil shock absorber moves downward;

FIG. 20 is an enlarged cross sectional view of the oil shock absorber in accordance with the second embodiment of the present invention, wherein the valve port is completely opened when the oil shock absorber moves downward;

FIG. 21 is an enlarged cross sectional view of the oil shock absorber in accordance with the second embodiment of the present invention, wherein the valve port is completely opened when the oil shock absorber moves upward;

FIG. 22 is a cross sectional view of the oil shock absorber in accordance with the second embodiment of the present invention, wherein the valve port is closed to a certain extent to reduce its opening size when the oil shock absorber moves downward;

FIG. 23 is an enlarged cross sectional view of the oil shock absorber in accordance with the second embodiment of the present invention, wherein the valve port is closed to a certain extent to reduce its opening size when the oil shock absorber moves downward;

FIG. 24 is an enlarged cross sectional view of the oil shock absorber in accordance with the second embodiment of the present invention, wherein the valve port is closed to a certain extent to reduce its opening size when the oil shock absorber moves upward;

FIG. 25 is a cross sectional view of the oil shock absorber in accordance with the second embodiment of the present invention, wherein the valve port is closed to a great extent to further reduce its opening size when the oil shock absorber moves downward;

FIG. 26 is an enlarged cross sectional view of the oil shock absorber in accordance with the second embodiment of the present invention, wherein the valve port is closed to a certain extent to reduce its opening size when the oil shock absorber moves downward;

FIG. 27 is a cross sectional view of the oil shock absorber in accordance with the second embodiment of the present invention, wherein the valve port is closed to a great extent to further reduce its opening size when the oil shock absorber moves upward;

FIG. 28 is an enlarged cross sectional view of the oil shock absorber in accordance with the second embodiment of the present invention, wherein the valve port is closed to a certain extent to reduce its opening size when the oil shock absorber moves upward;

FIG. 29 is a cross sectional view of the oil shock absorber in accordance with the second embodiment of the present invention, wherein the oil shock absorber is turned off;

FIG. 30 is an enlarged cross sectional view of the oil shock absorber in accordance with the second embodiment of the present invention, wherein the oil shock absorber is turned off;

FIG. 31 is an exploded view of an oil shock absorber in accordance with a third embodiment of the present invention;

FIG. 32 is a cross sectional view of an oil shock absorber in accordance with the third embodiment of the present invention;

FIG. 33 is an exploded view of an oil shock absorber in accordance with a fourth embodiment of the present invention;

FIG. 34 is a cross sectional view of an oil shock absorber in accordance with the fourth embodiment of the present invention;

FIG. 35 is an exploded view of an oil shock absorber in accordance with a fifth embodiment of the present invention;

FIG. 36 is a cross sectional view of an oil shock absorber in accordance with the fifth embodiment of the present invention;

FIG. 36a is an exploded view of showing the storage hole in the control assembly and the tool to be stored in the storage hole;

FIG. 37 is an exploded view of an oil shock absorber in accordance with a sixth embodiment of the present invention;

FIG. 38 is a cross sectional view of an oil shock absorber in accordance with the sixth embodiment of the present invention;

FIG. 39 is an exploded view of an oil shock absorber in accordance with a seventh embodiment of the present invention;

FIG. 40 is a cross sectional view of an oil shock absorber in accordance with the seventh embodiment of the present invention;

FIG. 41 is an exploded view of an oil shock absorber in accordance with an eighth embodiment of the present invention;

FIG. 42 is a cross sectional view of the oil shock absorber in accordance with the eighth embodiment of the present invention;

FIG. 43 is an exploded view of an oil shock absorber in accordance with a ninth embodiment of the present invention;

FIG. 44 is a cross sectional view of the oil shock absorber in accordance with the ninth embodiment of the present invention;

FIG. 45 is an exploded view of an oil shock absorber in accordance with a tenth embodiment of the present invention;

FIG. 46 is a cross sectional view of the oil shock absorber in accordance with the tenth embodiment of the present invention;

FIG. 47 is an exploded view of an oil shock absorber in accordance with an eleventh embodiment of the present invention;

FIG. 48 is a cross sectional view of the oil shock absorber in accordance with the eleventh embodiment of the present invention;

FIG. 49 is an exploded view of an oil shock absorber in accordance with a twelfth embodiment of the present invention;

FIG. 50 is a cross sectional view of the oil shock absorber in accordance with the twelfth embodiment of the present invention;

FIG. 51 is an exploded view of an oil shock absorber in accordance with a thirteenth embodiment of the present invention;

FIG. 52 is a cross sectional view of the oil shock absorber in accordance with the thirteenth embodiment of the present invention;

FIG. 53 is an exploded view of an oil shock absorber in accordance with a fourteenth embodiment of the present invention;

FIG. 54 is a cross sectional view of the oil shock absorber in accordance with the fourteenth embodiment of the present invention, wherein the valve port is closed to a certain extent to reduce its opening size when the oil shock absorber moves upward;

FIG. 55 is an enlarged cross sectional view of the oil shock absorber in accordance with the fourteenth embodiment of the present invention, wherein the valve port is closed to a certain extent to reduce its opening size when the oil shock absorber moves upward;

FIG. 56 is a cross sectional view of the oil shock absorber in accordance with the fourteenth embodiment of the present invention, wherein the oil shock absorber is turned off;

FIG. 57 is an enlarged cross sectional view of the oil shock absorber in accordance with the fourteenth embodiment of the present invention, wherein the oil shock absorber is turned off;

FIG. 58 is a cross sectional view of the oil shock absorber in accordance with the fourteenth embodiment of the present invention, wherein the valve port is completely opened when the oil shock absorber moves downward;

FIG. 59 is an enlarged cross sectional view of the oil shock absorber in accordance with the fourteenth embodiment of the present invention, wherein the valve port is completely opened when the oil shock absorber moves downward;

FIG. 60 is an exploded view of an oil shock absorber in accordance with a fifteenth embodiment of the present invention;

FIG. 61 is a cross sectional view of the oil shock absorber in accordance with the fifteenth embodiment of the present invention;

FIG. 62 is an exploded view of an oil shock absorber in accordance with a sixteenth embodiment of the present invention;

FIG. 63 is a cross sectional view of the oil shock absorber in accordance with the sixteenth embodiment of the present invention;

FIG. 64 is an exploded view of an oil shock absorber in accordance with a seventeenth embodiment of the present invention;

FIG. 65 is a cross sectional view of the oil shock absorber in accordance with the seventeenth embodiment of the present invention;

FIG. 66 is an exploded view of an oil shock absorber in accordance with an eighteenth embodiment of the present invention;

FIG. 67 is a cross sectional view of the oil shock absorber in accordance with the eighteenth embodiment of the present invention;

FIG. 68 is an exploded view of an oil shock absorber in accordance with a nineteenth embodiment of the present invention;

FIG. 69 is a cross sectional view of the oil shock absorber in accordance with the nineteenth embodiment of the present invention;

FIG. 70 is an exploded view of an oil shock absorber in accordance with a twentieth embodiment of the present invention;

FIG. 71 is a cross sectional view of the oil shock absorber in accordance with the twentieth embodiment of the present invention;

FIG. 72 is an exploded view of an oil shock absorber in accordance with a twenty-first embodiment of the present invention;

FIG. 73 is a cross sectional view of the oil shock absorber in accordance with the twenty-first embodiment of the present invention;

FIG. 74 is an exploded view of an oil shock absorber in accordance with a twenty-second embodiment of the present invention;

FIG. 75 is a cross sectional view of the oil shock absorber in accordance with the twenty-second embodiment of the present invention;

FIG. 76 is an exploded view of an oil shock absorber in accordance with a twenty-third embodiment of the present invention;

FIG. 77 is a cross sectional view of the oil shock absorber in accordance with the twenty-third embodiment of the present invention;

FIG. 78 is an exploded view of an oil shock absorber in accordance with a twenty-fourth embodiment of the present invention;

FIG. 79 is a cross sectional view of the oil shock absorber in accordance with the twenty-fourth embodiment of the present invention;

FIG. 80 is an enlarged cross sectional view of showing another structure of the valve of the oil shock absorber in accordance with a twenty-fifth embodiment of the present invention;

FIG. 81 is an enlarged cross sectional view of showing another structure of the valve of the oil shock absorber in accordance with a twenty-sixth embodiment of the present invention;

FIG. 82 is an enlarged view in accordance with a twenty-seventh embodiment of the present invention of showing the sliding components coated with friction-resistant material;

FIG. 83 is an exploded view of showing the piston unit of the oil shock absorber in accordance with a twenty-eighth embodiment of the present invention;

FIG. 84 is an enlarged cross sectional view of showing the piston unit of the oil shock absorber in accordance with a twenty-eighth embodiment of the present invention;

FIG. 85 is an exploded view of showing another structure of check valve of the piston unit in accordance with a twenty-ninth embodiment of the present invention;

FIG. 86 is an enlarged cross sectional view of showing another structure of check valve of the piston unit in accordance with a twenty-ninth embodiment of the present invention;

FIG. 87 is an exploded view of showing a steel cord positioning assembly in accordance with a thirtieth embodiment of the present invention;

FIG. 88 is an assembly cross sectional view of showing the steel cord positioning assembly in accordance with the thirtieth embodiment of the present invention;

FIG. 89 is an operational view of showing the steel cord positioning assembly in accordance with the thirtieth embodiment of the present invention.

### DETAILED DESCRIPTION OF THE PREFERRED EMBODIMENTS

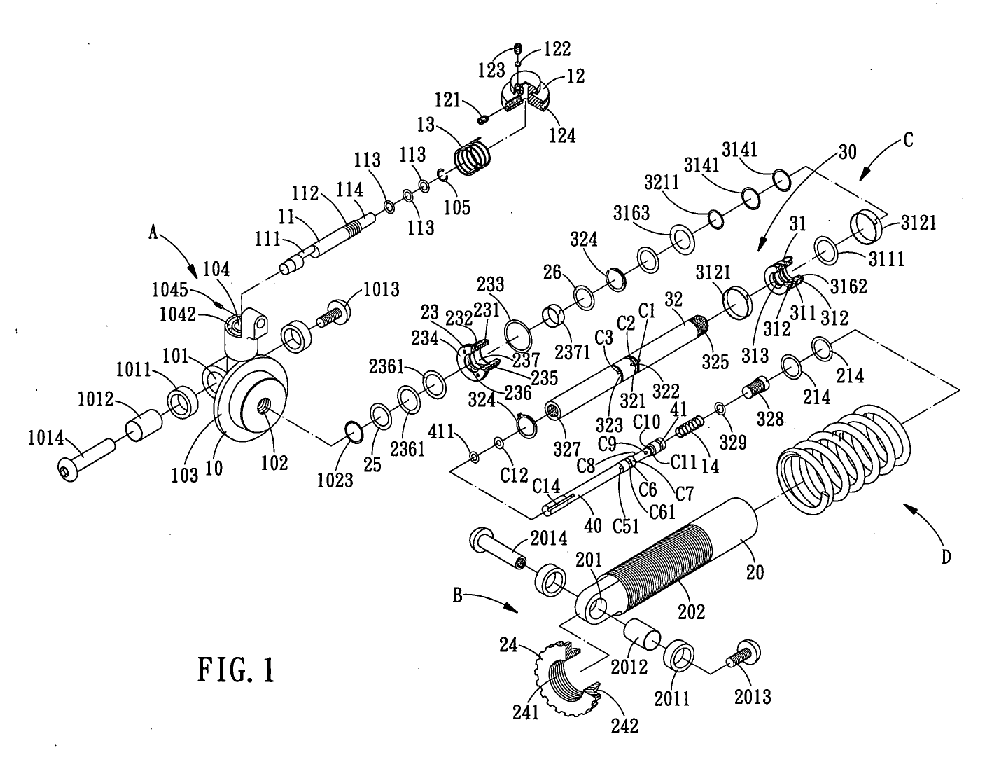

Referring to FIGS. 1-15, a shock absorber used on a bicycle is shown and comprises a control assembly A, a damper assembly B, a moving assembly C and a buffering spring D.

The control assembly A includes a base 10, a control shaft 11, a rotary button 12, a return spring 13, a control spring 14.

The base 10 is provided at an end with a pivoting hole 101 in which are disposed a cushion 1011 and a sleeve 1012, and then the base 10 is mounted on a bicycle by a pivot 1014 inserted through the pivoting hole 101 and screwed with a screw 1013. At another end of the base 10 opposite the pivoting hole 101 is a threaded hole 102. At the bottom of the threaded hole 102 are formed an inner flange 1021 and an annular groove 1022. In the annular groove 1022 is received an oil seal 1023. A spring retaining portion 103 is formed at the end of the threaded hole 102 of the base 10.

The base 10 is interiorly formed with a control hole 104 which is vertical to and in communication with the threaded hole 102. At an end of the control hole 104 opposite the threaded hole 102 is an inner annular groove 1041 in which is received a retainer 105. Adjacent to the inner annular groove 1041 is a recess 1042 at the bottom of which is formed a spring-fixing hole 1043. A positioning threaded hole 1044 is provided at a side of the recess 1042 in which is screwed a positioning bolt 1045.

The control shaft 11, at an end of which is formed an eccentric abutting portion 111, and at another end of which are provided a plurality of annular grooves 112 for accommodation of a plurality of a plurality of oil seals 113. A step portion 114 is formed on the control shaft 11 and located close to the annular groove 112. The control shaft 11 is rotatably disposed in the control hole 104 of the base 10 by cooperating with the oil seals 113, and confined therein by a retainer 105. The lower portion of the step portion 114 of the control shaft 11 is positioned in the retainer 105, and an end of the control shaft 11 protrudes out of the control hole 104.

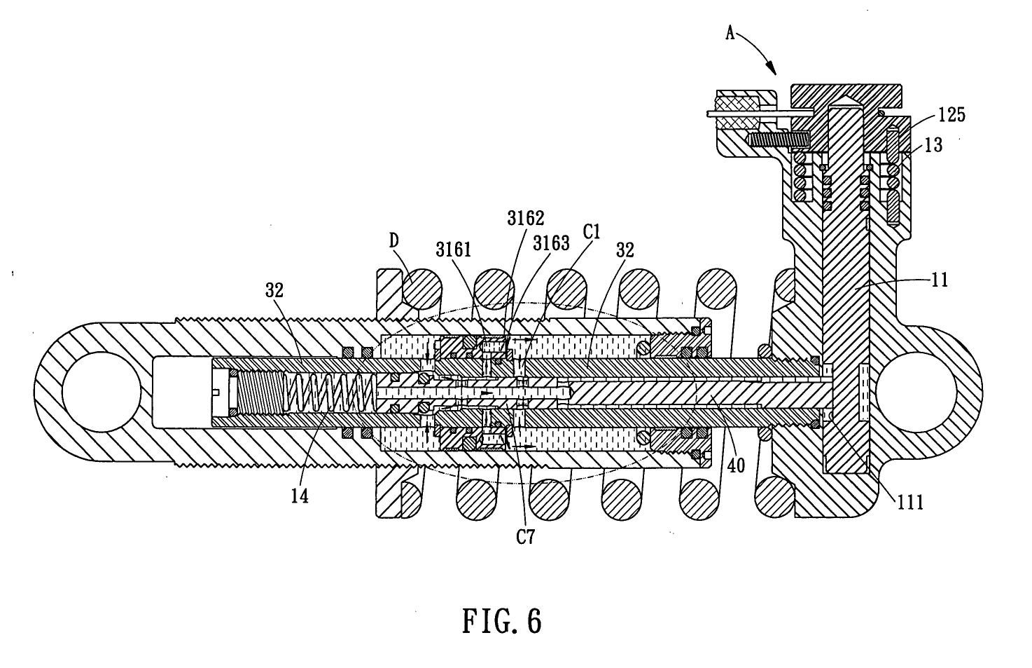

The rotary button 12 is positioned on the step portion 114 of the control shaft 11 by a screw 121. An end of the rotary button 12 is connected with steel cord (not shown) via a positioning washer 122 and a positioning screw 123 (the steel cord is controlled by the user, and the rotary button 12 can rotate after being pulled by the steel cord). A positioning arc groove 124 is formed on the rotary button 12 in response to the positioning bolt 1045 of the base 10, so that the positioning bolt 1045 and the positioning arc groove 124 are used to limit the rotation angle of the rotary button 12. At the bottom of the rotary button 12 is also provided a spring-fixing hole 125 (as shown in FIG. 6).

The return spring 13 is received in the recess 1042 of the base 10 with an end positioned in the spring-fixing hole 1043 and another end positioned in the spring-fixing hole 125 of the rotary button 12.

The control spring 14 is caused to be compressed or released by the rotation of the eccentric abutting portion 111 of the control shaft 11.

The damper assembly B includes a housing 20, an oil cylinder 21, a first leak proof member 22, a second leak proof member 23 and an adjust ring 24. Between the control assembly A and the damper assembly B is a first anti-collision cushion 25.

The housing 20 is provided at an end thereof with a pivoting hole 201 in which disposed a washer 2011 and a sleeve 2012, and through the pivoting hole 201 the hosing 20 is fixed on the frame of a bicycle by screws 2013 and bolts 2014. On the outer periphery of the housing 20 are provided a plurality of outer threads 202.

The oil cylinder 21 is formed in the housing 20, at an end of the oil cylinder 21 are provided a plurality of inner threads 211, and at the bottom of the oil cylinder 21 is formed an inner step hole 212. On the sidewall of the inner step hole 212 are formed two annular grooves 213 in each of which is disposed an oil seal 214. Thus forming the first leak proof member 22.

The second leak proof member 23 is provided on its outer periphery with outer threads 231 and annular grooves 232. In each of the annular grooves 232 is disposed an oil seal 233, and adjacent the outer threads 231 is an annular flange 234. The outer threads 231 of the second leak proof ember 23 is screwed with the inner threads 211 in the oil cylinder 21 by cooperating with an oil seal 233 in such a manner that the annular flange 234 is positioned at the terminal end of the oil cylinder 21 of the housing 20. On the inner periphery 235 of the second leak proof member 23 are provided annular grooves 236 and annular recess 237. In each of the annular grooves 236 is disposed an oil seal 2361, and in the annular recess 237 is disposed a friction ring 2371.

The adjust ring 24 is interiorly provided with inner threads 241 through which the adjust ring 24 is screwed with the outer threads 202 of the housing 20, and at an end of the adjust ring 24 is formed a spring retaining portion 242.

The moving assembly C includes a piston unit 30 and a control valve rod 40.

The piston unit 30 further includes a piston 31 and a shaft 32 which are moveably disposed in the oil cylinder 21 of the damper assembly B.

On the outer periphery of the piston 31 are provided an annular groove 311 and two annular recesses 312. In the annular groove 311 is disposed an oil seal 3111, and in each of the annular recesses 312 is disposed a friction ring 3121. The piston 31 is tight but moveably disposed in the oil cylinder 21 of the damper assembly B by virtue of the oil seal 3111 and the friction rings 3121. In the piston 31 is formed a bore 313 in which are provided two annular grooves 314 and an oil passage 315. In each of the annular grooves 314 is disposed an oil seal 3141, at an end of the piston 31 is provided a check valve unit 316 comprising a check valve port 3161, a close surface 3162 and a valve 3163. An end of the check valve port 3161 is in communication with the oil passage 315, and another end of the check valve port 3161 is formed with the close surface 3162. Close to the close surface 3162 is the valve 3163 that is used to close and open the check valve port 3161. The check valve port 3161 is open if the valve 3163 moves away from the close surface 3162.

Close to the mid of the shaft 32 is an annular groove 321 and two engaging grooves 322, 323. In the annular groove 321 is disposed an oil seal 3211, the shaft 32 is inserted in the bore 313 of the piston 31, and the piston 31 is positioned between the engaging grooves 322, 323 of the shaft 32 by two retainer rings 324. Meanwhile, the retainer rings 324 also position the valve 3163 of the check valve unit 316 of the piston 31. The oil seals 3141 in the piston 31 and the oil seal 3211 on the shaft 32 ensure a tight contact between the piston 31 and the shaft 32, and this tight contact is further improved by the first and the second leak proof members 22, 23, including the oil seals 214, 2361 and the friction rings 2371 thereof. At an end of the shaft are provided first outer threads 325, and at the end of the first outer threads 325 is formed a step portion 3251. The first outer threads 325 are screwed with the threaded hole 102 of the base 10 of the control assembly A in such a manner that the end of the shaft 32 is positioned by the inner flange 1021 in the threaded hole 102 of the control assembly A, and the step portion 3251 comes into tight contact with the oil seal 1023 in the annular groove 1022 of the threaded hole 102 of the base 10. The shaft 32 is formed with a bore 326, and at another end of the shaft 32 opposite the first outer threads 325 are formed inner threads 327 for screwed with a leak proof screw 328 and an oil seal 329. The control spring 14 of the control assembly A is disposed in the bore 326 of the shaft 32 with an end biased against the end of the leak proof screw 328. A first guiding hole C1 is provided beside the engaging groove 322 on the shaft 32 and located on the side of the valve 3163 of the check valve unit 316 of the piston 31. Next to the first guiding hole C1 is a second guiding hole C2 which is located in line with the annular oil passage 315 of the piston 31. A third guiding hole C3 is located on the side of the engaging groove 323. Yet a main oil passage C4 is disposed in the bore 326 of the shaft 32 and located between the second and the third guiding holes C2 and C3. The main oil passage C4 is provided with an inner flange C41 located on the side of the third guiding hole C3, so that the bore 326 of the shaft 32 is divided by the inner flange C41 into a big bore 3261 and a small bore 3262. The conjunction between the big bore 3261 and a small bore 3262 is a valve port 3263.

The control valve rod 40 is slidably disposed in the bore 326 of the shaft 32, an end of the control valve rod 40 extends out of the bore 326 to abut against the eccentric abutting portion 111 of the control shaft 11 of the control assembly A, so that the eccentric abutting portion 111 of the control shaft 11 can push the control valve rod 40 to move. Another end of the control valve rod 40 abuts against an end of the control spring 14 of the control assembly A (another end of the control spring 14 is biased against the leak proof screw 328). At an end of the outer periphery of the control valve rod 40, facing the control spring 14, is provided with an annular groove 41 in which is disposed an oil seal 411, so as to bring the control shaft 40 into tight contact with the bore 326 of the shaft 32. Still at this end of the inner periphery of the control valve rod 40 is formed an oil guiding passage C5. On the control valve rod 40 is formed a through hole C51 which is located at the end of the oil guiding passage C5. On the control valve rod 40 adjacent to the through hole C51 is a first oil guiding hole C6 which is arranged in line with the first guiding hole C1 of the shaft 32. At first oil deflector C61 is located outside the first oil guiding hole C6, which allows the first oil guiding hole C6 to communicate with the first guiding hole C1 of the shaft 32.

On the outer periphery of the control valve rod 40 and adjacent to the first oil guiding hole C6 is a first holding portion C7 corresponding to the first guiding hole C1 of the shaft 32, so that the displacement of the control valve rod 40 can enable the first holding portion C7 to adjust the opening size of the first guiding hole C1. On the outer periphery of the control valve rod 40 and adjacent to the first holding portion C7 is formed a second oil deflector C8 which is located in line with the main oil passage C4 of the shaft 32. A second oil guiding hole C9 is formed on the control valve rod 40 and located in line with the second oil deflector C8. The second oil deflector C8 increases the oil-flowing space of the main oil passage C4 of the shaft 32, makes the second oil guiding hole C9 communicate with the main oil passage C4 of the shaft 32. Still on the control valve rod 40 and adjacent to the second oil guiding hole C9 is formed a second holding portion C10 located in line with the main oil passage C4 of the shaft 32, and by controlling the displacement of the control valve rod 40, the second holding portion C10 can be caused change the size of the oil-flowing space of the main oil passage C4. Next to the second holding portion C10 is an annular groove C11 in which is received an oil seal C12 in response to the valve port 3263 of the inner flange C41 of the main oil passage C4, thus forming a valve C13.

When the control valve rod 40 moves, the oil seal C12 of the valve C13 is caused to abut against the valve port 3263 in the bore 326 of the shaft 32, thus closing the main oil passage C4. At an end of the outer periphery of the control valve rod 40 and neighboring the eccentric abutting portion 111 of the control shaft 11 is provided an oil guiding clearance C14 which cooperates with the oil guiding passage C5 and the through hole C51, so as to enable the control valve rod 40 to move within the bore 326 of the shaft 32 under the condition that there is no oil pressure resistance.

The buffering spring d is biased between the spring retaining portion 103 on the base 10 of the control assembly A and the spring retaining portion 242 on the adjust ring 24 of the housing 20 of the damper assembly B.

For better understanding of the operation and function of the invention, please refer again to the respective figures of the first embodiment.

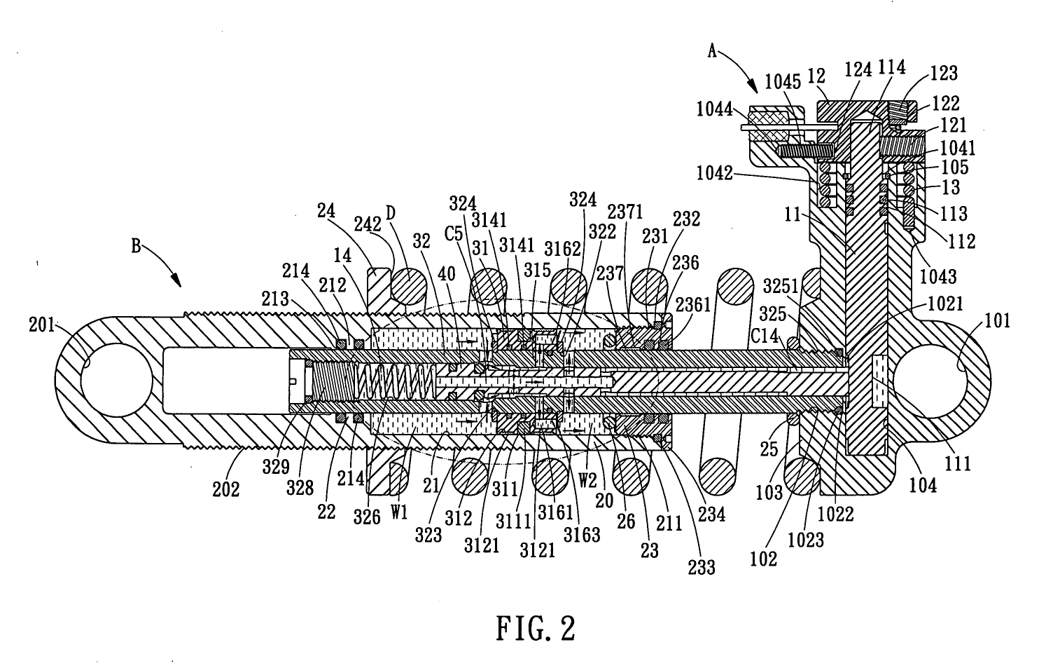

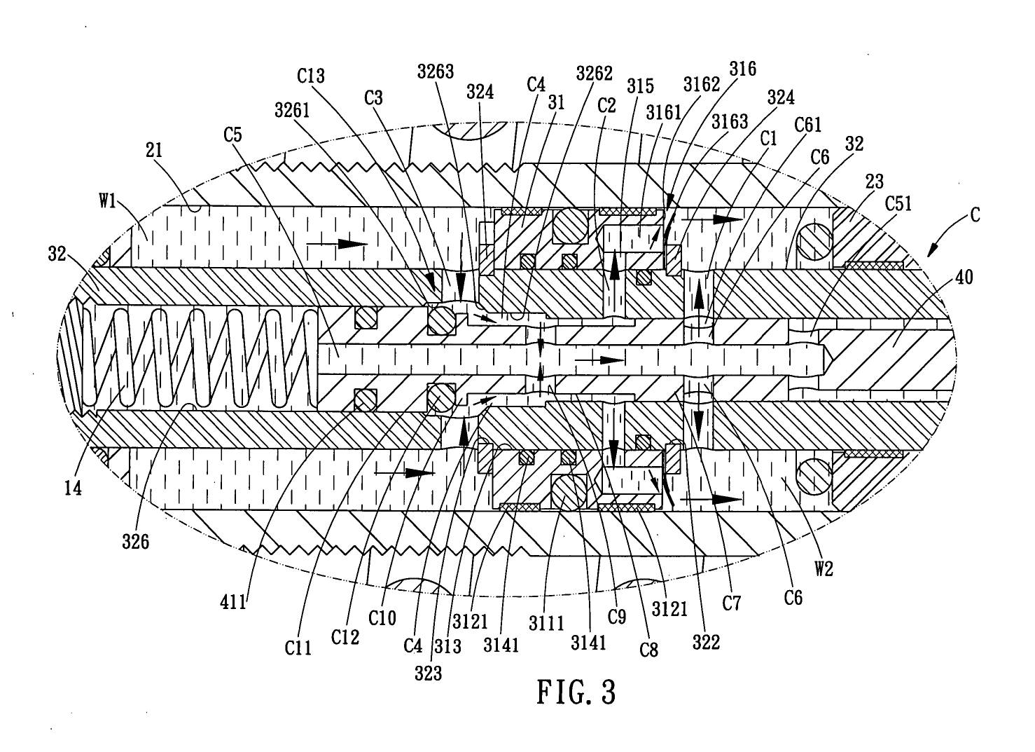

Referring initially to FIGS. 2 and 3, when riding on a flat road, the user can adjust the buffering force of the oil shock absorber to a low level by using the steel cord. The rotary button 12 will rotate when the steel cord is pulled, the rotary button 12 compresses the return spring 13 and drives the control shaft 11 to rotate. The eccentric abutting portion 111 of the control shaft pushes the control valve rod 40 of the moving assembly C to move, and meanwhile, compresses the control spring 14 of the control assembly A. The movement of the control valve rod 40 makes the first holding portion C7 move to the side of the first guiding hole C1 of the shaft 32, at this moment, the opening size of the first guiding hole C1 is maximized. When the oil shock absorber moves downward (the buffering spring D stores energy after being compressed), the piston 31 of the moving assembly C, the oil seal 3111 and the friction ring 3121 will move within the oil cylinder 21 of the damper assembly B. The shaft 32 at both ends of the piston 31 will move relative to the oil seals 214, 2361 of the first and the second leak proof members 22, 23 of the damper assembly B. Thereby, the oil in the first oil chamber W1 will be pressed by the piston 31 and flow to the second oil chamber W2 via the third guiding hole C3, the valve port 3263, the main oil passage C4, the second guiding hole C2, the oil passage 315 and the check valve port 3161, respectively (the oil pressure pushes the valve 3163 of the check valve unit 316 of the piston 31 to move away from the close surface 3162 of the valve port 3161). At the same time, the oil also flows to the second oil chamber W2 through the main oil passage C4, the second oil hole C9 of the control valve rod 40, the oil guiding passage C5, the first oil guiding hole C6 and the first guiding hole C1 of the shaft 32. At this moment, the oil flow resistance caused by the downward motion of the oil shock absorber is small, only the buffering spring D is used to absorb shock.

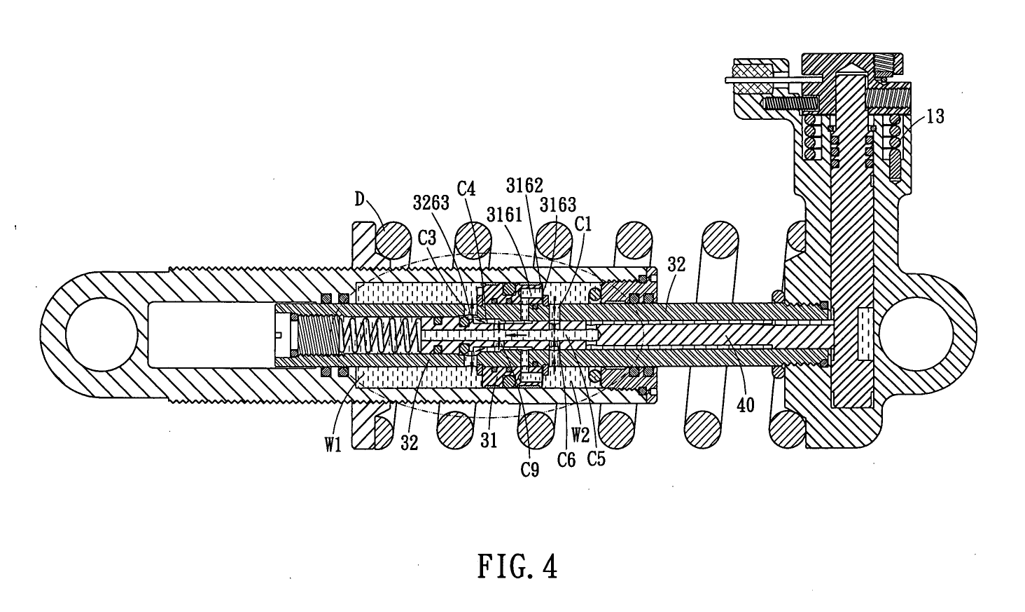

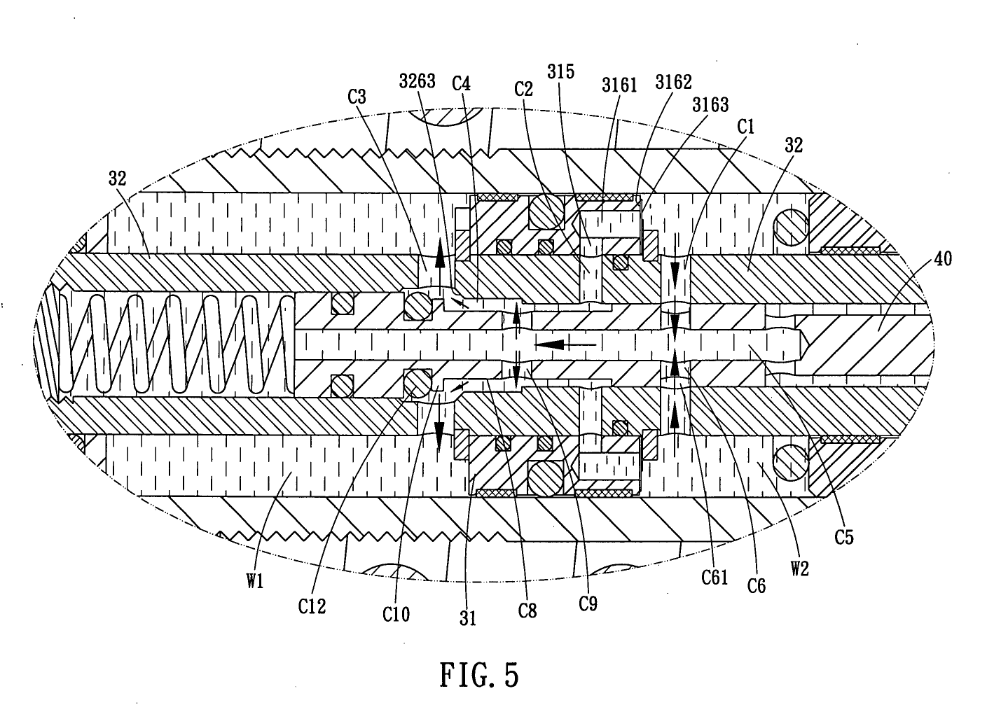

Referring to FIGS. 4 and 5, when the oil shock absorber moves upward under the effect of the elastic force of the buffering spring D, the oil in the second oil chamber W2, under the effect of the pressure caused by upward motion of the piston 31 as well as the elastic force of the valve 3163, will push the valve 3163 toward the close surface 3162 of the check valve port 3161 so as to close the check valve port 3161. At this moment, the oil can flow to the first oil chamber W1 only through the first guiding hole C1, the first guiding hole C6, the oil guiding passage C5, the second oil guiding hole C9 of the control valve rod 40, and the main oil passage C4, the valve port 3263 of the third guiding hole C3 of the shaft 32. Since the oil only flows through the first guiding hole C1 of the shaft 32, the oil flow resistance within the oil shock absorber will produce a buffering force in an opposite direction to the elastic force of the buffering spring D.

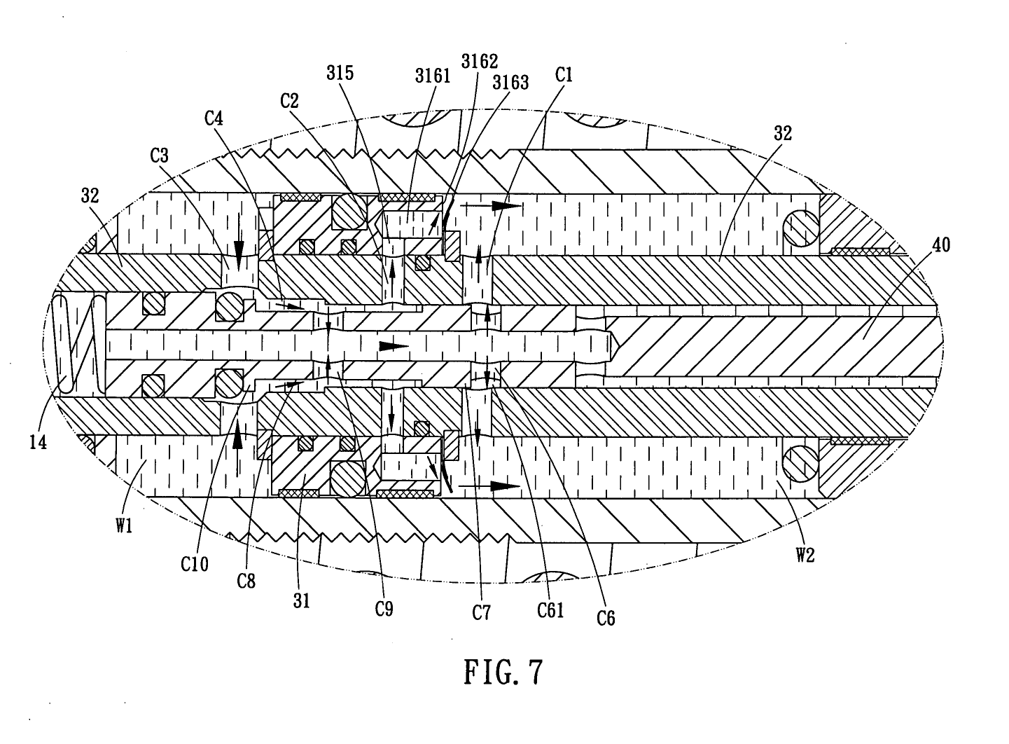

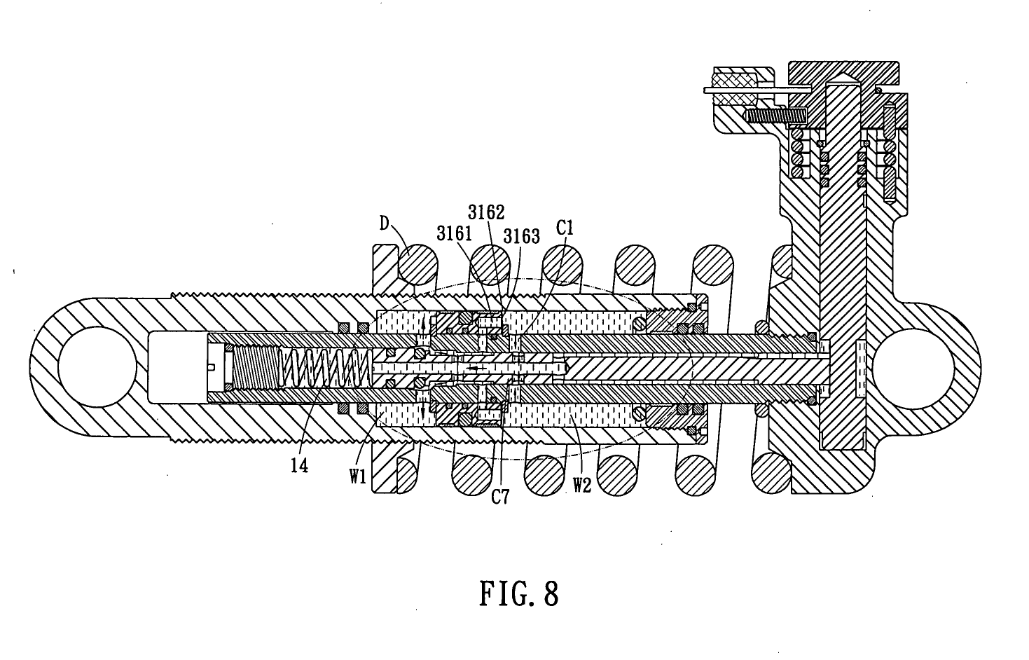

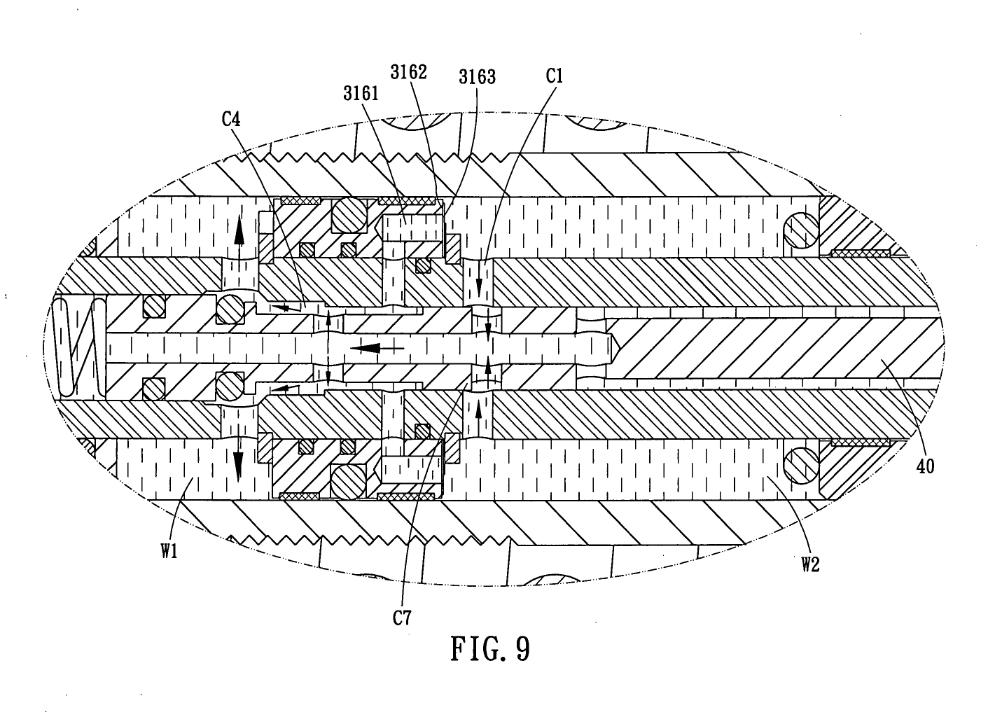

Referring further to FIGS. 6-9, when ridding on an uneven road, the user can adjust the buffering force of the oil shock absorber to a high level by using the steel cord (the steel cord can be used to adjust the buffering force to different levels according the real road condition). The control shaft 11 of the control assembly A is released from the steel cord, so it will drive the eccentric abutting portion 111 of the control shaft 11 to rotate under the effect of the elastic force of the return spring 13, so that a clearance appears between the eccentric abutting portion 111 and the control valve rod 40. The control spring 14 of the control assembly A pushes the control valve rod 40 to move along with the eccentric abutting portion 111 of the control shaft 11. At this moment, the control valve rod 40 moves in the bore 326 of the shaft 32, and the first holding portion C7 of the control valve rod 40 partially stops the first guiding hole C1 of the shaft 32 and makes it smaller. When the oil shock absorber moves downward (with reference to FIGS. 6 and 7), the valve 3163 of the check valve unit 316 will be pushed by the oil pressure to move away from the close surface 3162 of the check valve port 3161, so that is the check valve port 3161is opened. At this moment, the oil flow resistance caused by the downward motion of the oil shock absorber is small, only the buffering spring D is used to absorb shock. Referring to FIGS. 8 and 9, when the oil shock absorber moves upward under the effect of the elastic force of the buffering spring D, the oil in the second oil chamber W2, under the effect of the pressure caused by upward motion of the piston 31 as well as the elastic force of the valve 3163, will push the valve 3163 toward the close surface 3162 of the check valve port 3161 so as to close the check valve port 3161, the oil in the second oil chamber W2 only flows through the first guiding hole C1 of the shaft 32. Furthermore, the first guiding hole C1 is partially closed by the first holding portion C7 of the control valve rod 40 and the opening size thereof is reduced, so that the oil flow resistance is increased so as to increase the buffering resistance. The increased buffering resistance of the oil shock absorber can provide comfortable riding feeling for the user when ridding on an uneven road.

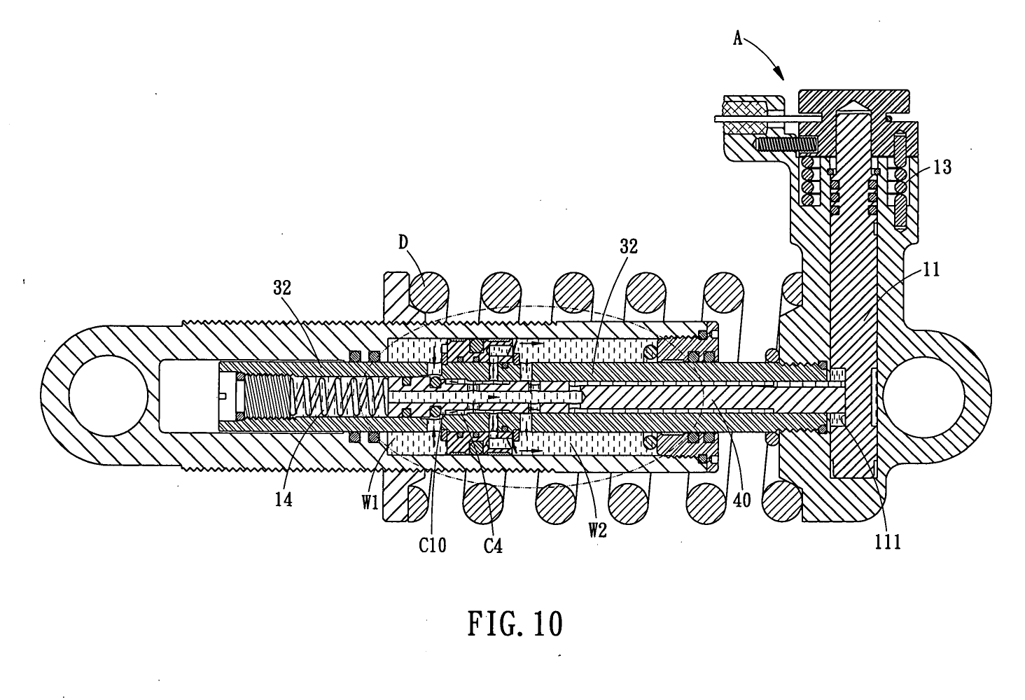

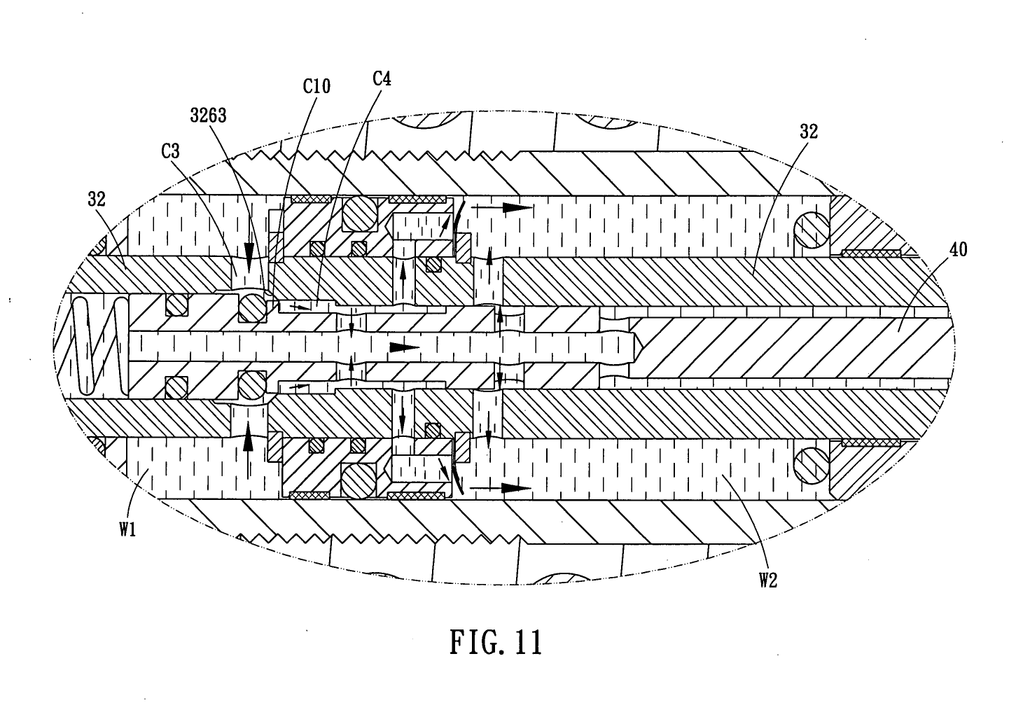

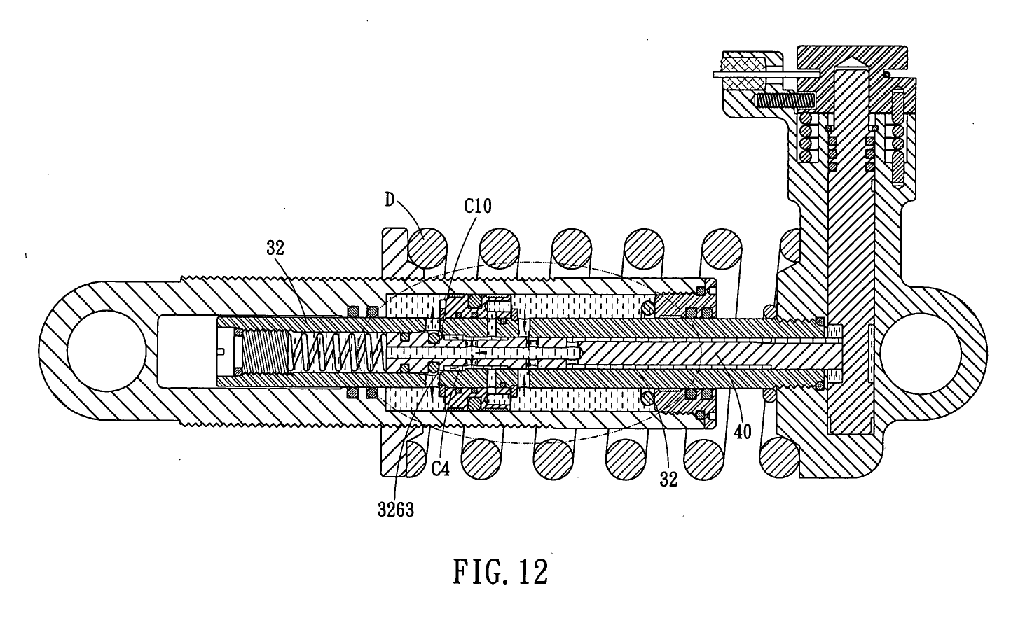

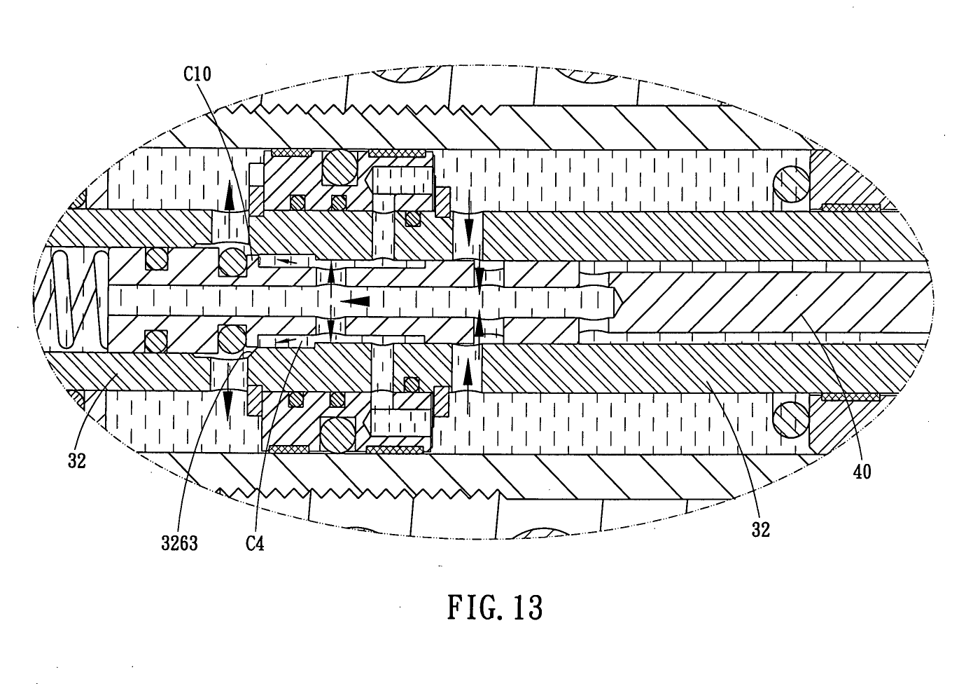

Referring to FIGS. 10-13, if the road surface is more uneven, the user can set the buffering force at higher level by using the steel cord. The control shaft 11 of the control assembly A is further released from the steel cord, so the rotation angle of the control shaft 11 is further increased under the effect of the elastic force of the return spring 13. Meanwhile, the control spring 14 pushes the control valve rod 40 to move along with the eccentric abutting portion 111 of the control shaft 11. The second holding portion C10 of the control valve rod 40 blocks the flow space of the main oil passage C4 beside the valve portion 3263 of the shaft 32. When the oil shock absorber moves downward, with reference to FIGS. 10 and 11, the oil in the first oil chamber W1 flows to the second oil chamber W2. Due to the oil flow resistance is large, the elastic force of the buffering spring D and the oil flow resistance will produce a more large downward buffering resistance. When the oil shock absorber is pushed to move upward by the buffering spring D, with reference to FIGS. 12 and 13, due to the main oil passage C4 beside the valve port 3263 of the shaft 32 is blocked by the second holding portion C10 of the control valve rod 40, the oil flow resistance is more increased. Through this way, the downward and the upward buffering resistance of the oil shock absorber can enable the rider to ride stably in a more uneven road.

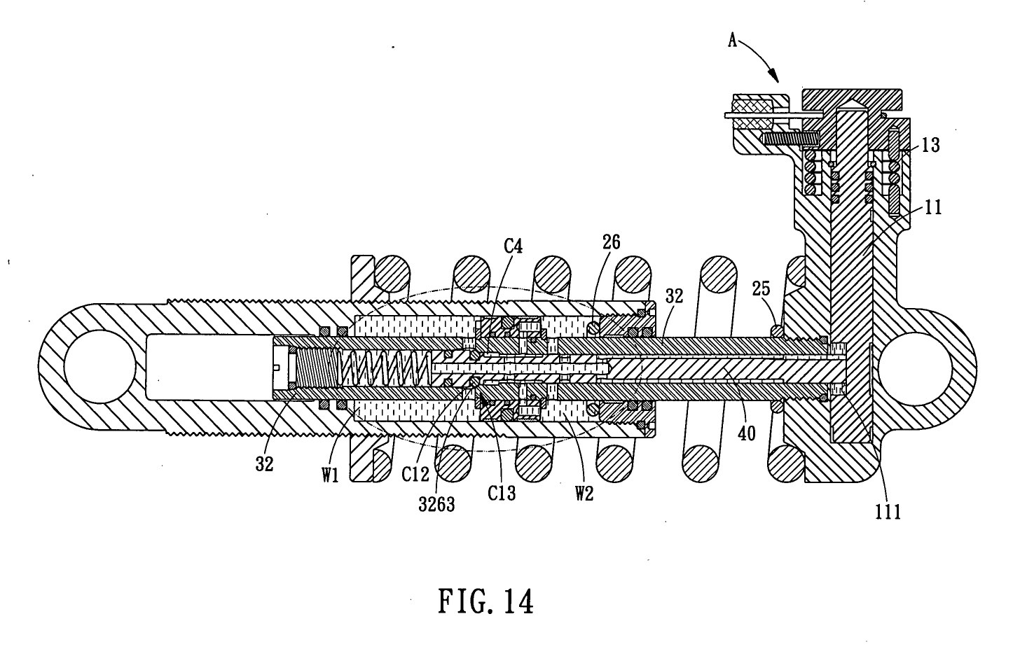

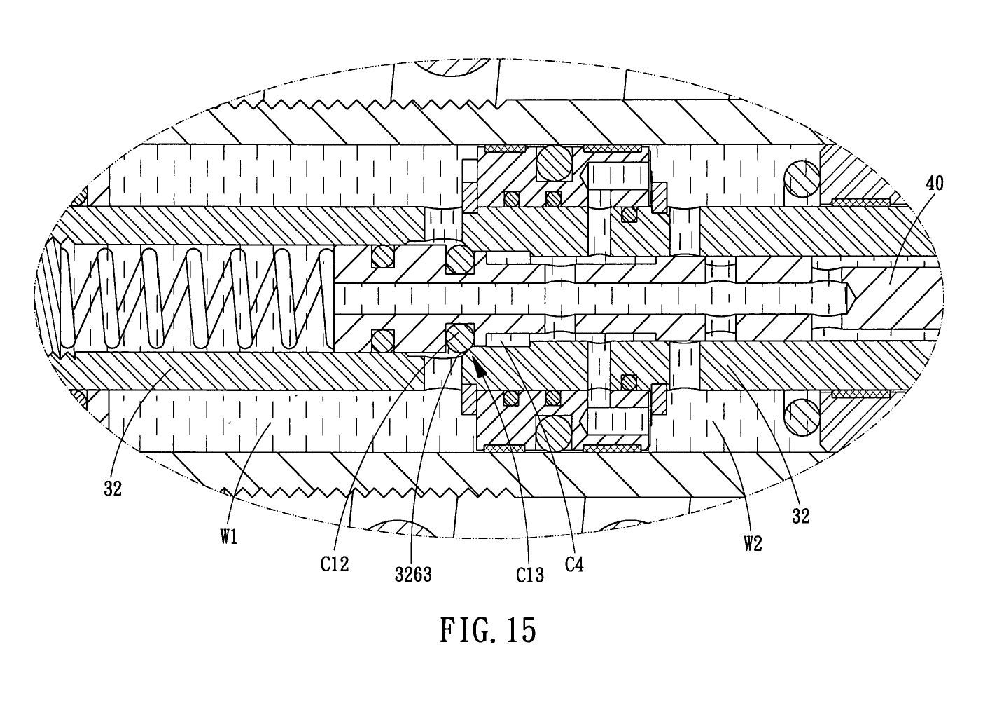

Referring to FIGS. 14 and 15, when riding up or down a slope, the user can set the oil shock absorber at “off” state by using the steel cord for the sake of labor-saving and safety. At this moment, the rotation angle of the control shaft 11 of the control assembly A is further increased under the effect of the return spring 13, and the eccentric abutting portion 111 rotates away from the control valve rod 40. The control spring 14 of the control assembly A will push the control valve rod 40 to move along with the eccentric abutting portion 111 of the control shaft 11, and the oil seal C12 of the valve C13 will move toward the valve portion 3263 of the shaft 32 to close the main oil passage C4. Therefore, the oil in the first and the second oil chambers W1, W2 is unable to flow, and the buffering function of the oil shock absorber is turned off.

To turn the buffering function on, the user can set the oil shock absorber at the “on” position by pulling the steel cord, and also can choose the level of buffering force, as needed. The steel cord pulls the control shaft 11 to rotate and the return spring 13 is compressed. Meanwhile, the eccentric abutting portion 111 of the control shaft 11 moves the control valve rod 40 and compresses the control spring 14. The displacement of the control valve rod 40 causes the oil seal C12 of the valve C13 to move away from the valve portion 3263 of the shaft 32, so as to enable the oil to flow between the first and the second oil chambers W1, W2, and to enable the oil shock absorber to move up and down. The second anti-collision cushion 25 between the control assembly A and the damper assembly B can produce a buffering effect when the oil shock absorber moves down to the utmost bottom thereof, and the first anti-collision cushion 26 between the piston 31 of the moving assembly C and the first leak proof member 22 also can produce a buffering effect when the oil shock absorber moves up to the utmost top thereof.

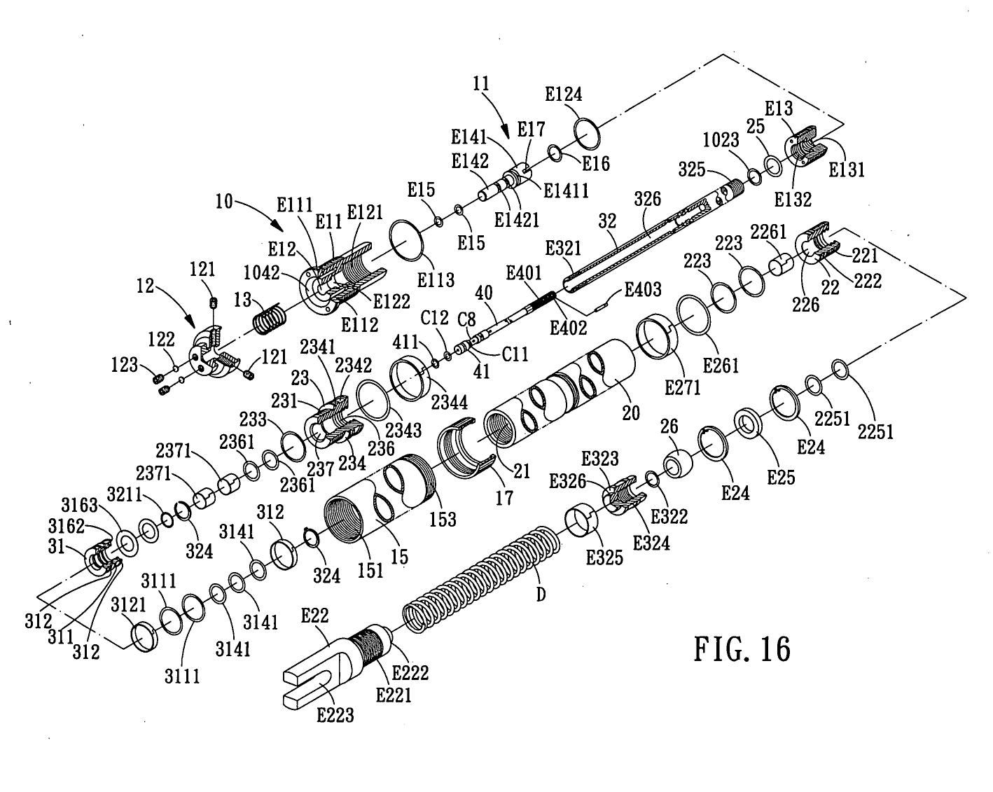

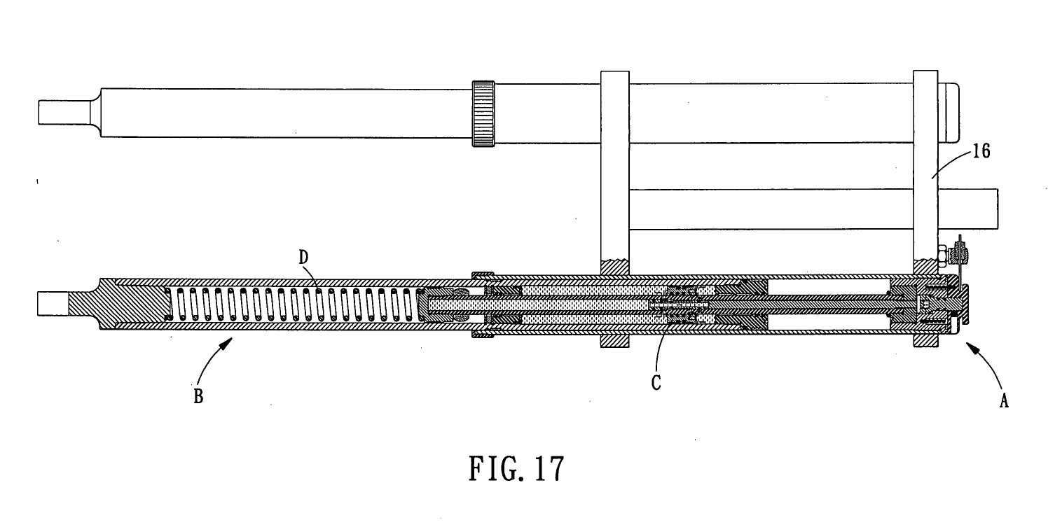

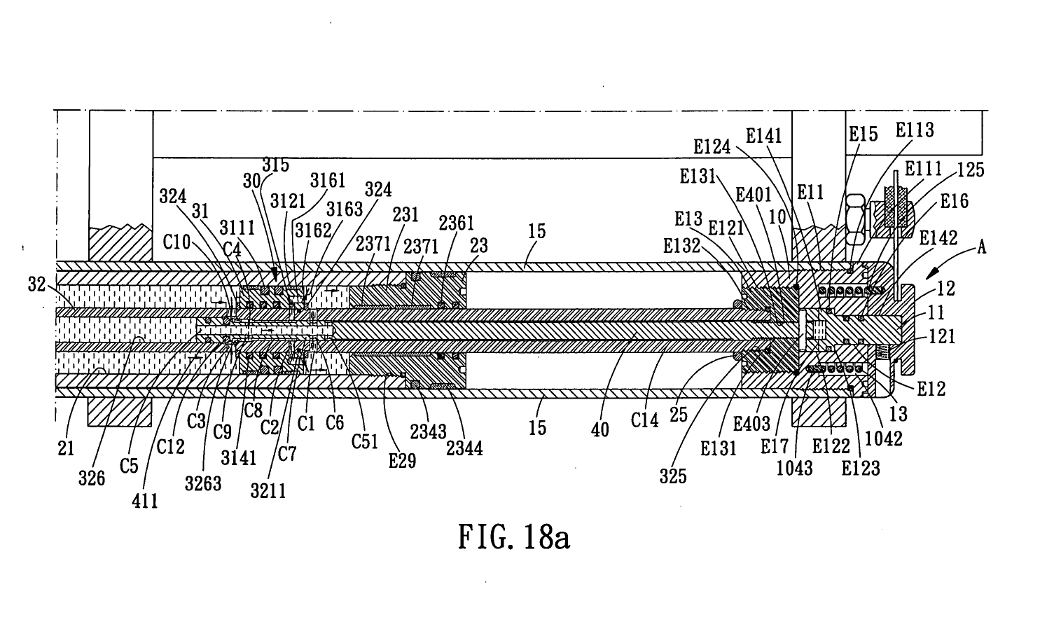

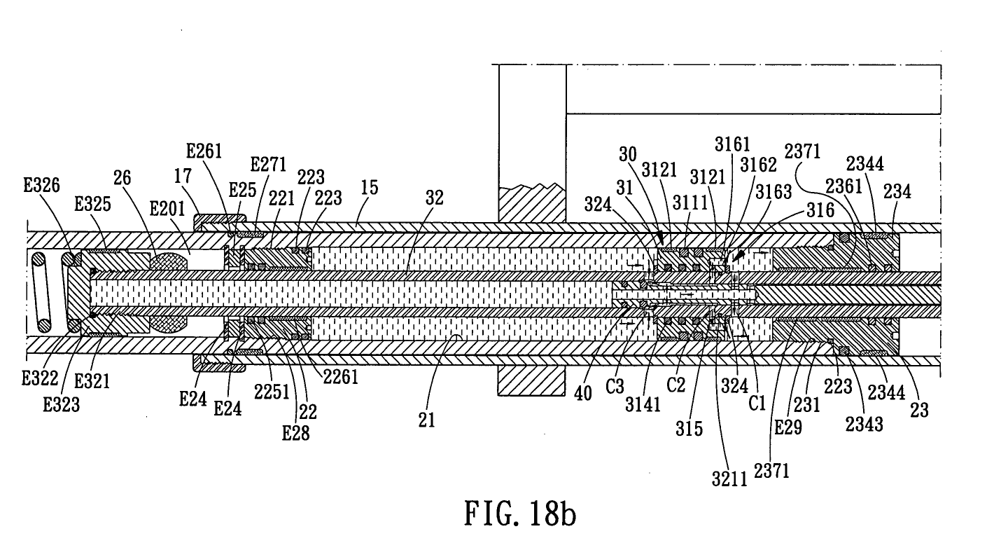

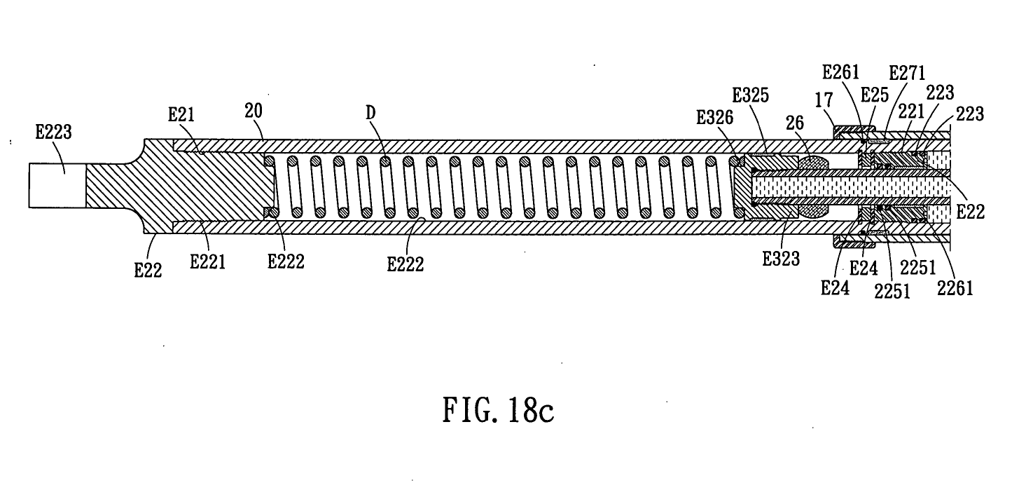

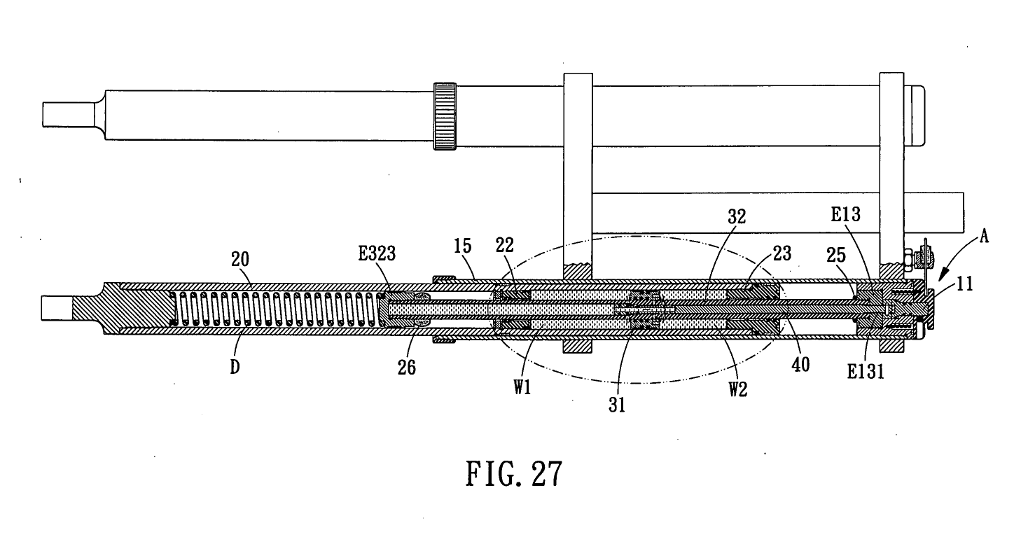

Referring to FIGS. 16-30, which show an oil shock absorber in accordance with a second embodiment of the present invention used on the front fork of a bicycle, and the oil shock absorber comprises a control assembly A, a damper assembly B, moving assembly C and the buffering spring D.

The control assembly A (as shown in FIGS. 16, 17 and 18a) includes a base 10, a control shaft 11, a rotary button 12, a return spring 13 and a sleeve 15.

The base 10 is provided on the outer periphery with outer threads E11 and an annular flange E111, and an annular groove E112 is located between the threads E11 and the annular flange E111 for receiving an oil seal E113. At an end of the inner periphery of the base 10 are a recess 1042 and a through hole E12, and at another end of the base 10 is a threaded hole E121. Between the threaded hole E121 and the through hole E12 is an inner hole E122, and a positioning surface E123 is formed at the conjunction between the through hole E12 and the inner hole E122. The recess 1042 is provided with a spring-fixing hole 1043 in line with the inner hole E122. In the threaded hole E121 is formed an oil seal E124 and then is screwed a threaded sleeve E13 in which is formed a displacement threaded hole E131. At an end of the displacement threaded hole E131 is a positioning threaded hole E132.

The control shaft 11 is provided on its outer periphery with a step portion E14 which divides the control shaft 11 into a large diameter portion E141 and a small diameter portion E142. The large diameter portion E141 and the small diameter portion E142 are provided with an annular groove E1411, E1421 in which is disposed an oil seal E15, E16, respectively. The rotatably sealed in the through hole E12 and the inner hole E122 of the base 10 of the control assembly A by the oil seals E15 and E16. The connection surface between the large diameter portion E141 and the small diameter portion E142 is positioned at the positioning surface E123 between the through hole E12 and the inner hole E122. At the end of the large diameter portion E141 of the control shaft 11 is formed an elongated groove E17.

The rotary button 12 is fixed on the small diameter portion E142 of the control shaft 11 by screws 121, and to an end of the rotary button 12 is connected a steel cord by using washers 122 and screws 123 (the steel cord is controlled by the user to rotate the rotary button 12). At the bottom of the rotary button 12 is formed a spring-fixing hole 125.

The return spring 13 is received in the recess 1042 and biased between the spring-fixing hole 1043 of the base 10 and the spring-fixing hole 125 of the rotary button 12.

The sleeve 15 is fixed to the front fork 16 of a bicycle, at an end of the inner periphery of which are formed inner threads 151 and an inner step portion 152. The inner threads 151 are screwed with the outer threads E11 of the base 10, and the inner step portion 152 comes in tight contact with the oil seal E113 in the annular groove E112. An end of the sleeve 15 is positioned on the annular flange E111 of the base 10, and another end of the sleeve 15 is provided with outer threads 153 which are screwed with a ring 17.

The damper assembly B (as shown in FIGS. 16, 17, 18a, 18b and 18c) comprises a housing 20, an oil cylinder 21, a first leak proof member 22 and a second leak proof member 23.

The housing 20 is provided with a bore E201, formed at an end of the bore E201 are inner threads E21 which are screwed with outer threads E221 on an end of a positioning bracket E22. At the end of positioning bracket E22 adjacent to the outer threads E221 is formed a spring retaining portion E222, while at another end of the positioning bracket E22 is formed a slot E223 which is fixed on the wheel axis of the bicycle. On the inner periphery of the housing 20 and close to the center thereof are provided two engaging grooves E23 in each of which is received a retainer E24, and a washer E25 is located between the retainers E24.

An annular groove E26 and an annular recess E27 are provided close to the mid section of the outer surface of the housing 20. In the annular groove E26 is disposed an oil seal E261, and in the annular recess E27 is a friction ring E271. The housing 20 is moveably disposed in the sleeve 15 of the control assembly A by cooperating with the oil seal E261 and the friction ring E271.

The oil cylinder 21 is disposed in the housing 20, at an end of the oil cylinder 21 are provided inner threads E28 and inner step portion E281, and at another end of the oil cylinder 21 are formed outer threads E29 and inner step portion E291.

At an end of the outer surface of the first leak proof member 22 are provided outer threads 221 and two annular grooves 222, in each of the two annular grooves 222 is received an oil seal 223. The outer threads 221 of the first leak proof member 22 are screwed with inner threads E28 on the oil cylinder 21, and the oil seals 223 come into tight contact with the inner step portion E281 of the oil cylinder 21. The bottom of the first leak proof member 22 is positioned on the retainer E24 inside the housing 20.

Formed in the bore 224 of the first leak proof member 22 are two annular grooves 225 and an annular recess 226, disposed in each of the annular grooves 225 is an oil seal 2251, and in the annular recess 226 is provided a friction ring 2261.

Formed at an end of the outer surface of the second leak proof member 23 are outer threads 231, an annular groove 232 and an annular flange 234. The outer threads 231 are screwed with the inner threads E29 of the oil cylinder 21, and the oil seal 233 in the annular groove 232 comes into tight contact with the inner step portion E291 of the oil cylinder 21.

Formed at a side of the annular flange 234 of the second leak proof member 23 are an annular groove 2341 and an annular recess 2342. In the annular groove 2341 is an oil seal 2343, and in the annular recess 2342 is a friction ring 2344. The annular flange 234 is positioned at an end of the oil cylinder 21 of the housing 20, and the oil seal 2343 and the friction ring 2344 make the housing 20 move smoothly in the sleeve 15 of the control assembly A.

Formed in the bore 235 of the second lead proof member 23 are two annular grooves 236 and two annular recesses 237, in each of the annular grooves 236 is received an oil seal 2361 and in each of the annular recesses 237 is disposed a friction ring 2371.

The moving assembly C (as shown in FIGS. 16, 17, 18a, 18b and 18c) comprising a piston unit 30 and a control valve rod 40 is moveably disposed in the oil cylinder 21 of the damper assembly B.

The piston unit 30 includes a piston 31 and a shaft 32.

The piston 31 is provided on the outer surface thereof with annular grooves 311 and annular recesses 312. In the annular grooves 311 are received with oil seals 3111, and in the annular recesses 312 are received with friction ring 3121. The oil seals 3111 and the friction rings 3121 bring the piston 31 into tight contact with the oil cylinder 21, and the piston 31 is movable in the oil cylinder 21. In the bore 313 of the piston 31 are formed three annular grooves 314 and an annular oil passage 315. In each of the three annular grooves 314 is received an oil seal 3141. At an end surface of the piston 31 is provided a check valve 316 which has a check valve port 3161, a close surface 3162 and a valve 3163. The check valve port 3161 at a side of the check valve 316 is connected to the annular oil passage 315, the close surface 3162 is formed at another side of the check valve 316, and adjacent to the close surface 3162 is the valve 3163. The check valve port 3161 can be closed by pushing the valve 3163 towards the close surface 3162 of the check valve port 3161, and it can be opened by moving the valve 3163 away from the close surface 3162.

On the outer surface of the shaft 32 and close to the center thereof are provided an annular groove 321 and two engaging grooves 322, 323. disposed in the annular groove 321 is an oil seal 3211, the shaft 32 is inserted in the bore 313 of the piston 31, and the piston 31 is positioned between the engaging grooves 322, 323 of the shaft 32 by two retainer rings 324. Meanwhile, the retainer rings 324 also position the valve 3163 of the check valve unit 316 of the piston 31. The oil seals 3141 in the piston 31 and the oil seal 3211 on the shaft 32 ensure a tight contact between the piston 31 and the shaft 32, and this tight contact is further improved by the first and the second leak proof members 22, 23, including the oil seals 2251, 2361 and the friction rings 2261, 2371 thereof. At an end of the shaft are provided first outer threads 325 which are screwed with the threaded hole E132 of the threaded sleeve E13 of the base 10, and an oil seal 1023 is disposed between the shaft 32 and the threaded sleeve E13 for ensuring a tight contact therebetween. At another end of the shaft 32 are formed second outer threads E321 which are screwed with a leak proof cap E323, and an oil seal E322 is disposed theretween for creating a tight contact effect. An annular recess E324 is formed on the outer surface of the leak proof cap E323 for receiving a friction ring E325, and the leak proof cap E323 moves in the bore E201 of the housing 20 of the damper assembly B. At an end of the leak proof cap E323 is provided a spring-retaining portion E326.

Beside the engaging groove 322 and the shaft 32 is provided a first guiding hole C1 located toward the check valve 316 of the piston 31. Adjacent to the first guiding hole C1 and on the shaft 32 is a second guiding hole C2 located in line with the annular oil passage 315, and a third guiding hole C3 is formed on the shaft 32 and located beside the engaging groove 323. The shaft 32 is provided in its bore 326 with a main oil passage C4 which is located between the second and the third guiding holes C2, C3. The main oil passage C4 is provided with an inner step portion C41 located toward the third guiding hole C3, so that the bore 326 of the shaft 32 is divided by the inner flange C41 into a big bore 3261 and a small bore 3262. The conjunction between the big bore 3261 and a small bore 3262 is a valve port 3263.

The control valve rod 40 is moveably disposed in the bore 326 of the shaft 32, at an end of the control valve rod 40 are formed displacement threads E401 and a through hole E402. The displacement threads E401 protrude out of the bore 326 of the shaft 32 and are screwed in the displacement threaded hole E131 of the threaded sleeve E13, and a pin E403 is inserted in the through hole E402 of the control valve rod 40 to cooperates with the elongated groove E17 of the control shaft 11, so that the elongated groove E17 will rotate the pin E403 when the control shaft 11 rotates. The control valve rod 40 is driven by the pin E403 to rotate along with the control shaft 11, and the rotation of the control valve rod 40 will cause axial displacement thereof under the effect of the displacement threaded hole E131 of the base 10. At another end of the outer surface of the control valve rod 40 is formed an annular groove 41 in which is received an oil seal 411 which bring the control valve rod 40 into tight contact with the shaft 32 when valve rod 40 moves in the bore 326. Still at this end of the inner periphery of the control valve rod 40 is formed an oil guiding passage C5. On the control valve rod 40 is formed a through hole C51 which is located at the end of the oil guiding passage C5. On the control valve rod 40 adjacent to the through hole C51 is a first oil guiding hole C6 which is arranged in line with the first guiding hole C1 of the shaft 32. At first oil deflector C61 is located outside the first oil guiding hole C6, which allows the first oil guiding hole C6 to communicate with the first guiding hole C1 of the shaft 32.

On the outer periphery of the control valve rod 40 and adjacent to the first oil guiding hole C6 is a first holding portion C7 corresponding to the first guiding hole C1 of the shaft 32, so that the displacement of the control valve rod 40 can enable the first holding portion C7 to adjust the opening size of the first guiding hole C1. On the outer periphery of the control valve rod 40 and adjacent to the first holding portion C7 is formed a second oil deflector C8 which is located in line with the main oil passage C4 of the shaft 32. A second oil guiding hole C9 is formed on the control valve rod 40 and located in line with the second oil deflector C8. The second oil deflector C8 increases the oil-flowing space of the main oil passage C4 of the shaft 32, makes the second oil guiding hole C9 communicate with the main oil passage C4 of the shaft 32. Still on the control valve rod 40 and adjacent to the second oil guiding hole C9 is formed a second holding portion C10 located in line with the main oil passage C4 of the shaft 32, and by controlling the displacement of the control valve rod 40, the second holding portion C10 can be caused change the size of the oil-flowing space of the main oil passage C4. Next to the second holding portion C10 is an annular groove C11 in which is received an oil seal C12 in response to the valve port 3263 of the inner flange C41 of the main oil passage C4, thus forming a valve C13.

When the control valve rod 40 moves, the oil seal C12 of the valve C13 is caused to abut against the valve port 3263 in the bore 326 of the shaft 32, thus closing the main oil passage C4. At an end of the outer periphery of the control valve rod 40 and on the side of the control shaft 11 is provided an oil guiding clearance C14 which cooperates with the oil guiding passage C5 and the through hole C51, so as to enable the control valve rod 40 to move within the bore 326 of the shaft 32 under the condition that there is no oil pressure resistance.

The buffering spring D is arranged in the bore E201 of the housing 20 of the damper assembly B and biased between the spring retaining portion E222 of the positioning bracket E22 of the housing 20 and the spring portion E326 of the leak proof cap E323 of the piston unit 30.

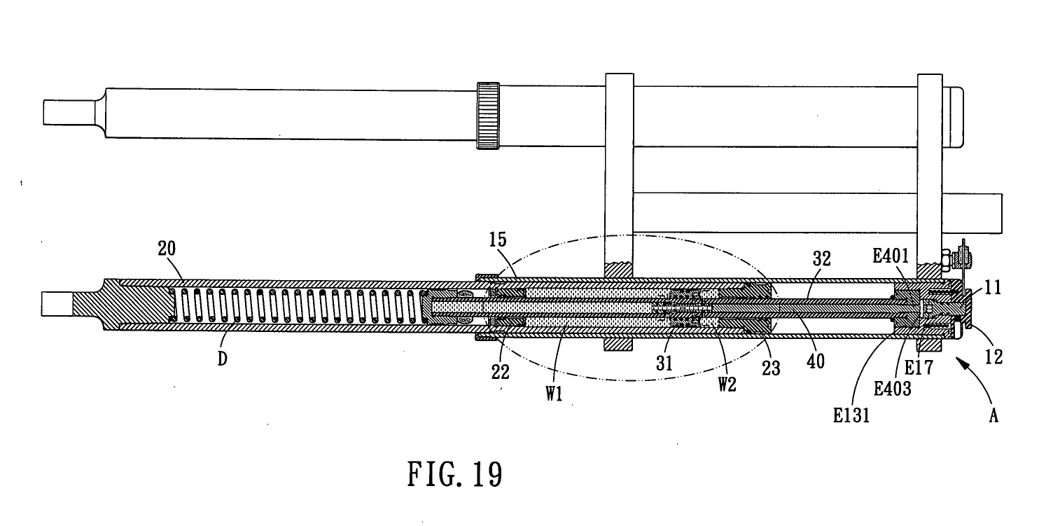

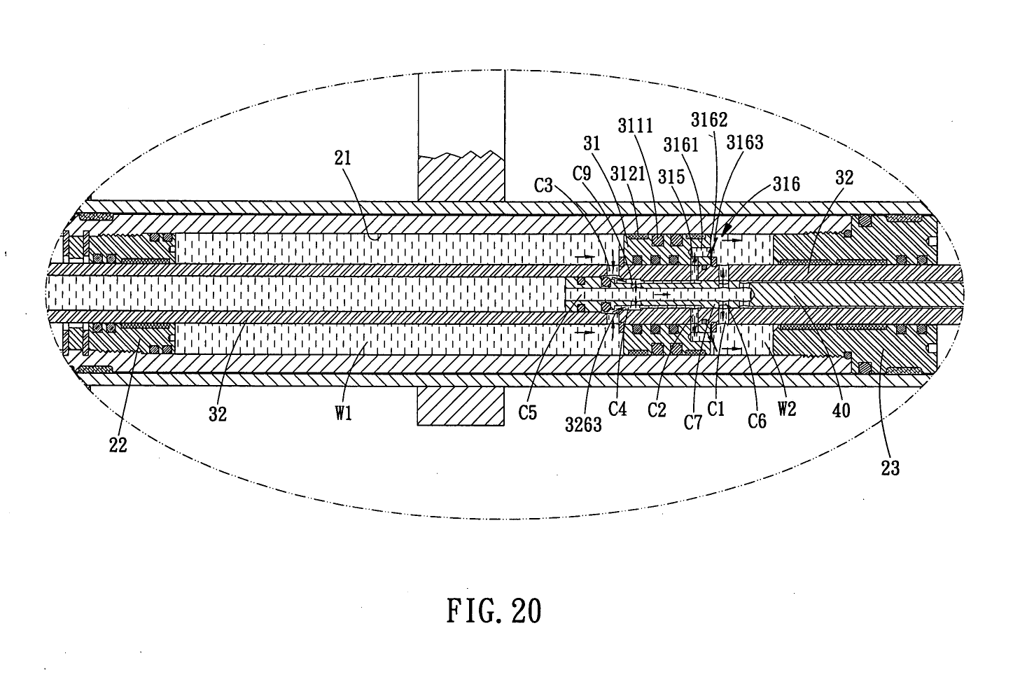

Referring initially to FIGS. 19 and 20, when riding on a flat road, the user can adjust the buffering force of the oil shock absorber to a low level by using the steel cord. The rotary button 12 will rotate when the steel cord is pulled, and will drive the control shaft 11 to rotate. Meanwhile, the elongated groove E17 of the control shaft 11 will rotate the pin E403 so as to make the control valve rod 40 move along with the control shaft 11. When the control valve rod rotates 40, the displacement threads E401 thereof can produce a displacement of the control valve rod 40 by cooperating with the displacement threaded hole E131 of the threaded sleeve E13 (the pin E403 moves in the elongated groove E17), so that the first holding portion C7 of the control valve rod 40 moves to the side of the first guiding hole C1 of the shaft 32, at this moment, the opening size of the first guiding hole C1 is maximized. When the oil shock absorber moves downward (the buffering spring D stores energy after being compressed), the piston 31 of the moving assembly C, the oil seal 3111 and the friction ring 3121 will move within the oil cylinder 21 of the damper assembly B. The shaft 32 at both ends of the piston 31 will move in bore of the first and the second leak proof members 22, 23 of the damper assembly B. Thereby, the oil in the first oil chamber W1 will be pressed by the piston 31 and flow to the second oil chamber W2 via the third guiding hole C3, the valve port 3263, the main oil passage C4, the second guiding hole C2, the oil passage 315 and the check valve port 3161, respectively (the oil pressure pushes the valve 3163 of the check valve unit 316 of the piston 31 to move away from the close surface 3162 of the valve port 3161). At the same time, the oil also flows to the second oil chamber W2 through the main oil passage C4, the second oil hole C9 of the control valve rod 40, the oil guiding passage C5, the first oil guiding hole C6 and the first guiding hole C1 of the shaft 32. At this moment, the oil flow resistance caused by the downward motion of the oil shock absorber is small, only the buffering spring D is used to absorb shock.

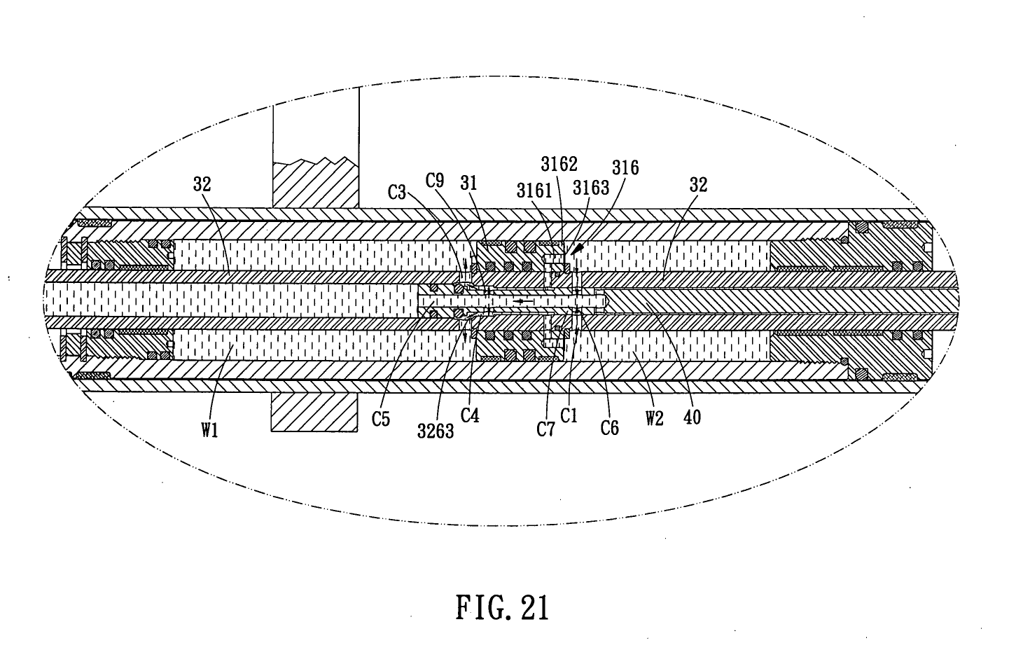

Referring to FIG. 21, when the oil shock absorber moves upward under the effect of the elastic force of the buffering spring D, the oil in the second oil chamber W2, under the effect of the pressure caused by upward motion of the piston 31 as well as the elastic force of the valve 3163, will push the valve 3163 toward the close surface 3162 of the check valve port 3161 so as to close the check valve port 3161. At this moment, the oil can flow to the first oil chamber W1 only through the first guiding hole C1, the first guiding hole C6, the oil guiding passage C5, the second oil guiding hole C9 of the control valve rod 40, and the main oil passage C4, the valve port 3263 of the third guiding hole C3 of the shaft 32. Since the oil only flows through the first guiding hole C1 of the shaft 32, the oil flow resistance within the oil shock absorber will produce a buffering force in an opposite direction to the elastic force of the buffering spring D.

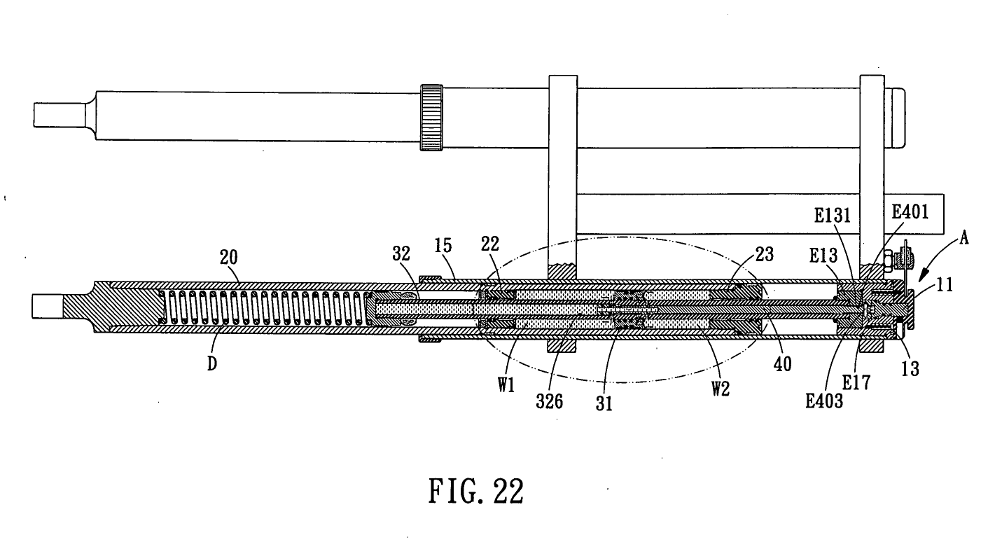

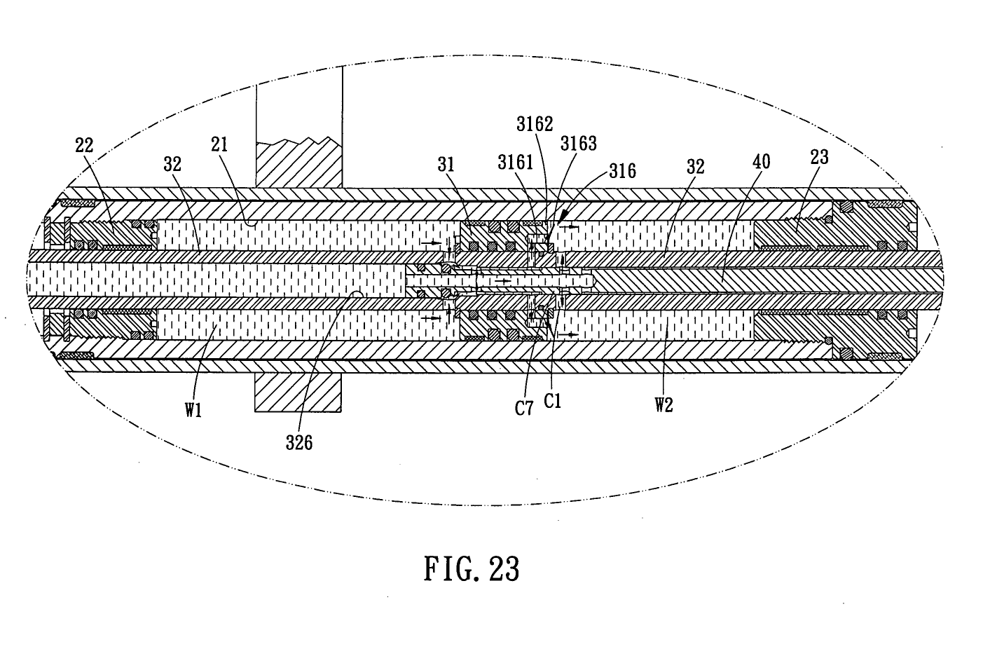

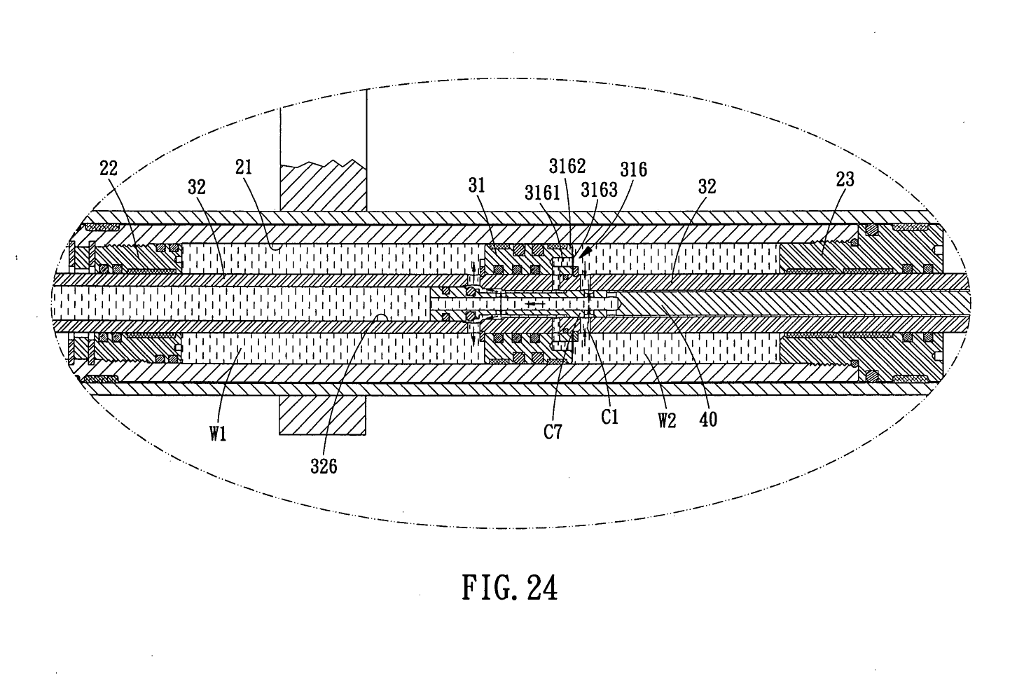

Referring further to FIGS. 22 and 23, when ridding on an uneven road, the user can adjust the buffering force of the oil shock absorber to a high level by using the steel cord (the steel cord can be used to adjust the buffering force to different levels according the real road condition). The control shaft 11 of the control assembly A is released from the steel cord, so it will drive the eccentric abutting portion 111 of the control shaft 11 to rotate under the effect of the elastic force of the return spring 13, and the control shaft 11 will drive the displacement threads E401 of the control valve rod 40 to rotate relative to the displacement threaded hole E131 of the threaded sleeve E13, thus causing axial displacement (the pin E403 moves in the elongated groove E17 of the control shaft 11). Thereby, the control valve rod 40 will move in the bore 326 of the shaft 32, and the first holding portion C7 of the control valve rod 40 partially stops the first guiding hole C1 of the shaft 32 and makes it smaller. When the oil shock absorber moves downward, the valve 3163 of the check valve unit 316 will be pushed by the oil pressure to move away from the close surface 3162 of the check valve port 3161, so that the check valve port 3161 is opened. At this moment, the oil flow resistance caused by the downward motion of the oil shock absorber is small, only the buffering spring D is used to absorb shock. Referring to FIG. 24, when the oil shock absorber moves upward under the effect of the elastic force of the buffering spring D, the oil in the second oil chamber W2, under the effect of the pressure caused by upward motion of the piston 31 as well as the elastic force of the valve 3163, will push the valve 3163 toward the close surface 3162 of the check valve port 3161 so as to close the check valve port 3161, the oil in the second oil chamber W2 only flows through the first guiding hole C1 of the shaft 32. Furthermore, the first guiding hole C1 is partially closed by the first holding portion C7 of the control valve rod 40 and the opening size thereof is reduced, so that the oil flow resistance is increased so as to increase the buffering resistance. The increased buffering resistance of the oil shock absorber can provide comfortable riding feeling for the user when ridding on an uneven road.

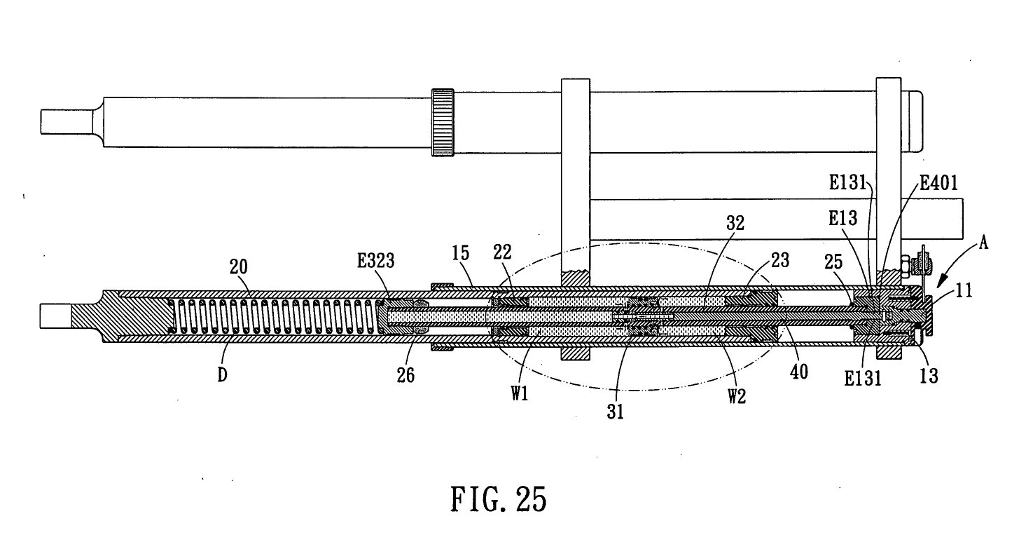

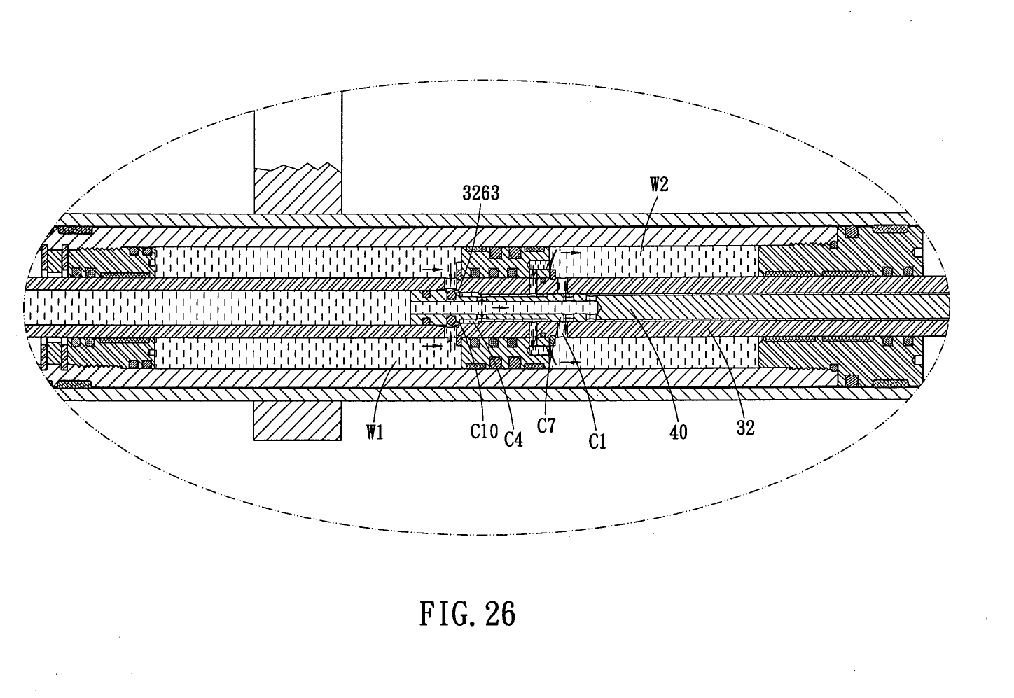

Referring to FIGS. 25-28, if the road surface is more uneven, the user can set the buffering force at more higher level by using the steel cord. The rotation angle of the control shaft 11 is further increased under the effect of the elastic force of the return spring 13, so that the displacement threads E401 rotate relative to the displacement threaded hole E131 of the threaded sleeve E13, thus causing a longer axial displacement of the control valve rod 40. The first holding portion C7 of the control valve rod 40 partially stops the first guiding hole C1 of the shaft 32 and makes it smaller. Meanwhile, the second holding portion C10 of the control valve rod 40 blocks the flow space of the main oil passage C4 beside the valve portion 3263 of the shaft 32 (as shown in FIG. 26). When the oil shock absorber moves downward, the oil in the first oil chamber W1 flows to the second oil chamber W2. Due to the oil flow resistance is large, the elastic force of the buffering spring D and the oil flow resistance will produce a more large downward buffering resistance.

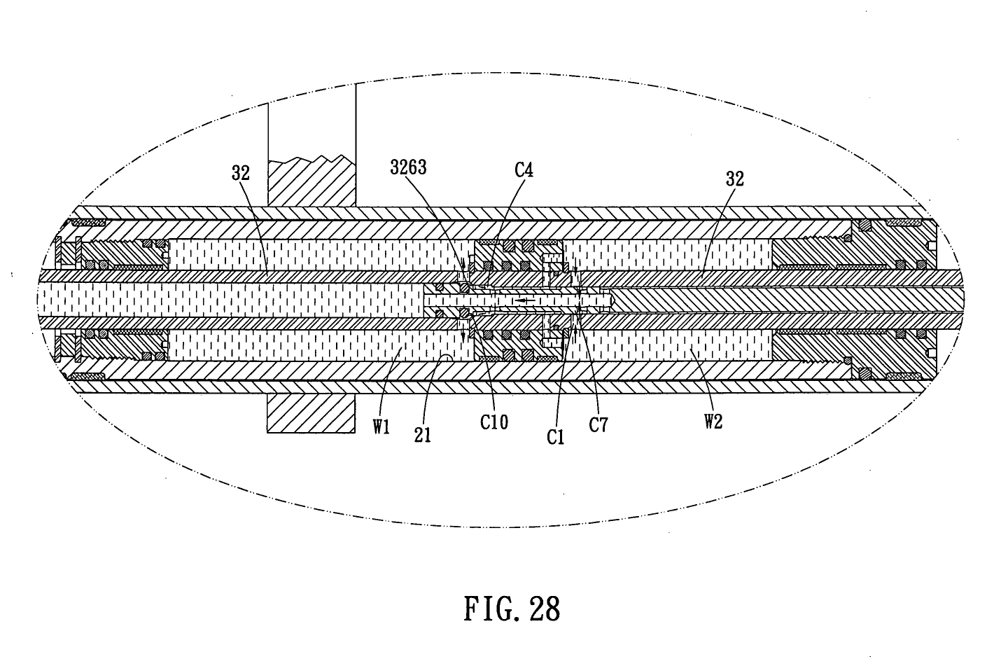

When the oil shock absorber is pushed to move upward by the buffering spring D, the oil flows from the second oil chamber W2 to the first oil chamber W1, due to the opening size of the first guiding hole C1 is reduced by the first holding portion C7 of the control valve rod 40, and the main oil passage C4 is blocked by the second holding portion C10 (as shown in FIG. 28), the oil flow resistance is more increased. Through this way, the downward and the upward buffering resistance of the oil shock absorber can enable the rider to ride stably in a more uneven road.

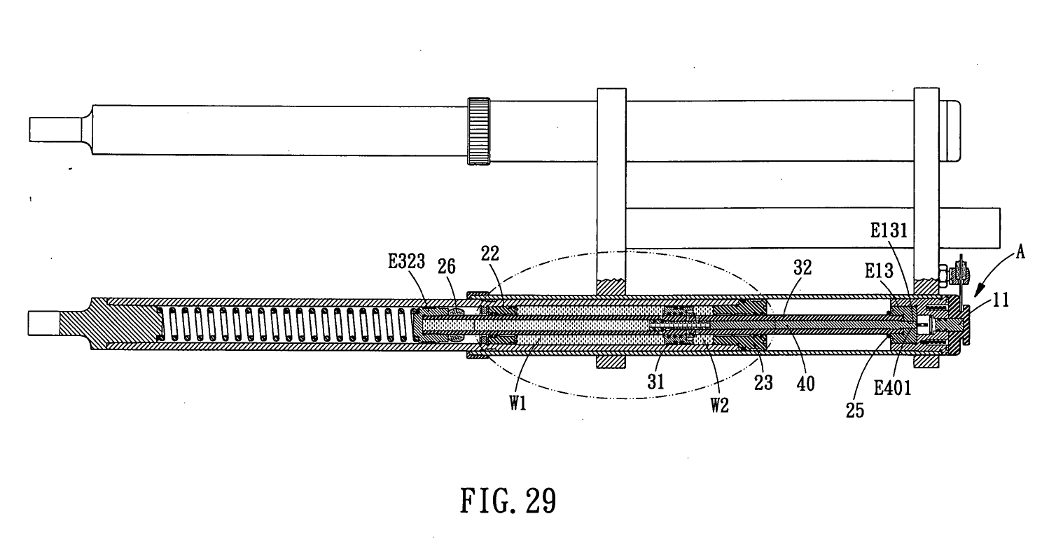

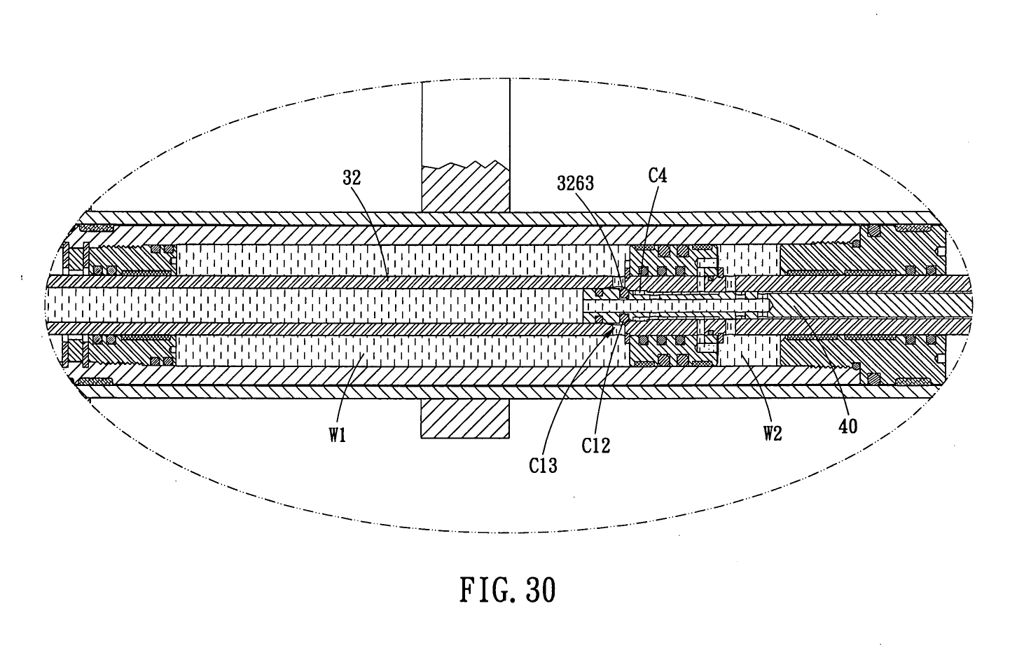

Referring to FIGS. 29 and 30, when riding up or down a slope, the user can set the oil shock absorber at “off” state by using the steel cord for the sake of labor-saving and safety. At this moment, the rotation angle of the control shaft 11 of the control assembly A is further increased under the effect of the return spring 13, so that the displacement threads E401 rotate relative to the displacement threaded hole E131 of the threaded sleeve E13, thus causing a longer axial displacement of the control valve rod 40. The oil seal C12 of the valve C13 will move toward the valve portion 3263 of the shaft 32 to close the main oil passage C4. Therefore, the oil in the first and the second oil chambers W1, W2 is unable to flow, and the buffering function of the oil shock absorber is turned off.

To turn the buffering function on, the user can set the oil shock absorber at the “on” position by pulling the steel cord, and also can choose the level of buffering force, as needed. The steel cord pulls the control shaft 11 to rotate adversely and compresses the return spring 13, so that the displacement threads E401 rotate adversely relative to the displacement threaded hole E131 of the threaded sleeve E13, thus causing a back-axial displacement of the control valve rod 40. The displacement of the control valve rod 40 causes the oil seal C12 of the valve C13 to move away from the valve portion 3263 of the shaft 32, so as to enable the oil to flow between the first and the second oil chambers W1, W2, and to enable the oil shock absorber to move up and down. The second anti-collision cushion 25 between the control assembly A and the damper assembly B can produce a buffering effect when the oil shock absorber moves down to the utmost bottom thereof, and the first anti-collision cushion 26 between the piston 31 of the moving assembly C and the first leak proof member 22 also can produce a buffering effect when the oil shock absorber moves up to the utmost top thereof.

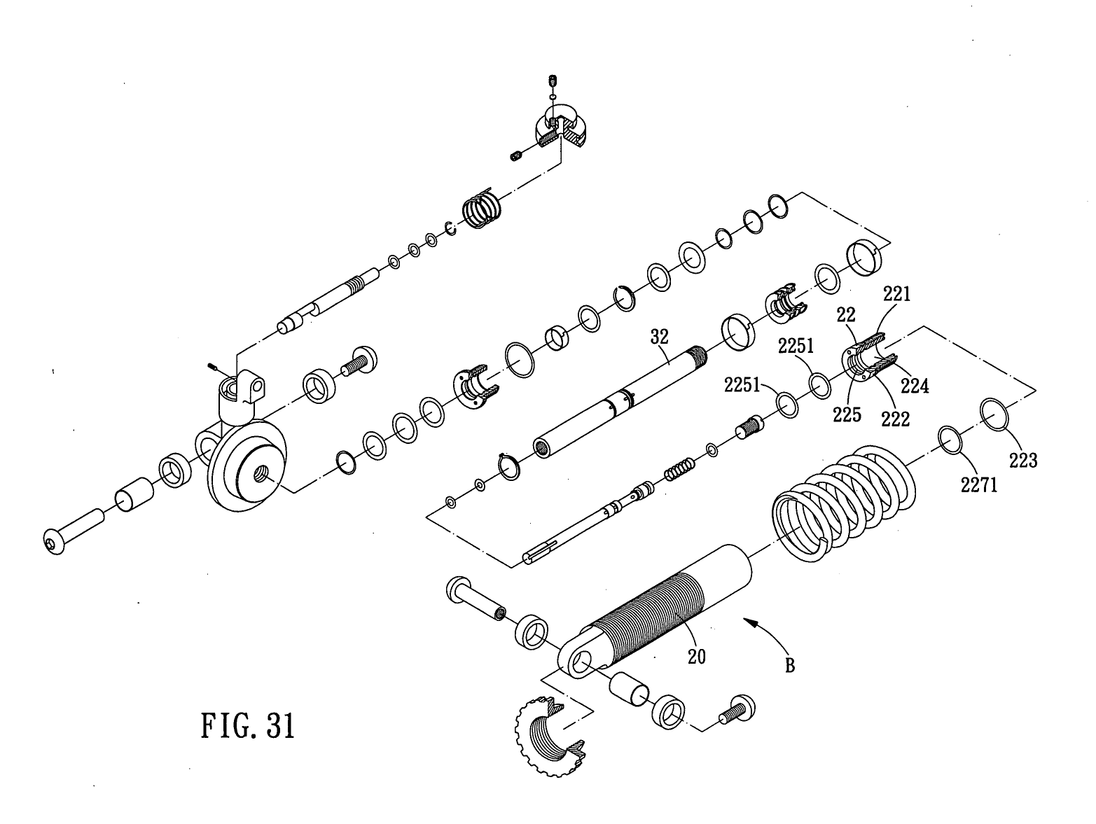

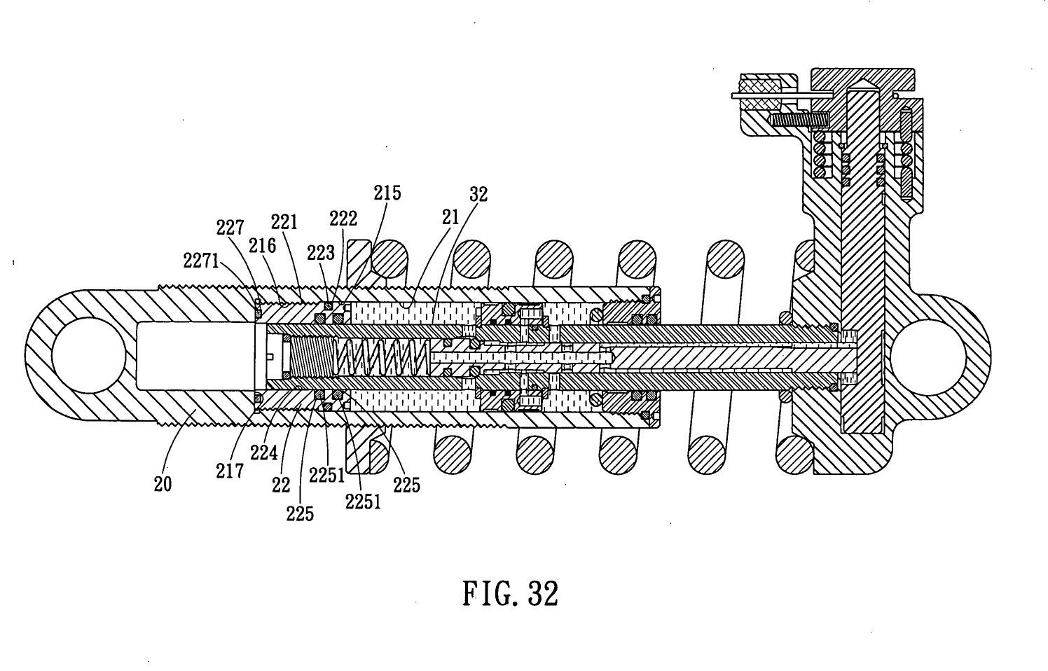

Referring to FIGS. 31 and 32, an oil shock absorber in accordance with a third embodiment of the present invention is shown which is revised from the oil shock absorber of the first embodiment, therefore, in the following, only the differences from the first embodiment are explained.

The first leak proof member 22 is integrally formed into a one-piece structure, formed on the outer surface of the leak proof member 22 are outer threads 221 and an annular groove 222 in which is arranged an oil seal 223. Formed on the surface of the bore 224 of the first leak proof member 22 are annular grooves 225 in each of which is received an oil seal 2251. Provided at the bottom of the leak proof member 22 is annular groove 227 in which is an oil seal 2271. In the oil cylinder 21 of the damper assembly B and close to the bottom end thereof are provided an inner step portion 215 and inner threads 216. Located at the end of the inner threads 216 is a positioning surface 217, so that the first leak proof member 22 is screwed with the inner threads 216 of the oil cylinder 21 and comes into tight contact with the inner step portion 215 of the oil cylinder 21 and the positioning surface 217 by taking use of the oil seal 223. Therefore, the shaft 32 of the moving assembly C will come into tight contact with the first leak proof member 22 when it moves in the bore 224.

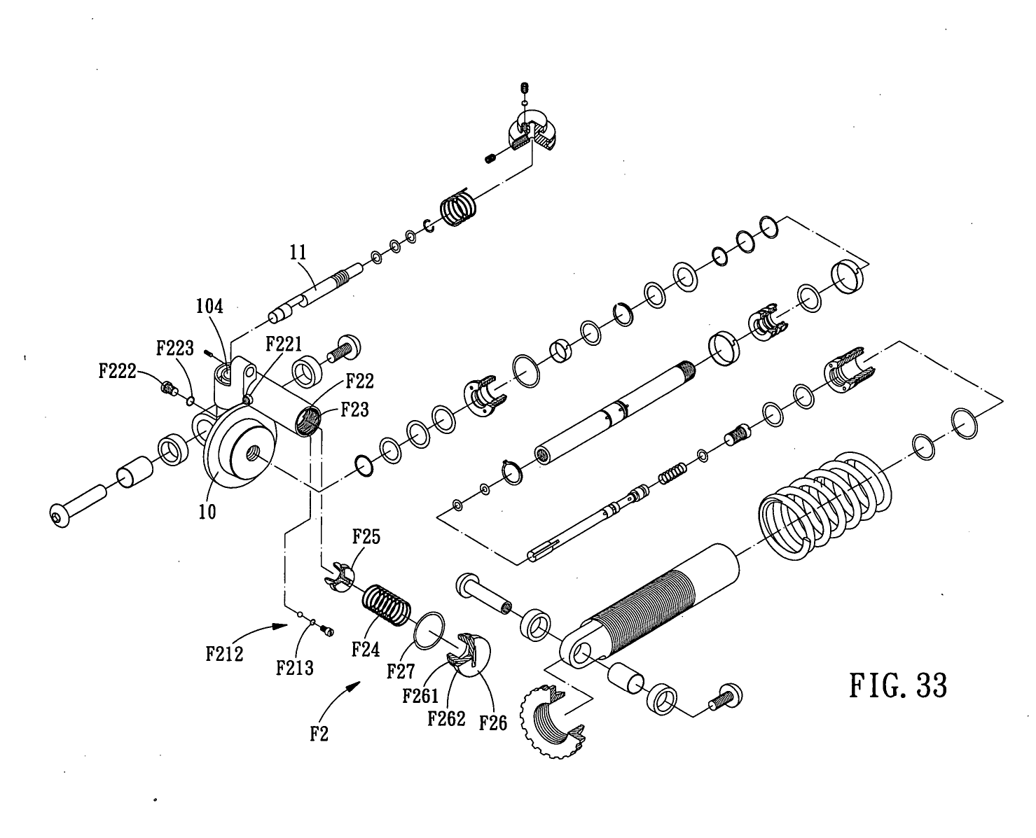

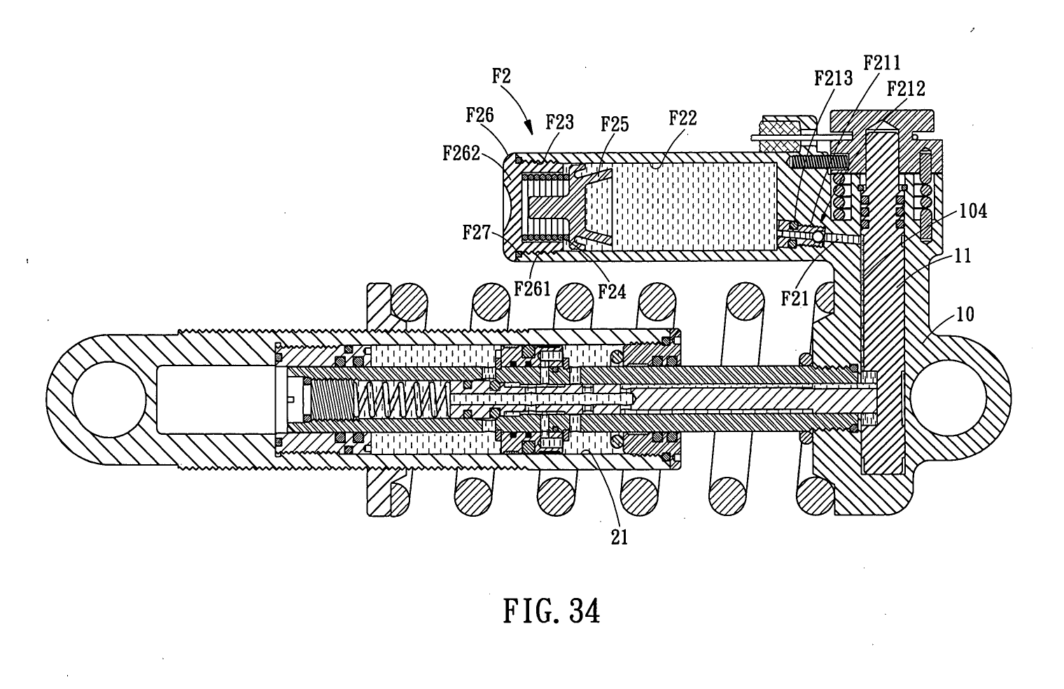

Referring to FIGS. 33 and 34, an oil shock absorber in accordance with a fourth embodiment of the present invention is shown, and it is revised from the oil shock absorber of the third embodiment, therefore, in the following, only the differences from the third embodiment are explained.

The oil shock absorber in this embodiment is additionally provided with an oil-feeding assembly F2 which is fixed on the base 10 of the control assembly A. Provided at the same side of the base 10 as the control hole 104 is a feed passage F21 which is connected to a oil-feeding cylinder F22. At a free end of the oil-feeding cylinder F22 are formed inner threads F23. Another end of the feed passage F21 is connected to the control hole 104. In the oil-feeding cylinder F22 are disposed a spring F24 and a plug F25. A threaded cap F26 having outer threads F261 and an annular flange F262 is screwed with the inner threads F23 of the oil-feeding cylinder F22 by using an oil seal F27. The oil-feeding assembly F2 uses the spring F24 to move the plug F25, so as to replenish the oil from the oil-feeding cylinder F22. At the connection between the feed passage F21 and the oil-feeding cylinder F22 is formed a threaded hole F211 in which is disposed an oil-feeding check valve F212 and an oil seal F213. The oil-feeding check valve F212 allows the oil in the oil-feeding cylinder F2 to flow to the oil cylinder 21 of the damper assembly B while preventing the oil in the oil cylinder 21 of the damper assembly B from flowing back to the oil-feeding assembly F2. A threaded hole F221 is formed on the oil-feeding cylinder F22 and located adjacent to the oil cylinder 21 and provided for accommodating a transparent screw F222 and an oil seal F223. The transparent screw F222 acts as a viewport for enabling the user to observe the oil level of the oil-feeding cylinder F22.

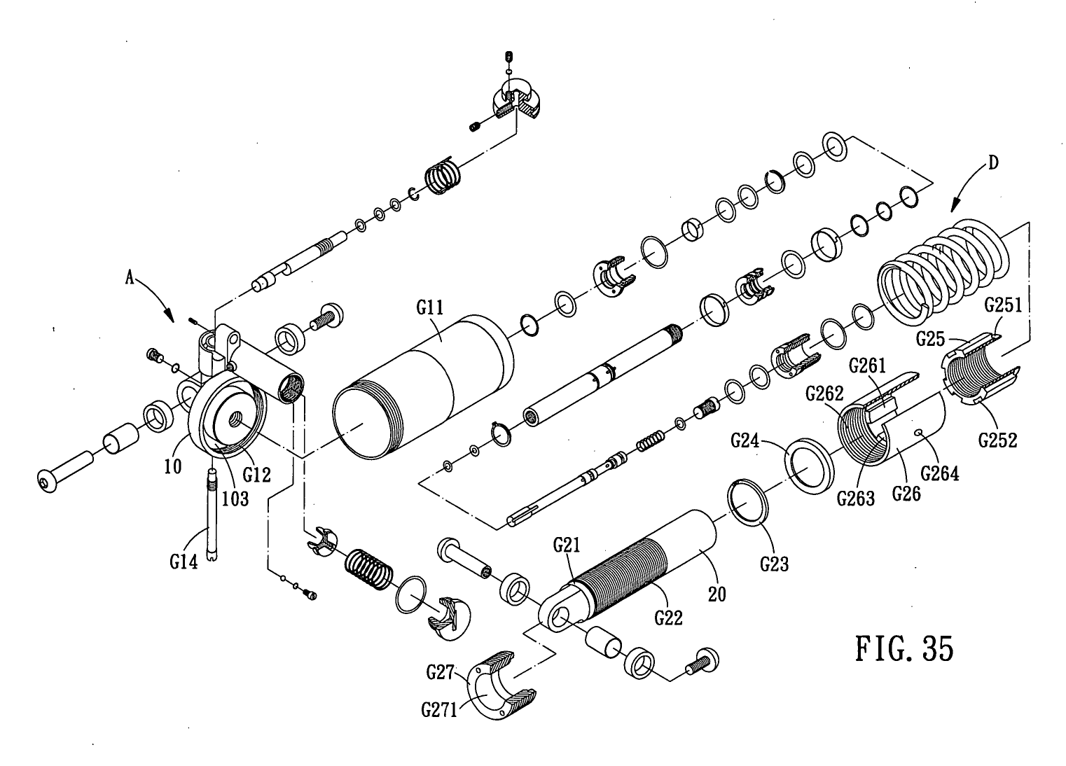

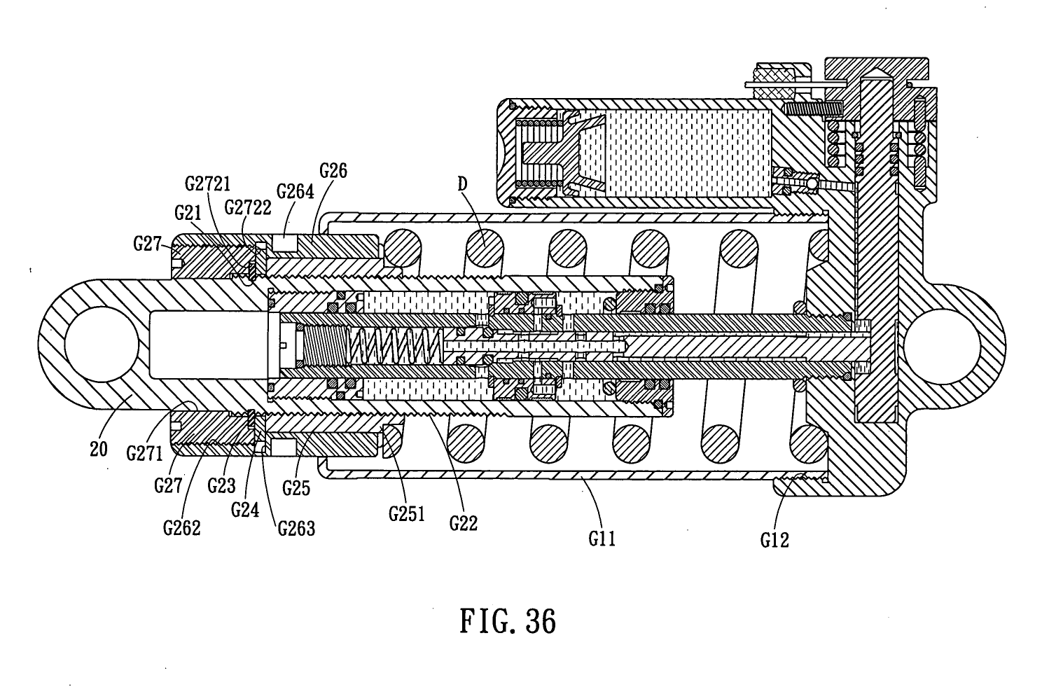

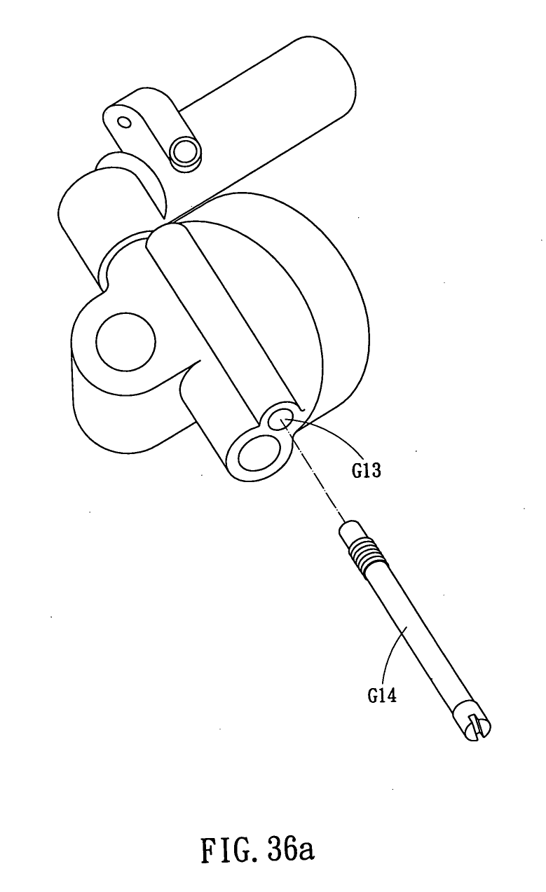

Referring to FIGS. 35 and 36, an oil shock absorber in accordance with a fifth embodiment of the present invention is shown, and it is revised from the oil shock absorber of the fourth embodiment, therefore, in the following, only the differences from the fourth embodiment are explained.

The oil shock absorber in this embodiment is additionally provided with an outer cap G11 and an adjusting member for adjusting the elastic force of the buffering spring.

On the outer surface of the spring retaining portion 103 of the base 10 of the control assembly A are provided with outer threads G12 and a storage hole G13 for storage of an adjusting tool G14 (as shown in FIG. 36a).

At an end of the outer surface of the housing 20 of the damper assembly B is provided an engaging groove G21 and outer threads G22. A retainer G23 is disposed in the engaging groove G21, adjacent to the retainer G23 are a washer G24 and a movable ring G25 screwed with the outer threads G22 of the housing 20. Formed at an end of the movable ring G25 is a spring retaining portion G251, and formed on the outer surface of the movable ring G25 are locking portions G252. A rotary ring G26 is mounted onto the movable ring G25, at an end of the inner diameter of the rotary ring G26 are formed locking portions G261 for locking with the locking portions G252 of the movable ring G25. At another end of inner surface of the rotary ring G26 are provided inner threads G262, and between the inner threads G262 and the locking portions G261 are positioning surfaces G263. An annular screw nut G27 is screwed with the inner threads G262 of the rotary ring G26, and the inner surface G271 of the annular screw nut G27 circularly mounted onto the housing 20. At an end of the inner surface G271 is provided an inner step portion G272, an end surface of a small diameter portion G2721 of the inner step portion G272 abuts against the retainer G23 of the housing 20, while an end surface of a big diameter portion G2722 of the inner step portion G272 abuts against the washer G24 and the positioning surface G263 of the rotary ring G26. Therefore, the rotary ring G26 is rotatable but not axially displaceable relative to the housing 20. The rotation of the rotary ring G26 will give rise to a displacement of the adjusting ring G25, so that the elastic force of the buffering spring D is adjusted. On the outer surface of the rotary ring G26 are provided a plurality of blind holes G264 for insertion of tools used to rotate the rotary ring G26.

The outer cap G11, an end of which is screwed with the outer threads G12 of the control assembly A, another end of which is moveably mounted onto the rotary ring G26. Thereby, the outer cap G11 not only improves the out appearance but also provides a good dust proof effect.

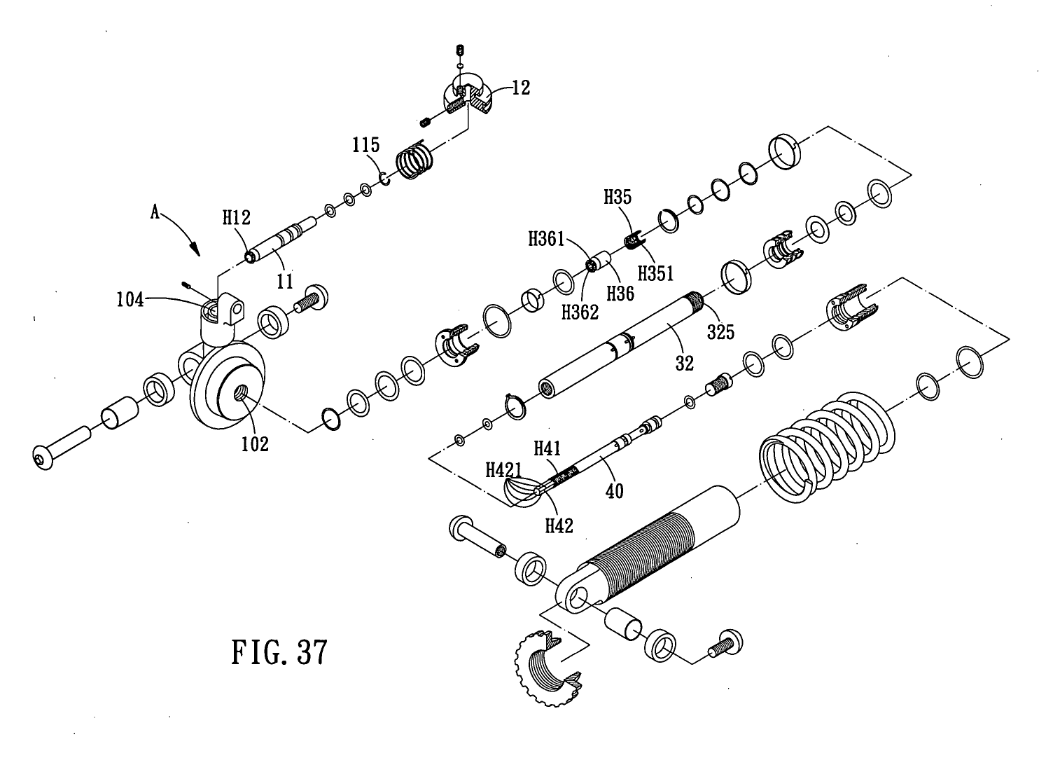

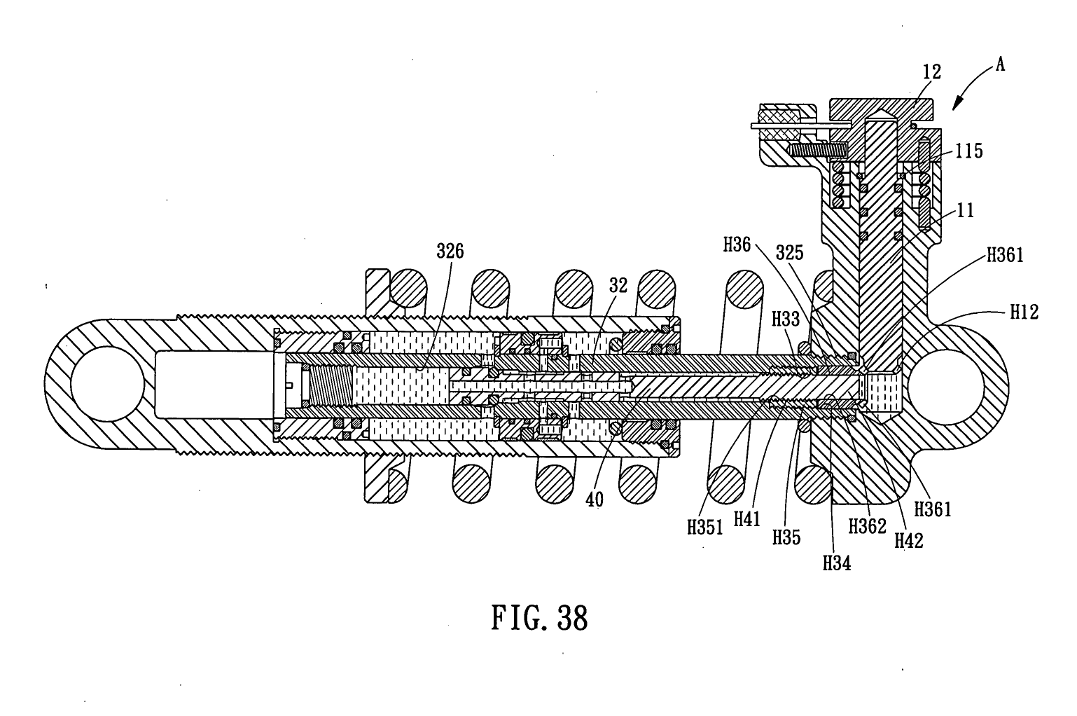

Referring to FIGS. 37 and 38, an oil shock absorber in accordance with a sixth embodiment of the present invention is shown, and it is revised from the oil shock absorber of the third embodiment, therefore, in the following, only the differences are explained. The structure of the control shaft 11 in this embodiment is changed.

The control shaft 11 is rotatably disposed in the control hole 104 of the control assembly A, an end of the control shaft 11 is connected to the rotary button 12 and is positioned by a retainer 115, and another end of the control shaft 11 is provided with bevel gear H12.

The first outer threads 325 at an end of the shaft 32 are screwed with the threaded hole 102 of the control assembly A, still at this end of the bore 326 of the first outer threads 325 are provided inner threads H33, between the inner threads H33 and the end of the first outer threads 325 is an inner step portion H34. The inner threads H33 are screwed with an annular screw member H35 having a displacement threaded hole H351. A sleeve H36, slideably received in the inner step portion H34, is provided on its outer surface with bevel gear H361 which is engaged with the bevel gear H12 of the control shaft 11 for transmitting motion. Another end of the sleeve H36 is positioned by abutting against the annular screw member H35. Inside the sleeve H36 is a hexagonal-shaped bore H362 whose inner surface work as motion-transmitting surface H3621.

The control valve rod 40 is inserted in the bore 326 of the shaft 32 and is free to move therein, at an end of the control valve rod 40 facing the annular screw member H35 are provided displacement threads H41 and a hexagonal rod H42. The displacement threads H41 are meshed with the displacement threaded hole H351 of the annular screw member H35. The outer surface of the hexagonal rod H42 act as a motion-transmitting surface H421 to work with the motion-transmitting surface H3621 of the hexagonal bore H362 of the sleeve H36 to transmit motion. The hexagonal rod H42 is free to move in the hexagonal bore H362.

When rotates the control shaft 11, the toothed wheel H12 will drive the sleeve H36 to rotate (the bevel gear H361 on the sleeve H36 works with the bevel gear H12 of the control shaft 11 to transmit motion). Meanwhile, the motion-transmitting surface H3621 in the hexagonal bore H362 of the sleeve H36 will rotate the motion-transmitting surface H421 of the hexagonal rod H42, and then the displacement threads H41 of the hexagonal rod H42 will work with the displacement threaded hole H351 of the annular screw member H35 in the bore 326 of the shaft 32. therefore, the control valve rod 40 is driven by the control shaft 11 to move in the bore 326 of the shaft 32, so as to control the action of the oil shock absorber, when the control valve rod 40 moves, the hexagonal rod H42 slides in the H362 of the sleeve H36.

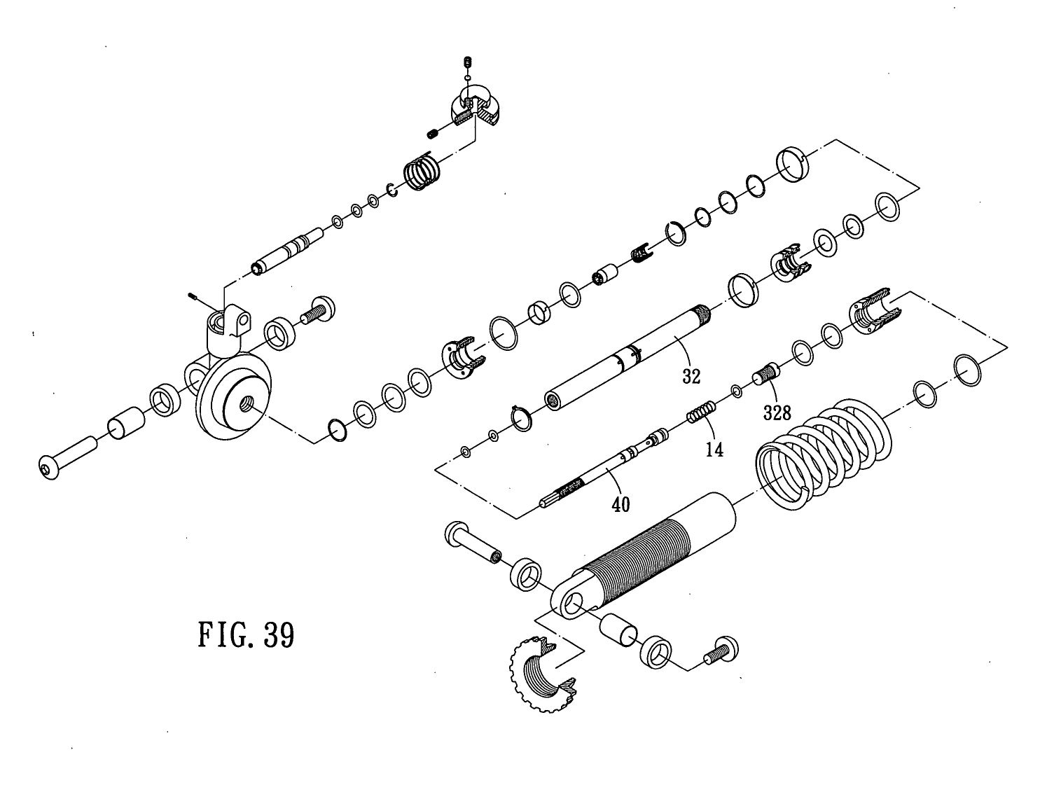

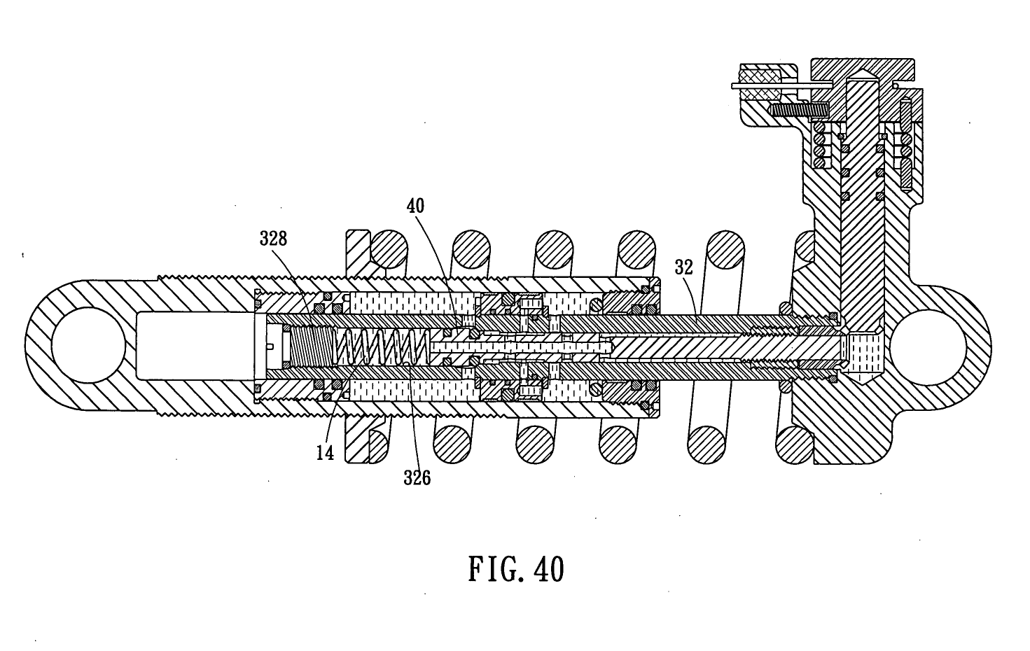

Referring to FIGS. 39 and 40, an oil shock absorber in accordance with a seventh embodiment of the present invention is revised from the sixth embodiment by adding a control spring 14, therefore, in the following, only the differences are explained.

The oil shock absorber in this embodiment is additionally provided with a control spring 14 which is received in the bore 326 of the shaft 32 and biased between the control valve rod 40 and the leak proof screw 328, the control spring 14 pushes the control valve rod 40 with its elastic force so as to eliminate the clearances between the respective motion-transmitting components.

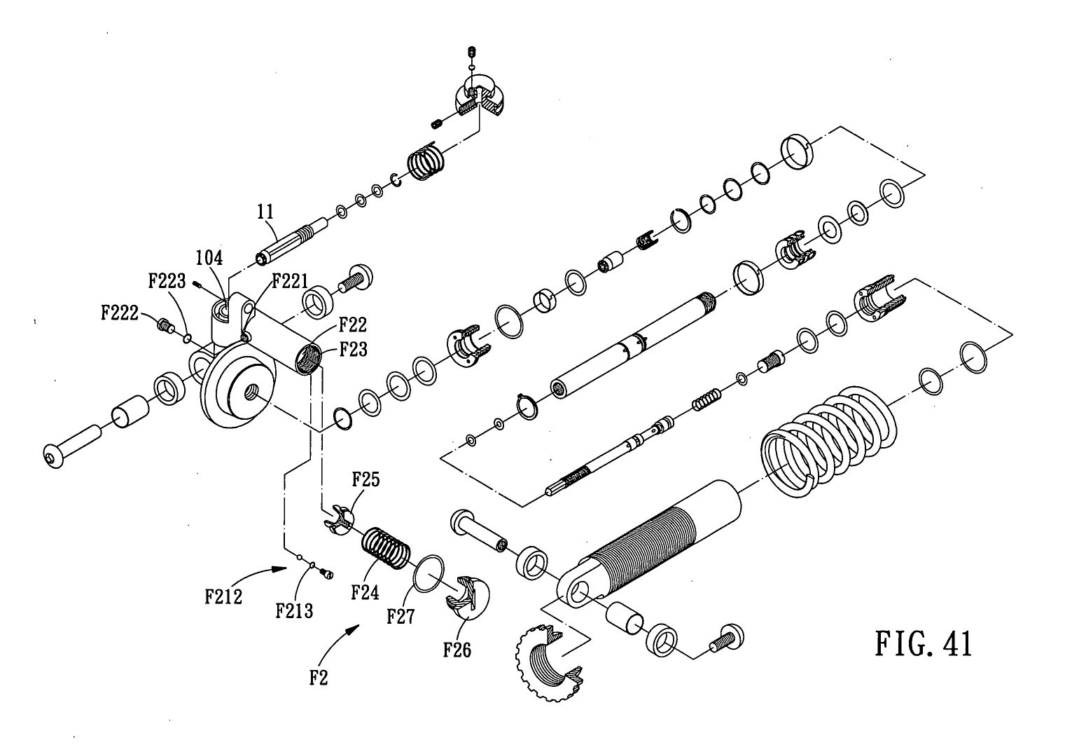

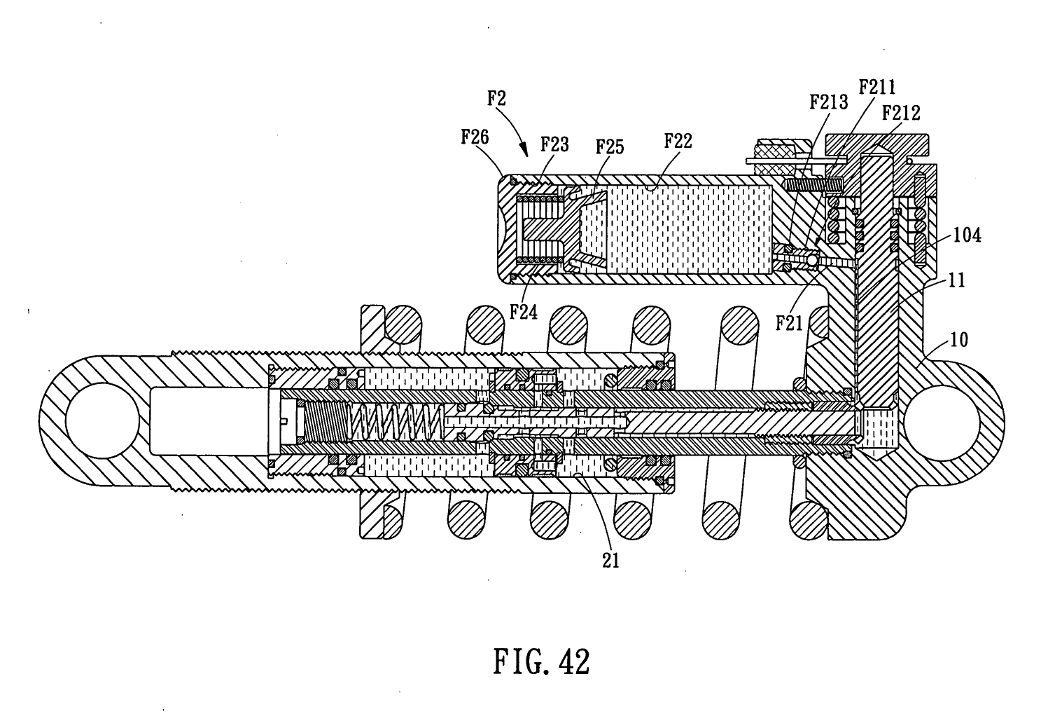

Referring to FIGS. 41 and 42, an oil shock absorber in accordance with a eighth embodiment of the present invention is revised from the seventh embodiment but is additionally provided with an oil-feeding assembly F2 whose structure is identical with the fourth embodiment, therefore, further descriptions are omitted.

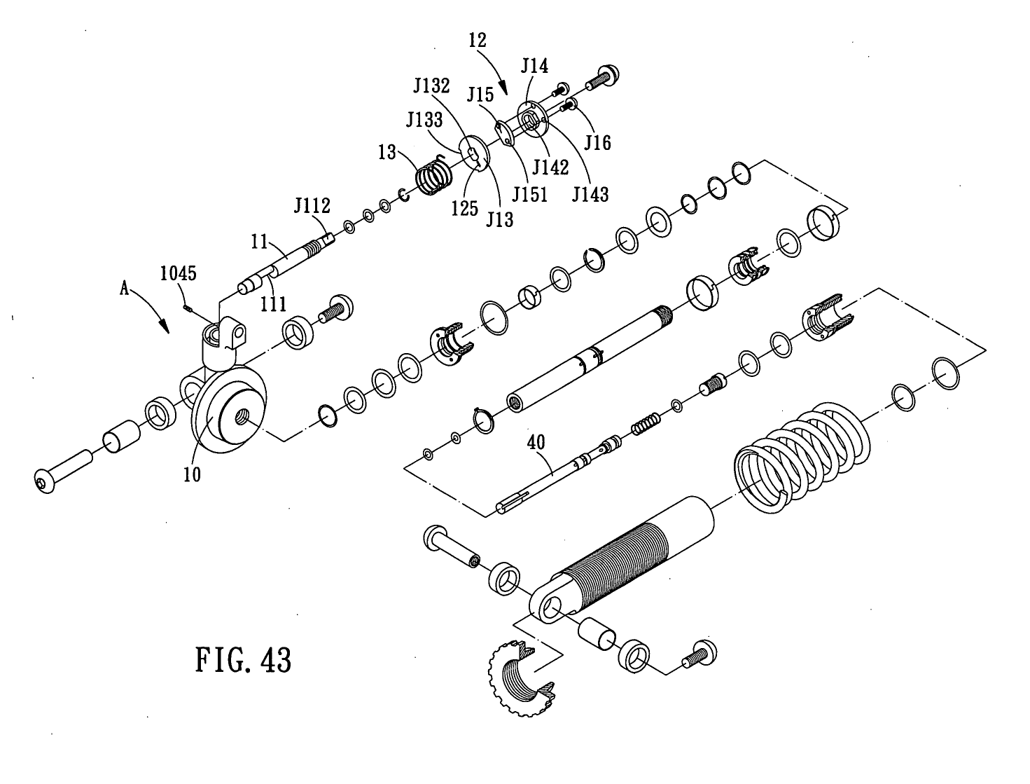

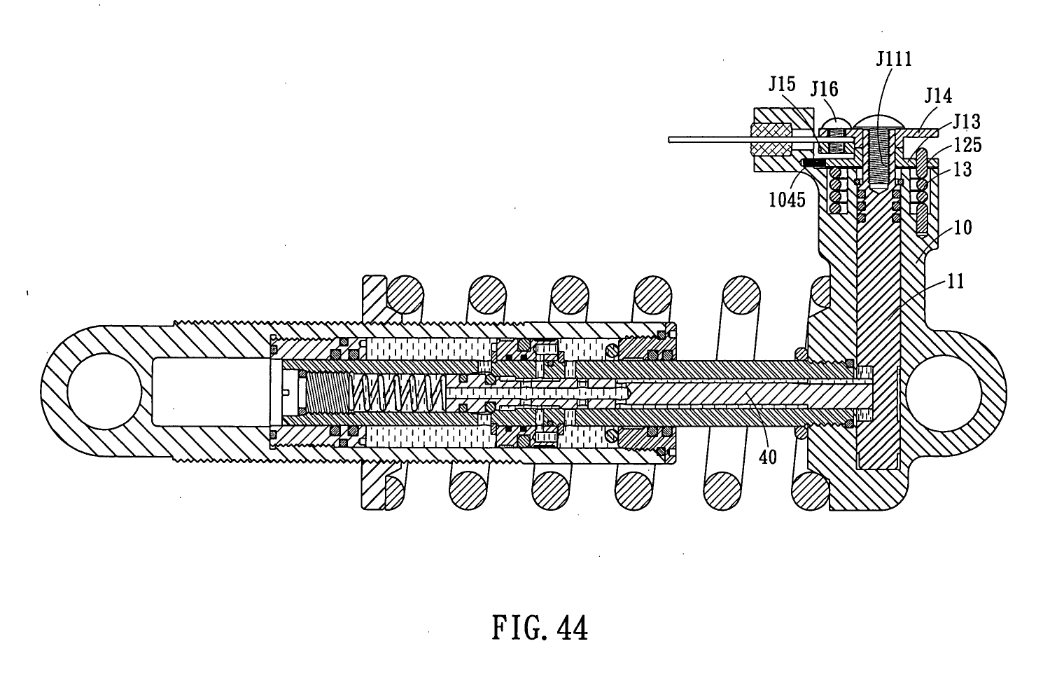

Referring to FIGS. 43 and 44, an oil shock absorber in accordance with a ninth embodiment of the present invention is revised from the third embodiment, therefore, in the following, only the differences are explained. The structure of the rotary button 12 in this embodiment is changed.

The control shaft 11 is provided at its end facing the rotary button 12 with a threaded hole J111 and flat surfaces J112 at both sides of the outer diameter of the threaded hole J111.

The rotary button 12 comprises a first rotary member J13, a second rotary member J14 and a positioning block J15. At both sides of a bore J131 of the first rotary member J13 are flat surfaces J132 which serve to work with the flat surfaces J112 of the control shaft 11 to transmit motion. Formed on the outer surface of the rotary member J13 is an arc groove J133 serving to work with the positioning threaded rod 1045 so as to fix the rotation angle. Formed on the first rotary member J13 is a spring retaining hole 125 for accommodation of an end of a return spring 13. At both sides of the bore J141 of the second rotary member J14 are flat surfaces J142 which serve to the flat surfaces J112 of the control shaft 11 for transmitting motion. At the bottom of the second rotary member J14 are formed two through holes J143.

The positioning block J15 disposed between the first and the second rotary members J13, J14 is provided with two threaded holes J151 for enabling a steel cord controlled by the user to be inserted between the positioning block J15 and the second rotary member J14. Two screws J16 are used to make the positioning block J15 clamp the steel cord to the second rotary member J14. By such arrangements, the rotary button 12 also can be driven by the steel cord to rotate the control shaft 11, and the eccentric abutting portion 111 of the control shaft 11 pushes the control valve rod 40 of the moving assembly C to move.

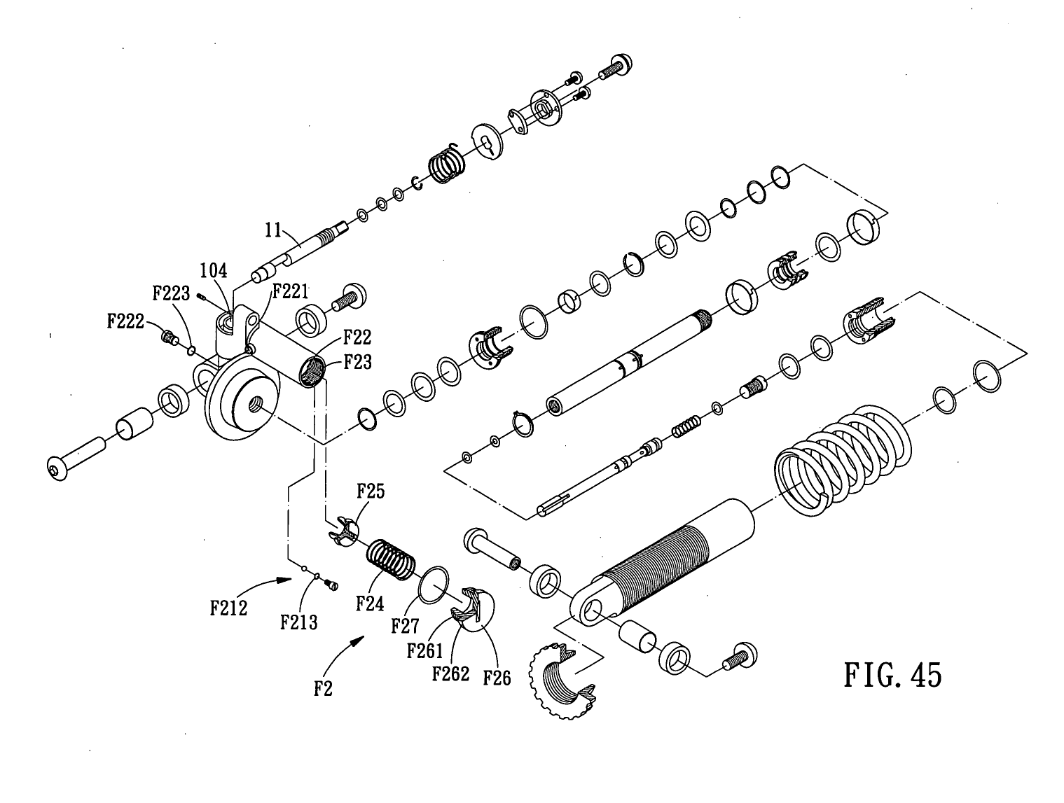

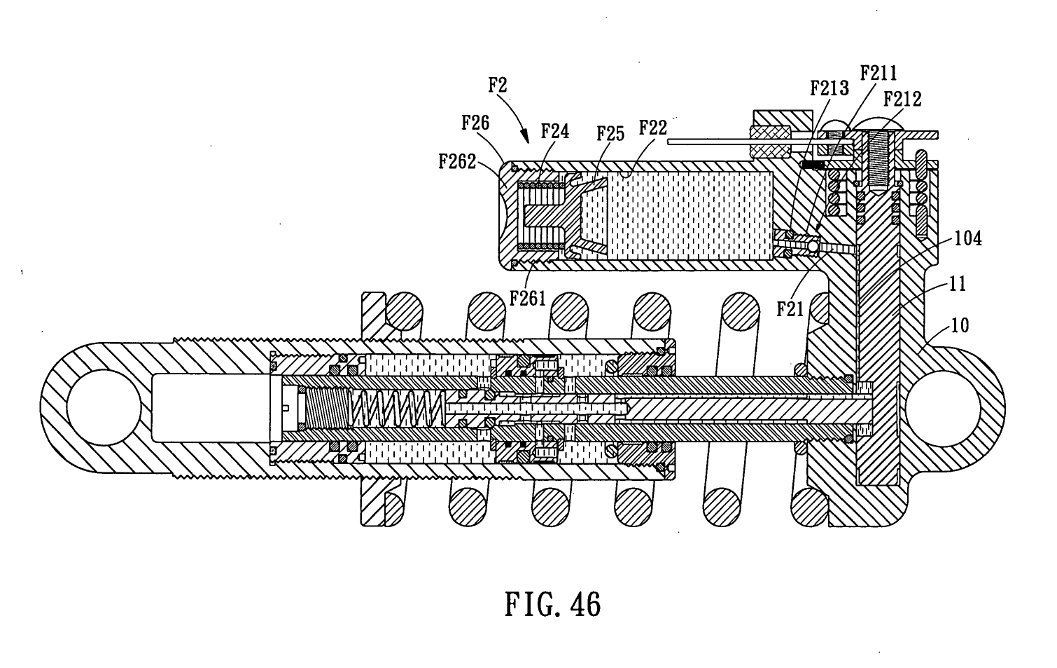

Referring to FIGS. 45 and 46, an oil shock absorber in accordance with a tenth embodiment of the present invention is revised from the ninth embodiment but is additionally provided with an oil-feeding assembly F2 whose structure is identical with the fourth embodiment, therefore, further descriptions are omitted.

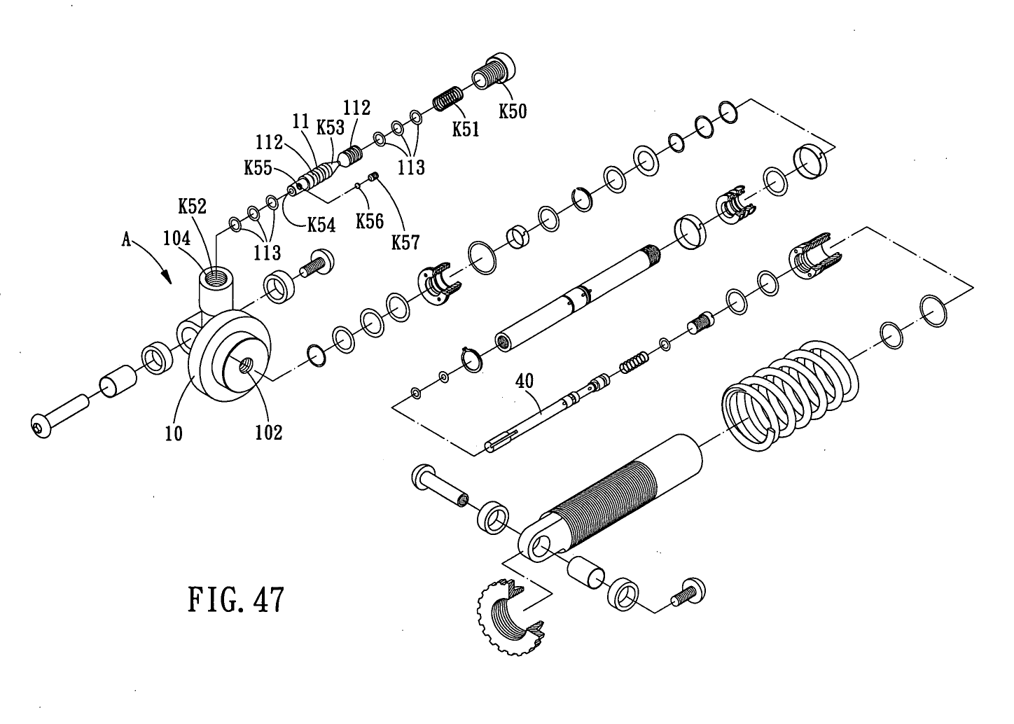

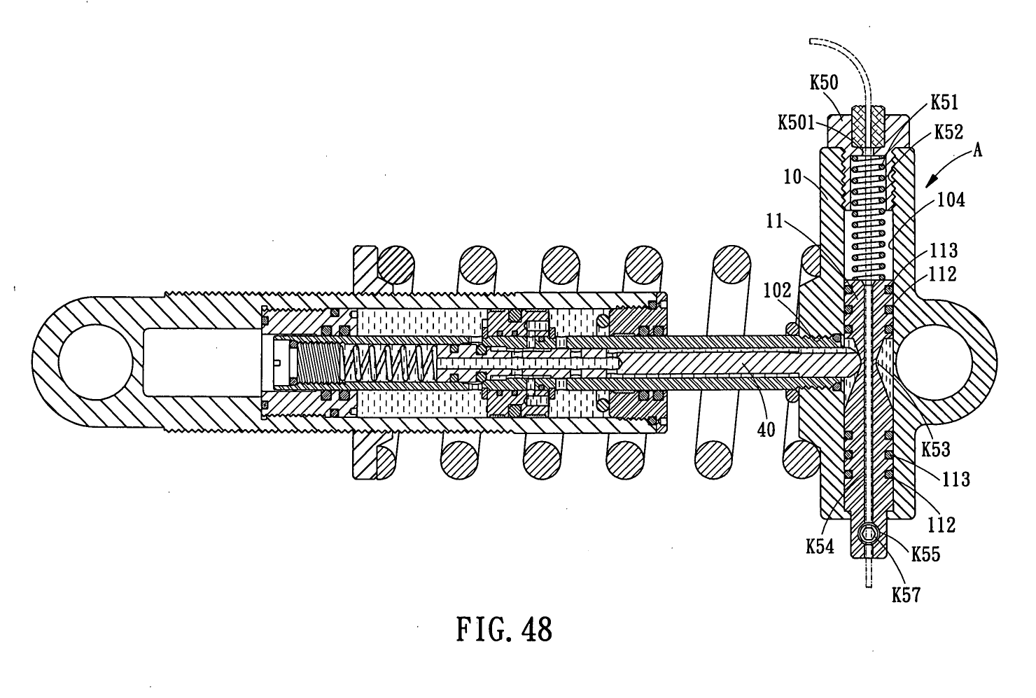

Referring to FIGS. 47 and 48, an oil shock absorber in accordance with a eleventh embodiment of the present invention is revised from the third embodiment, therefore, in the following, only the differences are explained. The structure of the control shaft 11 in this embodiment is changed.

The control assembly A comprises the base 10, the control shaft 11, a cap K50 and a return spring K51.

A control hole 104 formed on the base 10 is vertical to and in communication with the threaded hole 102, and at an end of the control hole 104 are formed inner threads K52 located opposite the threaded hole 102.

Close to the mid portion of the outer surface of the control shaft 11 is a conical notch K53, at both sides of the conical notch K53 are plural annular grooves 112 in each of which is received an oil seal 113. The control shaft 11 is provided with a through hole K54 and a positioning hole K55 in vertical to the through hole K54. Disposed in the positioning hole K55 are a washer K56 and a screw K57.

The cap K50 is screwed with the inner threads K52 of the control hole 104 to confine the return spring K51 in the control hole 104 of the base 10, in the center of the cap K50 is formed a hole K501 for introduction of the steel cord to through hole K54 of the control shaft 11, and the steel cord is positioned by the washer K56 and the screw K57.

The user can pulls the control shaft 11 with the steel cord so as to make the conical notch K53 push the control valve rod 40, meanwhile, the return spring K51 will store energy to return the control shaft 11 to its original position. Therefore, the user can adjust the buffering force of the shock absorber or turn on/off it according the road condition at any time.

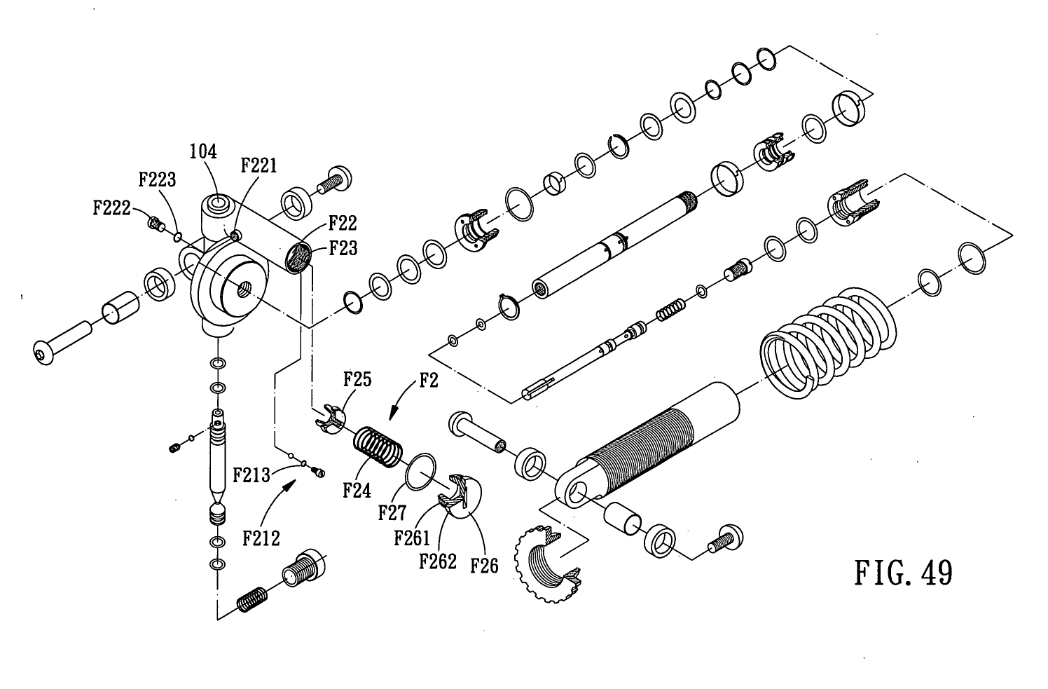

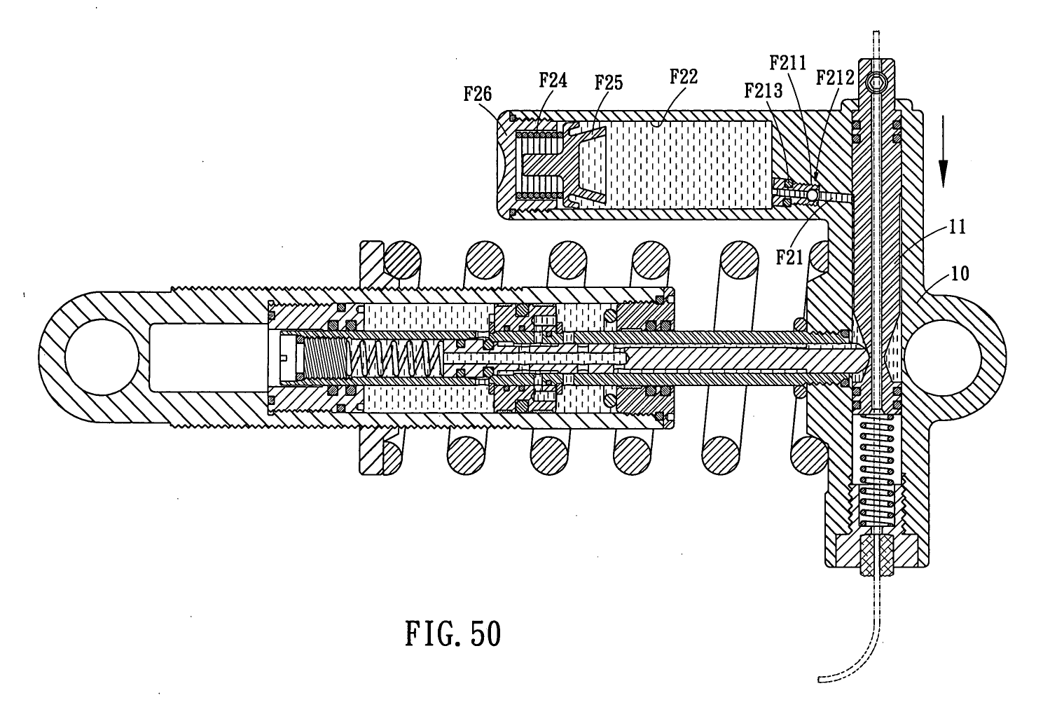

Referring to FIGS. 49 and 50, an oil shock absorber in accordance with a twelfth embodiment of the present invention is revised from the eleventh embodiment but is additionally provided with an oil-feeding assembly F2 whose structure is identical with the fourth embodiment, therefore, further descriptions are omitted.

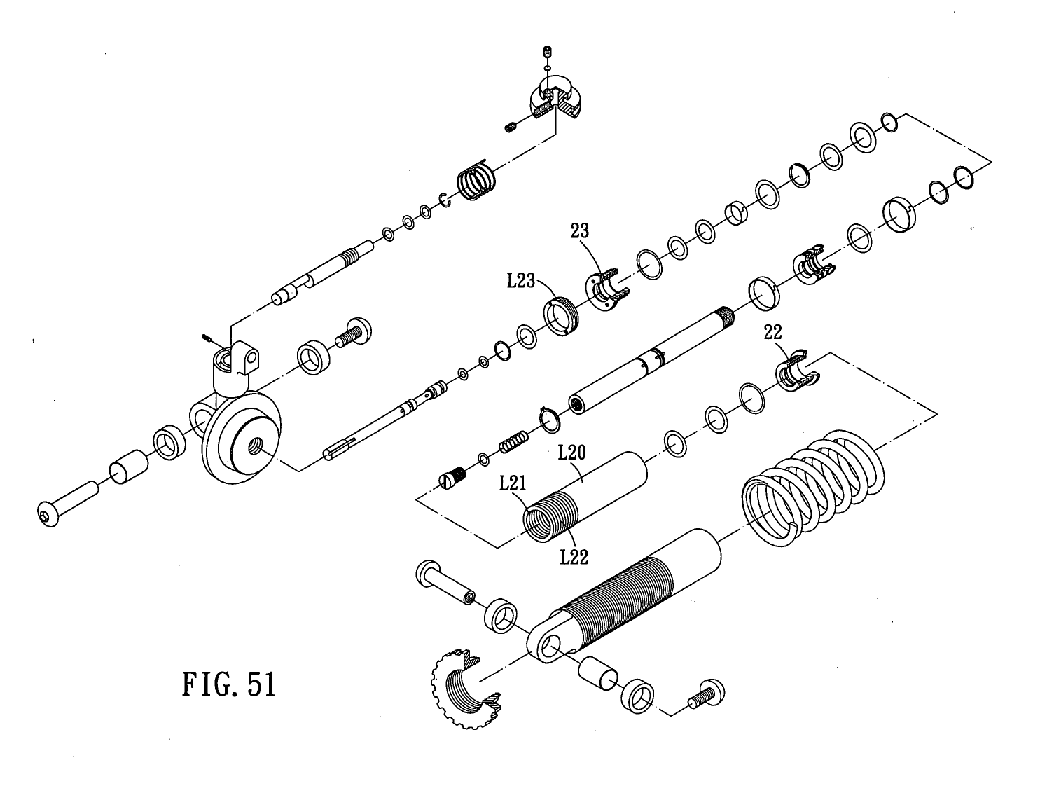

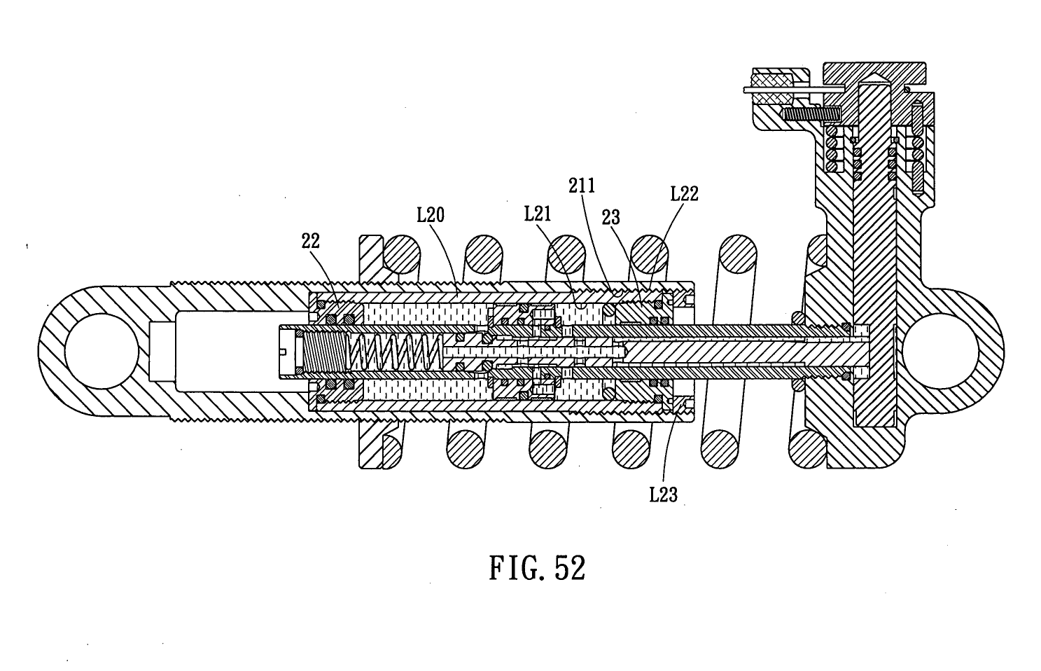

Referring to FIGS. 51 and 52, an oil shock absorber in accordance with a thirteenth embodiment of the present invention is revised from the first, the third, the fourth, the fifth, the sixth, the seventh, the eighth, the ninth, the tenth, the eleventh and the twelfth embodiments but is additionally provided with an oil cylinder L20 in the damper assembly B (with reference to FIG. 32 for example), a bore L21 is formed in the oil cylinder L20, and a first leak proof member 22 and a second leak proof member 23 are screwed to either side of the bore L21. On the outer surface of the oil cylinder L20 are provided outer threads L22 for screwing with the inner threads 211 of the damper assembly B, and an annular screw member L23 is used to enhance screwing connection. The rest structure of this embodiment is the same as other embodiments, therefore, further explanations are omitted.

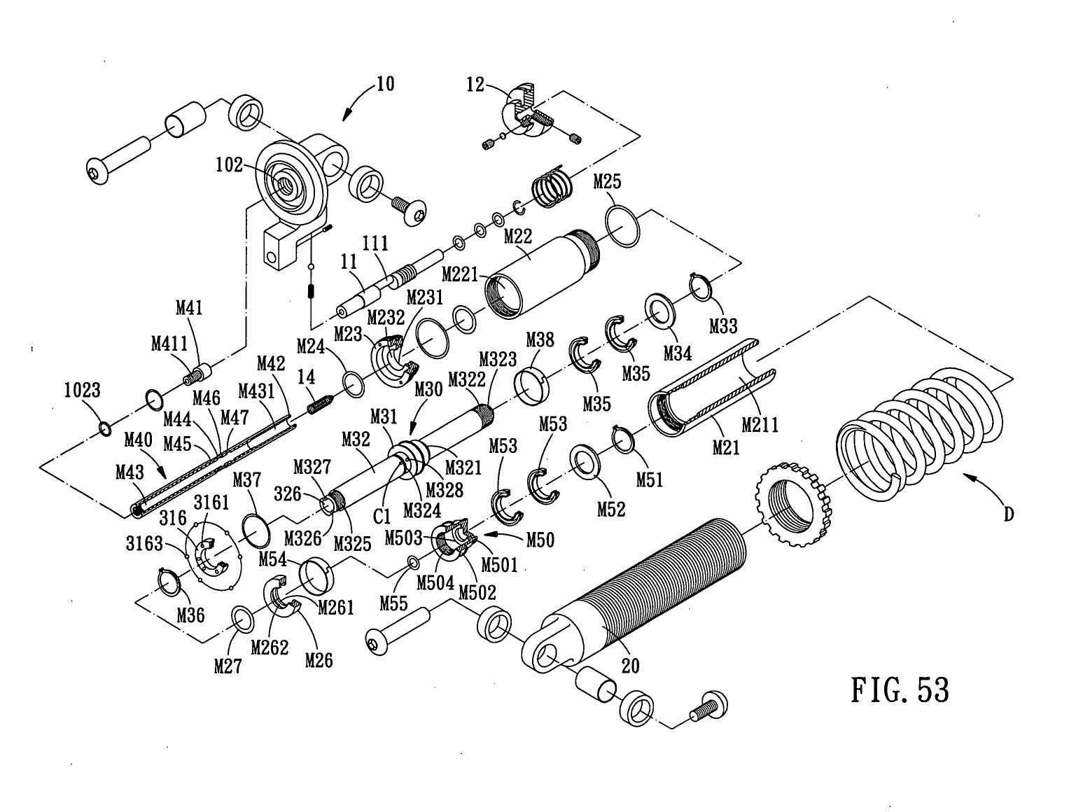

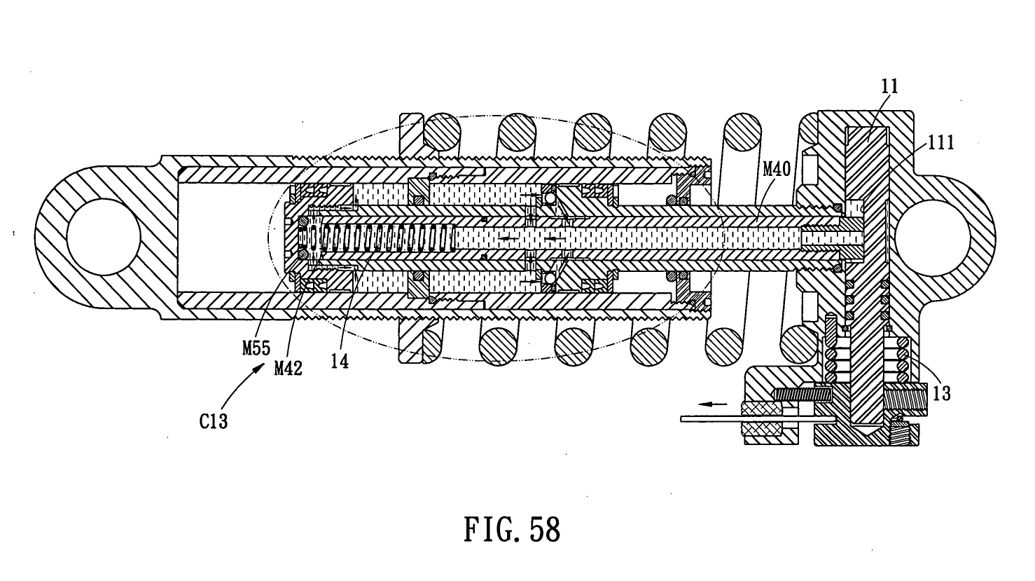

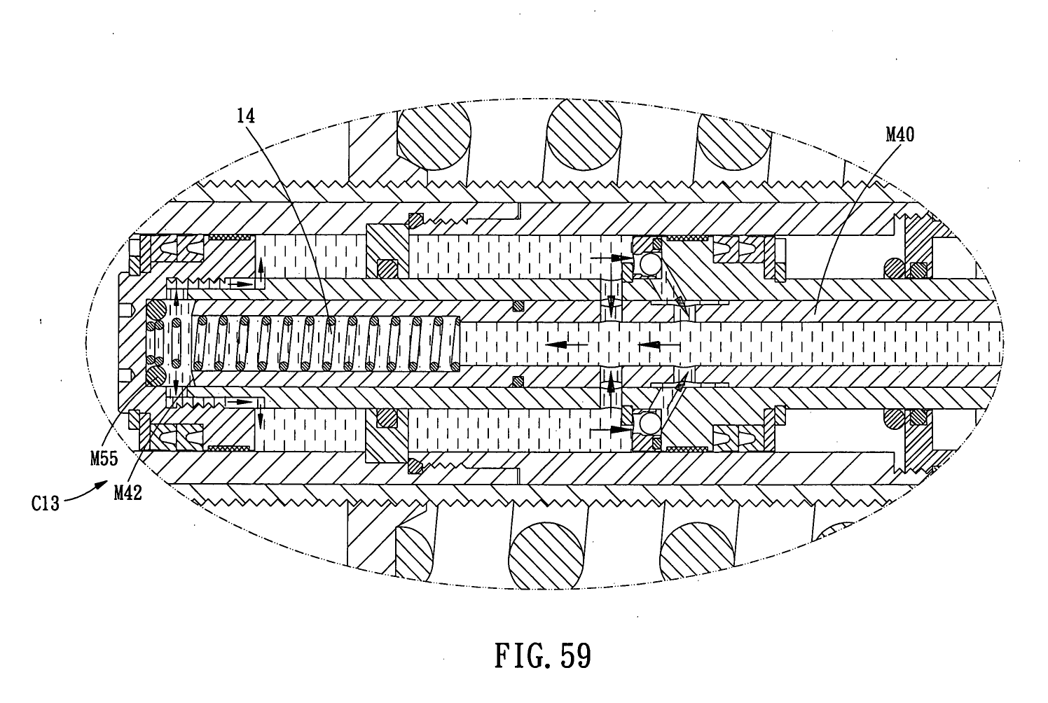

Referring to FIGS. 53-59, an oil shock absorber in accordance with a fourth embodiment of the present invention is revised by dividing the oil cylinder L20 of the thirteenth embodiment into a first oil cylinder M21 and a second oil cylinder M22, the followings are about the revised structure:

The damper assembly B, in which are formed the first oil cylinder M21 and the second oil cylinder M22 connected together by an annular screw member M23. The screw member M23 is formed an inner bore M231 in which is provided an annular groove M232 for receiving an oil seal M24. Between the first and the second oil cylinders M21, M22 is screwed a ring M26 and an oil seal M25 used to enhance the tight connection therebetween. In the ring M26 is a bore M261 and an annular groove M262, disposed in the annular groove M26 is an oil seal M27. The ring M26 serves to create a first oil chamber W1 in the bore M211 of the first oil cylinder and a second oil chamber W2 in the bore M221 of the second oil cylinder M22.

The moving assembly C comprises a piston unit M30, a control valve rod M40 and a leak proof seat M50.

The piston unit M30 consists of a piston M31 integrally formed with a shaft M32.

A first retainer M33 and a washer M34 are used to position an oil seal M35 on an end of the outer surface of the piston M31, and a second retainer M36 is used to fix the check valve unit 316 and an oil seal M37 at another end of the piston M31. The check valve unit 316 includes a check valve port 3161 and a valve 3163. At an end of the check valve port 3161 facing the second retainer M36 is formed a close surface 3162, another end of the check valve port 3161 is an open end. The check valve port 3161 can be closed by moving the valve 3163 toward the close surface 3162, and it can be opened by moving the valve 3163 away from the close surface 3162. On the outer surface of the piston M31 is provided a friction ring M38 which works with an oil seal M37 to seal the piston M31 in the bore M221 of the second oil cylinder M22, and the piston M31 is free to move therein.

At an end of the outer surface of the shaft M32 is provided a first engaging groove M321 for accommodation of the first retainer M33, still at this end of the outer surface of the shaft M32 are provided the first outer threads M322 and outer step portion M323 which are protruded out of the inner bore M231 of the annular screw member M23 and screwed with the threaded hole 102 and the oil seal 1023 of the base 10 of the control assembly A.

At another end of the outer surface of the shaft M32 are provided second outer threads M325 and a second engaging groove M324, in the second engaging groove M324 is received the second retainer M36. This another end of the shaft M32 extends out of the inner bore M261 of the ring M26, at the end of the second outer threads M325 are provided an oil guiding groove M326 and an oil guiding clearance M327. The oil guiding clearance M327 serves as a main oil passage C4. The shaft M32 has a bore 326, a first guiding hole C1 is located beside the second engaging groove M324, and an oil guiding hole M328 is located on the shaft M32 in response to the check valve port 3161.

The control valve rod M40 slidably disposed in the bore 326 of the shaft M32, an end of which is screwed with a plug M41 which serves to abut against the eccentric abutting portion 111 of the control shaft 11. The control valve rod M40 is driven to move by the eccentric abutting portion 111. An oil guiding bore M411 is formed in the plug M41. Another end of the control valve rod M40 is provided contacting surface M42.

In the control valve M40 is an oil guiding passage M43, an end of the oil guiding passage M43 is connected to the oil guiding bore M411 of the plug M41, and in another end of the oil guiding passage M43 is formed a hole M431 in which is received a control spring 14, and end of the control spring 14 is positioned at the conjunction between the hole M431 of the control valve rod M40 and the oil guiding passage M43.

On the control valve rod M40 is formed a first oil guiding hole M44 which is arranged in line with the first guiding hole C1 of the shaft M32. At first oil deflector M45 is located outside the first oil guiding hole M44, which allows the first oil guiding hole M44 to communicate with the first guiding hole C1. On the outer periphery of the control valve rod M40 and adjacent to the first oil guiding hole M44 is formed a second oil deflector M46 which is located in line with the oil guiding hole M328 of the shaft M32. A second oil guiding hole M47 is formed on the control valve rod M40 and located in line with the second oil deflector M46, so as to allow the second oil guiding hole M47 to communicate with the oil guiding hole M328. A first holding portion C7 is located between the first oil deflector M45 and the second oil deflector M46.

At an end of the outer surface of the leak proof seat M50 is formed an engaging groove M501, and a retainer M51 and a washer M52 are used to position an oil seal M53 on the outer surface of the leak proof seat M50. At another end of the outer surface of the leak proof seat M50 is formed an annular groove M502 in which is received a friction ring M54 which works with an oil seal M53 to make the leak proof seat M50 in tight contact with the bore M211 of the first oil cylinder M21, and to enable the leak proof seat M50 to move freely therealong. Inside the leak proof seat M50 is provided a oil guiding blind hole M503 in which are provided inner threads M504 and an annular groove M505. In the annular groove M505 is disposed an oil seal m55, thus forming a valve C13.

The inner threads M504 of the blind hole M503 are screwed with the second outer threads M325 of the shaft M32, and the end control shaft M32 provided with the oil guiding groove M326 is positioned at the bottom of the inner threads M504. An end of the control spring 14 of the control assembly A is positioned at a position close to the bottom of the oil guiding blind hole M503 of the leak proof seat M50 (the end of control spring 14 is a necked end which is positioned in the leak proof seat M50, while the opposite end of the control spring 14 is positioned at the bottom of the hole M431 of the control valve rod M40). When the control valve rod M40 is pushed by the eccentric abutting portion 111 of the control shaft 11 to make the contacting surface M42 move close to the oil seal M55 of the leak proof seat M50, thus the main oil passage C4 is closed. When the contacting surface M42 moves away from the oil seal M55 of the leak proof seat M50, the main oil passage C4 will be opened.

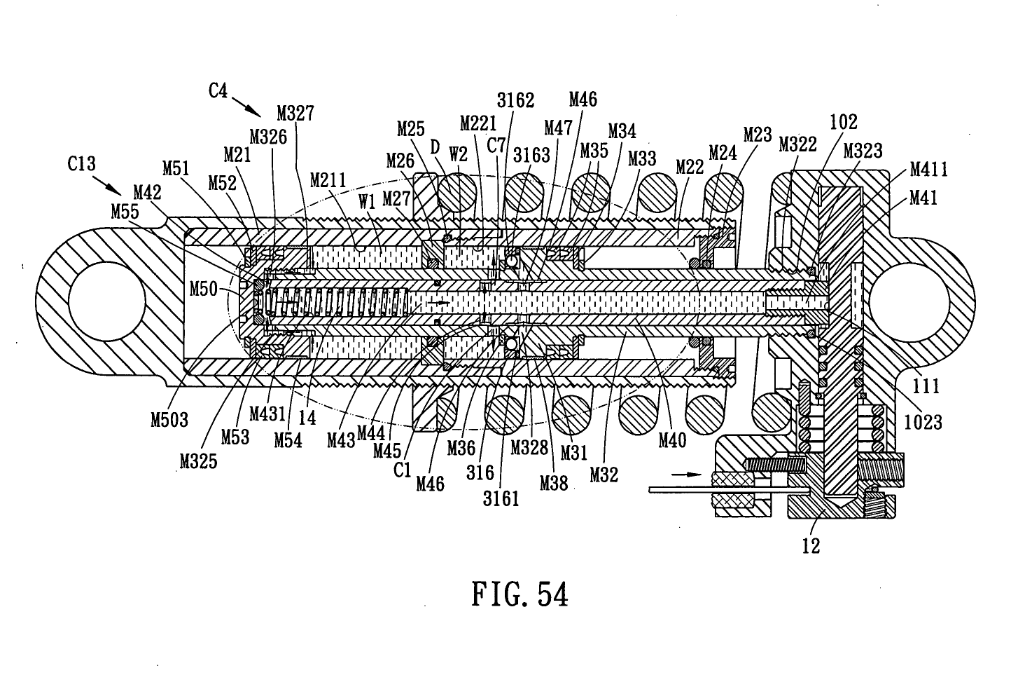

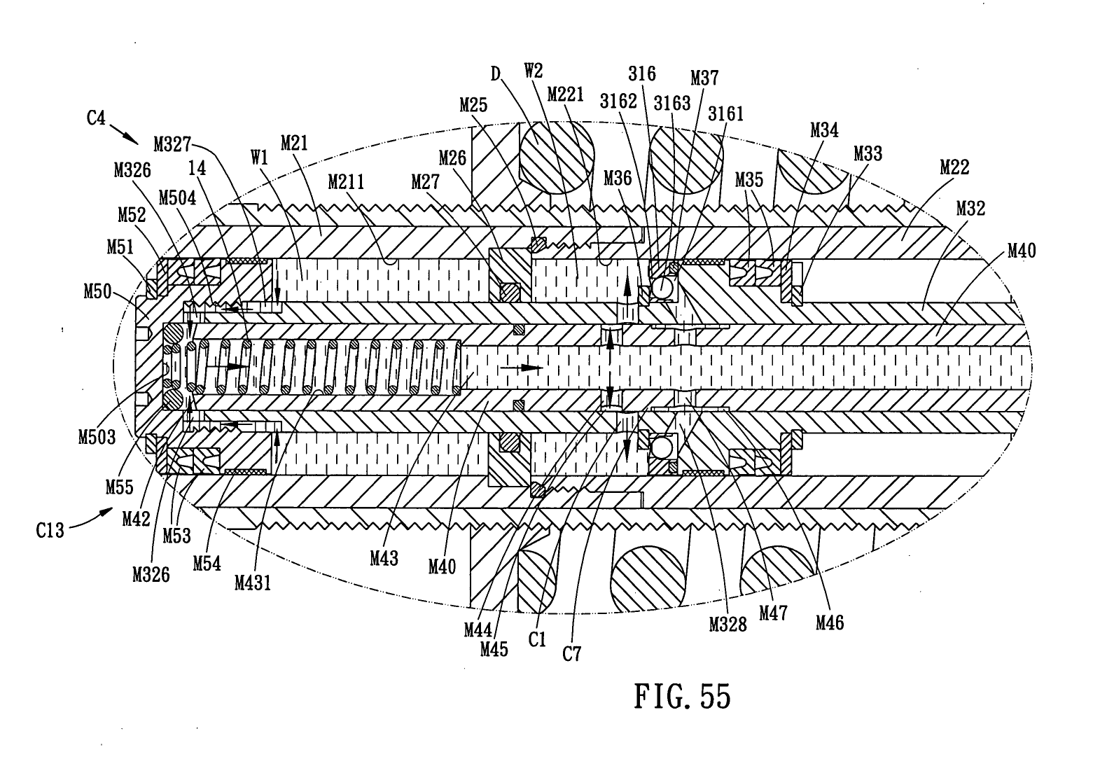

Referring to FIGS. 54 and 55, when the user sets the buffering force of the oil shock absorber by pulling the steel cord, the rotary button 12 will make the eccentric abutting portion 111 of the control shaft 11 push the control valve rod M40 to move, and the displacement of the control valve rod M40 can enable the first holding portion C7 to change the opening size of the first guiding hole C1, thus adjusting the oil flow resistance.

When the buffering spring D moves the oil shock absorber upward, the oil in the first oil chamber W1 will be compressed by the upward motion of the leak proof seat M50 and the caused oil pressure will push the valve 3163 of the check valve 316 of the piston M31 toward the close surface 3162 of the check valve port 3161, so as to close the check valve port 3161. At this moment, the oil can flow to the second oil chamber W2 only through the first guiding hole C1, the oil guiding passage M43, and the main oil passage C4. Since the first guiding hole C1 is reduced by the first holding portion C7 of the control valve rod M40, and the valve portion 3161 is closed, the oil only flows through the first guiding hole C1 of the shaft M32, the oil flow resistance within the oil shock absorber will produce a buffering force in an opposite direction to the elastic force of the buffering spring D.

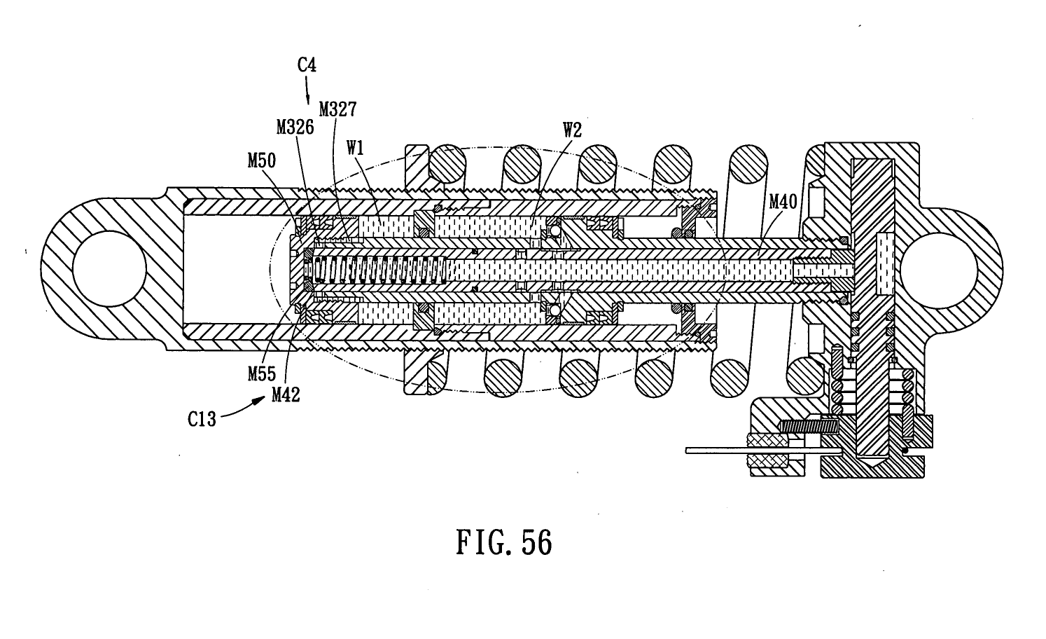

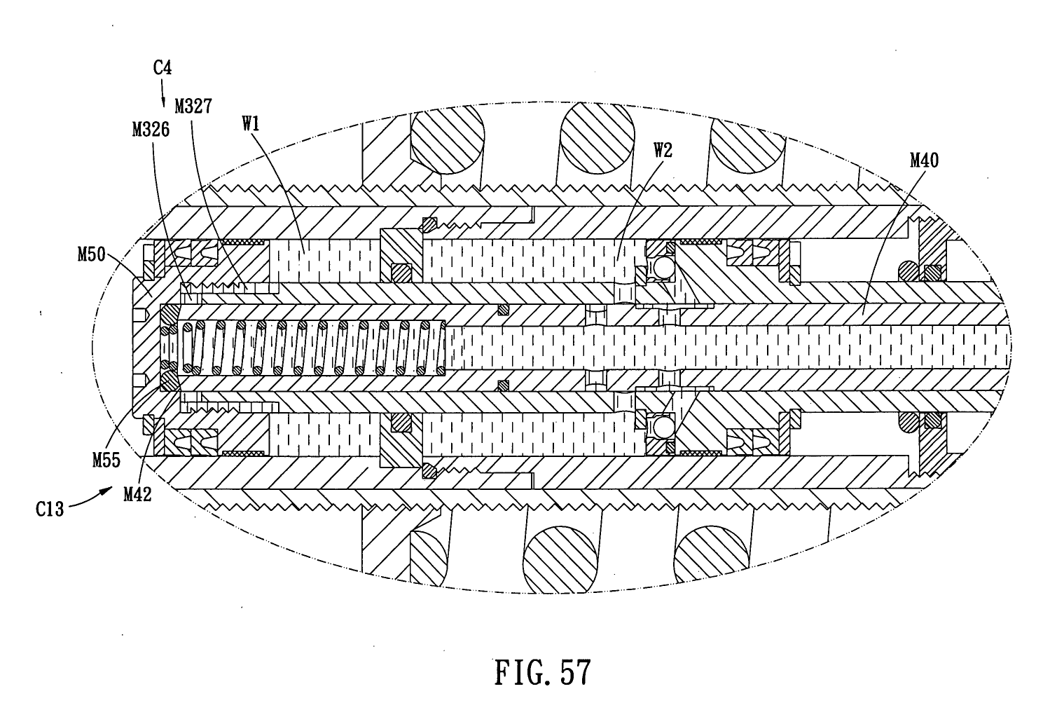

Referring to FIGS. 56 and 57, when riding up or down a slope, the user can make the contacting surface M42 abut against the oil seal M55 of the valve C13 to close the main oil passage C4 of the control shaft M32, so that the oil is unable to flow between the first and the second oil chambers W1, W2, thus the oil shock absorber is turned off.

To turn the buffering function on, the user can set the oil shock absorber at the “on” position by pulling the steel cord, and also can choose the level of buffering force, as needed. The return spring 13 will cause rotation of the eccentric abutting portion 111 of the control shaft 11, meanwhile, the control spring 14 will push the control valve rod M40 to move, so as to make the contacting surface M42 move away from the oil seal M55 of the valve C13, thus producing a buffering effect when the shock absorber moves up and down.

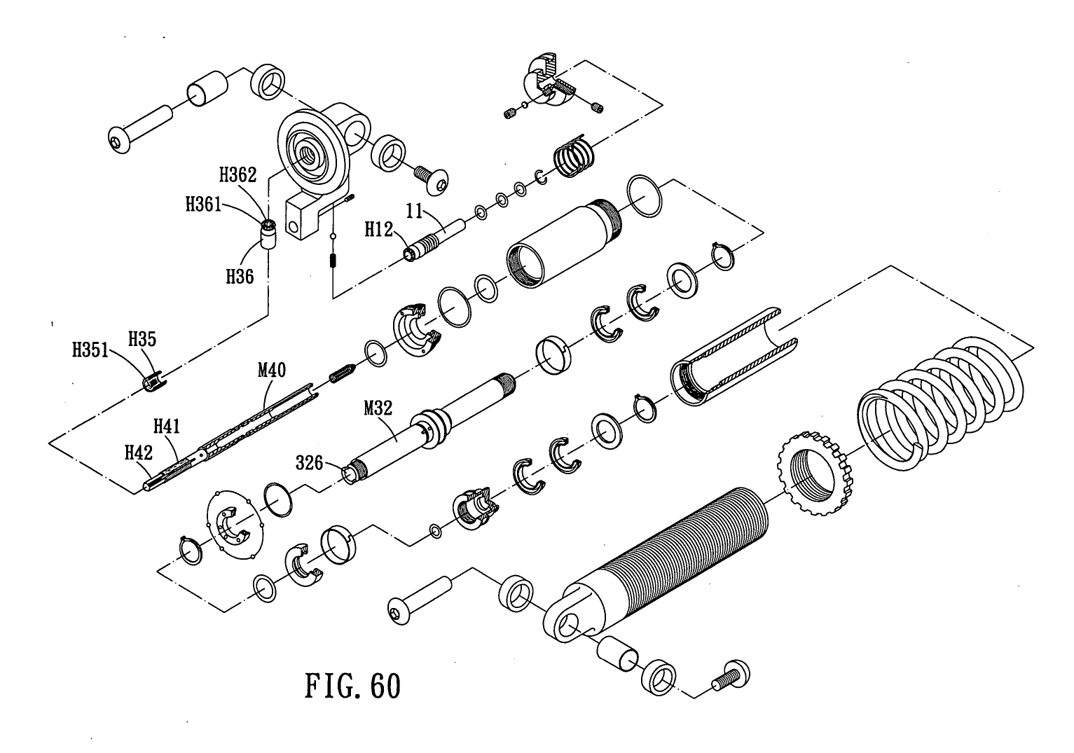

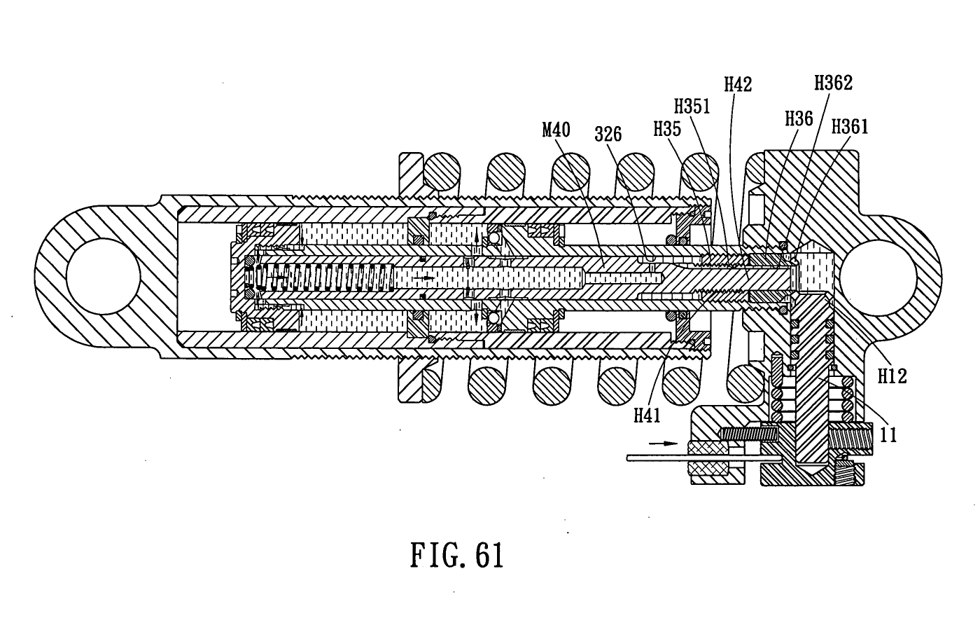

Referring to FIGS. 60 and 61, an oil shock absorber in accordance with a fifteenth embodiment of the present invention is s revised by using the control shaft 11 of the sixth embodiment on the oil shock absorber of the fourteenth embodiment, therefore, in the following, only the differences are explained.

The bevel gear H361 on the sleeve H36 works with the toothed wheel H12 of the control shaft 11 to transmit motion, the motion-transmitting surface H3621 in the hexagonal bore H362 of the sleeve H36 will rotate the motion-transmitting surface H421 of the hexagonal rod H42, and then the displacement threads H41 of the hexagonal rod H42 will work with the displacement threaded hole H351 of the annular screw member H35 in the bore 326 of the shaft M32. Therefore, the control valve rod 40 is driven by the control shaft 11 to move in the bore 326 of the shaft M32, so as to control the action of the oil shock absorber, when the control valve rod 40 moves, the hexagonal rod H42 slides in the hexagonal bore H362 of the sleeve H36. This embodiment also can control the buffering force of the shock absorber.

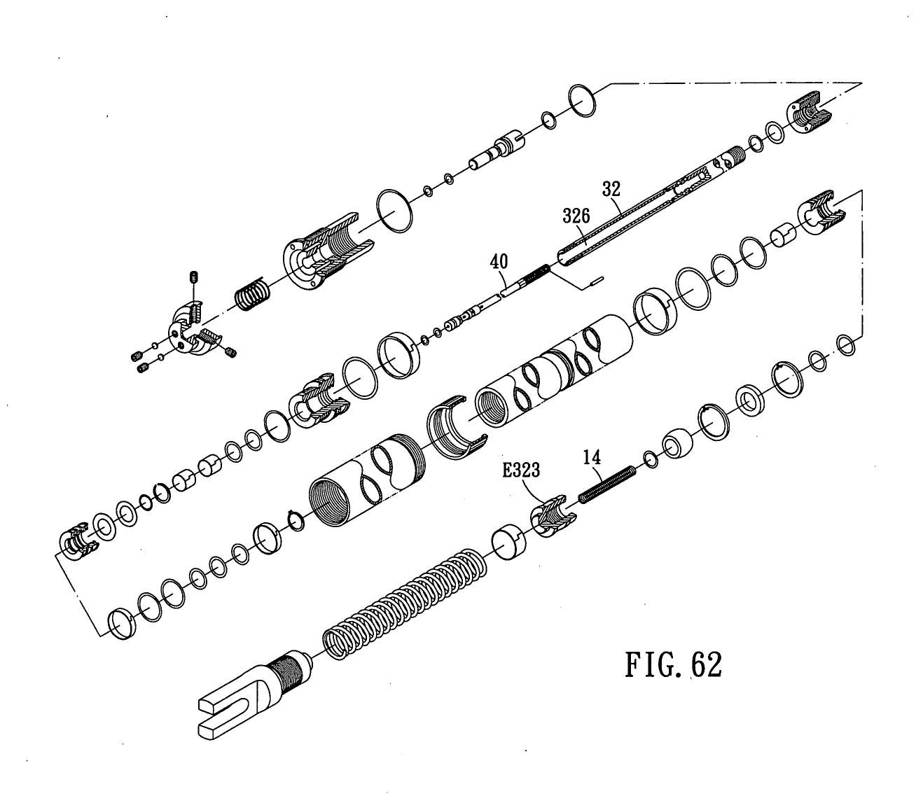

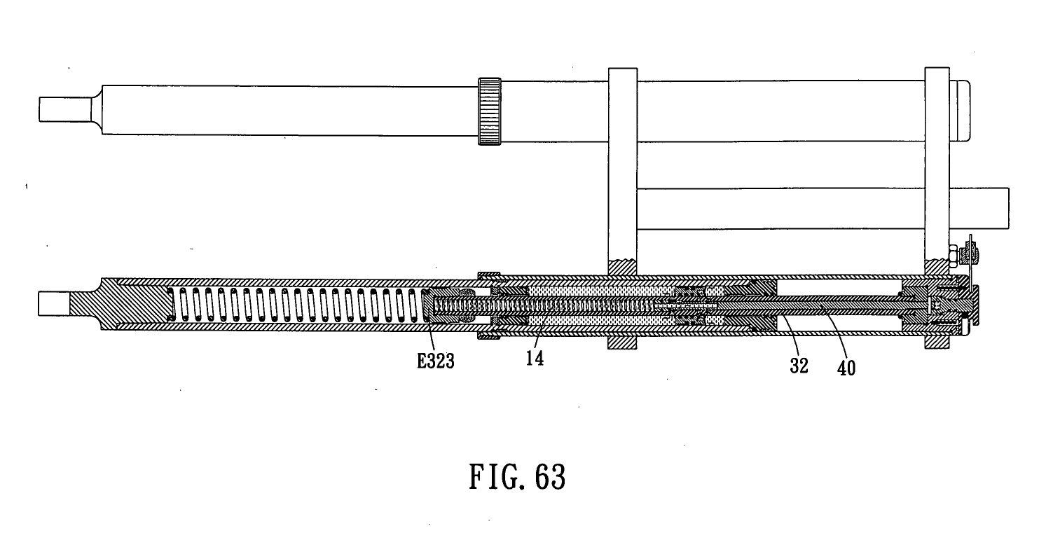

Referring to FIGS. 62 and 63, an oil shock absorber in accordance with a sixteenth embodiment of the present invention is revised from the second embodiment by adding a control spring 14, therefore, in the following, only the differences are explained.

The control spring 14 is received in the bore 326 of the shaft 32 and biased between the control valve rod 40 and the leak proof cap E323, the control spring 14 pushes the control valve rod 40 with its elastic force so as to eliminate the clearances between the respective motion-transmitting components.

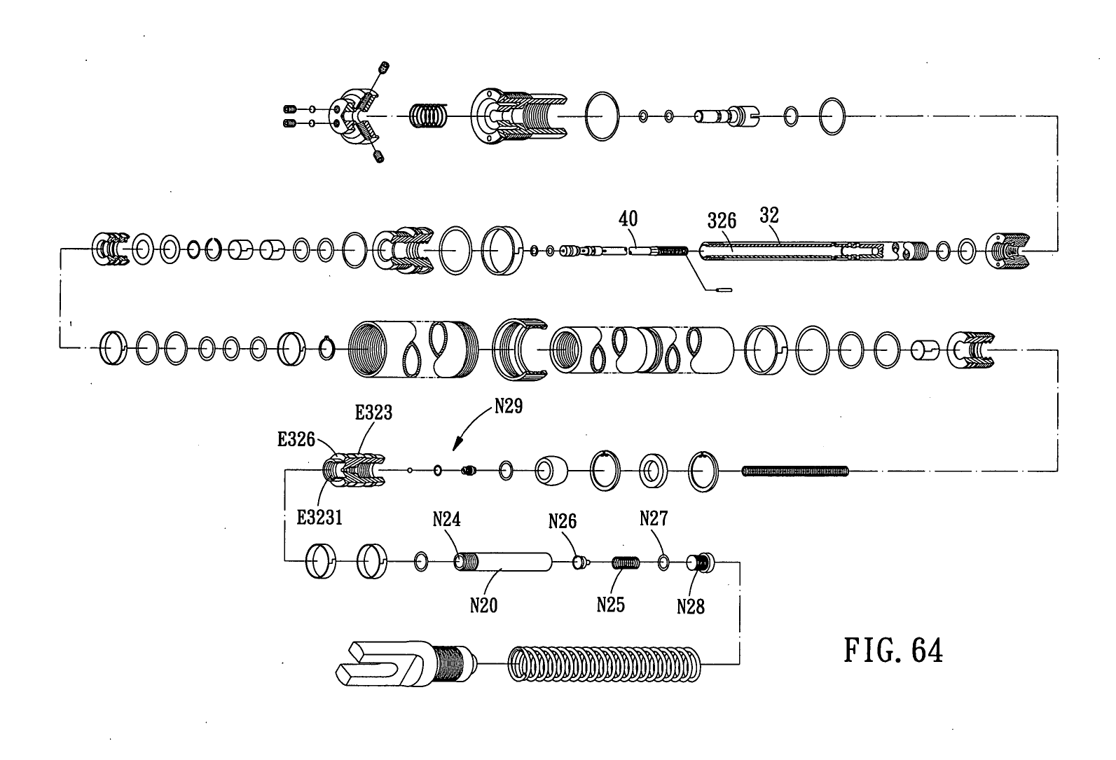

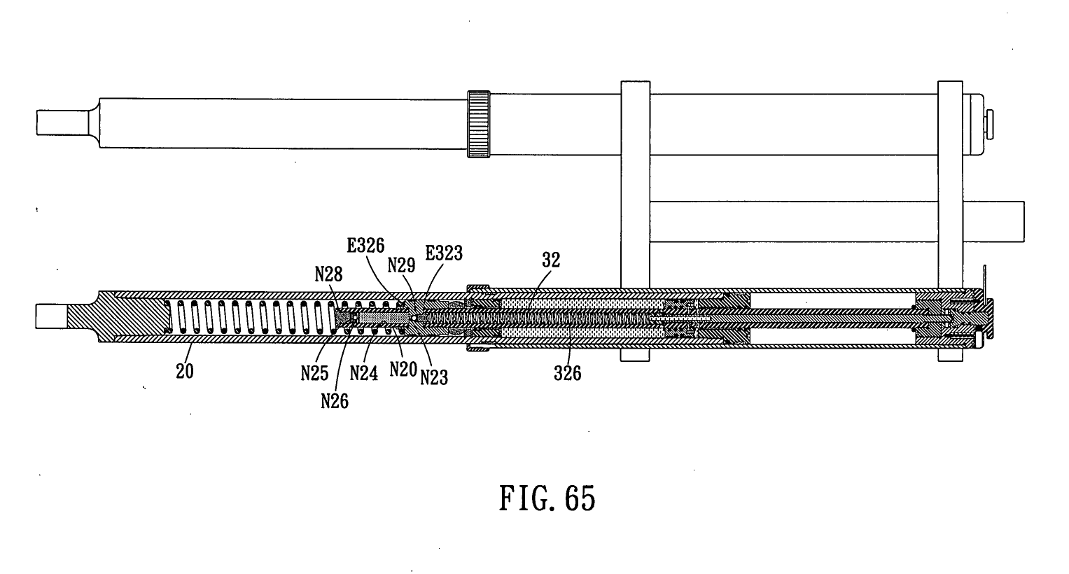

Referring to FIGS. 64 and 65, an oil shock absorber in accordance with a seventeenth embodiment of the present invention is shown, and it is revised from the oil shock absorber of the sixteenth embodiment, therefore, in the following, only the differences are explained.

The oil shock absorber in this embodiment is additionally provided with oil feeding assembly N2 which is disposed in the housing 20 of the damper assembly B. The oil feeding assembly N2 comprises an oil feeding cylinder N20, an oil-feeding passage N23, oil-feeding bore N24, an oil-feeding spring N25, plug N26, oil seal N27 and a cap N28. The oil-feeding passage N23 is formed in the leak proof cap E323, at the same end of the leak proof cap E323 as the spring retaining portion E326 are provided inner threads E3231 which are screwed with the oil feeding cylinder N20. The oil feeding bore N24 is formed in the oil feeding cylinder N20. The oil feeding passage N23 is connected to between the bore 326 of the shaft 32 and the oil feeding bore N24. The oil feeding bore N24 is provided at its end with inner threads N241 in which are disposed the oil feeding spring N25, the plug N26, the oil seal N27 and the cap N28. The oil-feeding assembly N2 uses the oil feeding spring N25 to move the plug N26, so as to replenish the oil from the oil feeding oil cylinder N20. The oil feeding passage N23 is connected to the oil feeding bore N24 and provided with a check valve N29 which allows unidirectional flow of the oil into the bore 326 of the shaft 32.

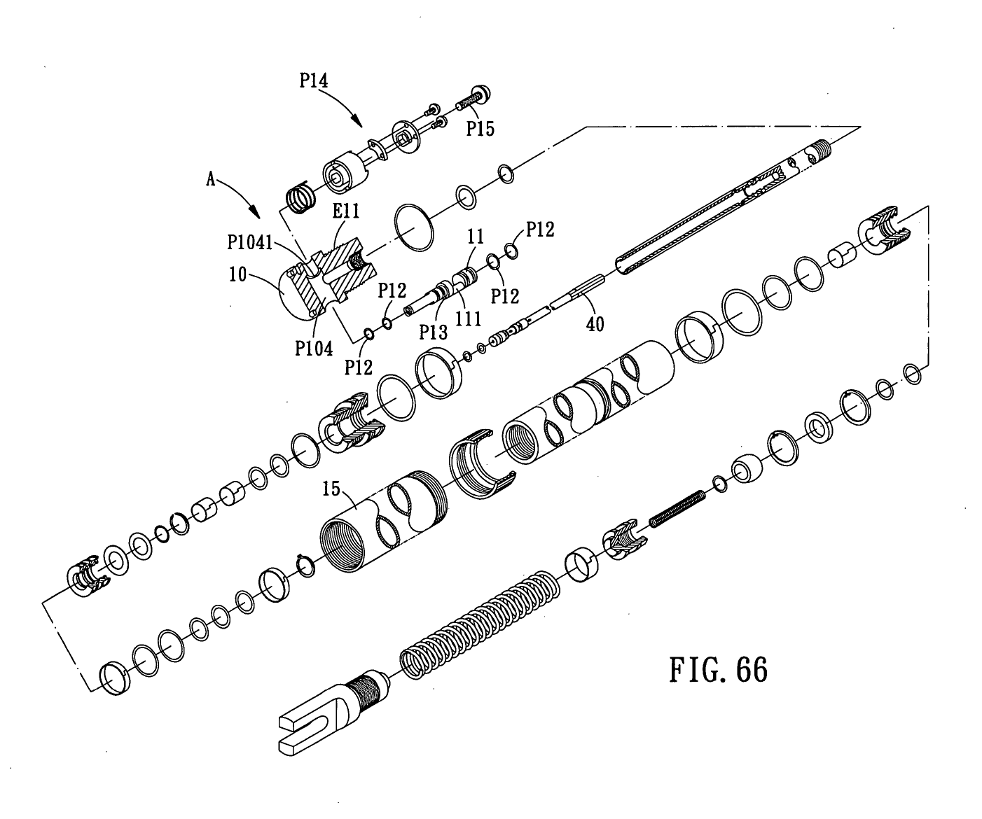

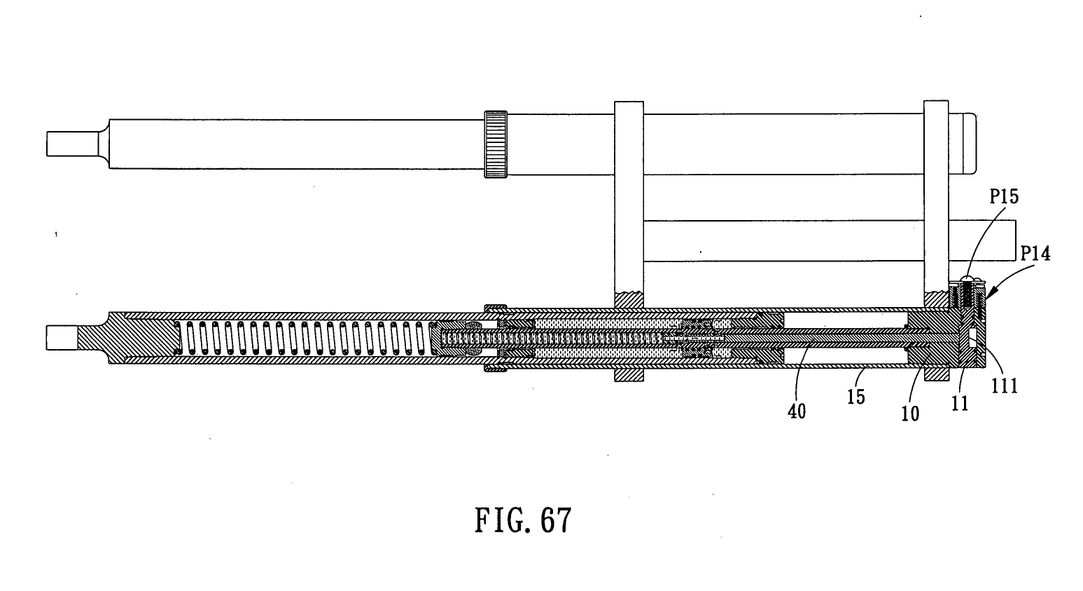

Referring to FIGS. 66 and 67, an oil shock absorber in accordance with a eighteenth embodiment of the present invention is revised by combining the control shaft 11 with the seventh embodiment, therefore, in the following, only the differences are explained.

The base 10 of the control assembly A is provided on the outer surface thereof with outer threads E11 for screwing with the sleeve 15 and a control hole P104, in the control hole P104 is formed an inner step portion P1041.

The control shaft 11 is sealed in the control hole P104 by an oil seal P12 and is free to rotate therein. An outer step portion P13 is provided at an end of the control shaft 11 and is positioned with the inner step portion P1041 in the control hole P104, and this end of the control shaft 11 is screwed with the rotary button P14 by a screw P15. An eccentric abutting portion 111 formed on the control shaft 11 and located close to the center thereof is used to move the control valve rod 40 of the moving assembly C.

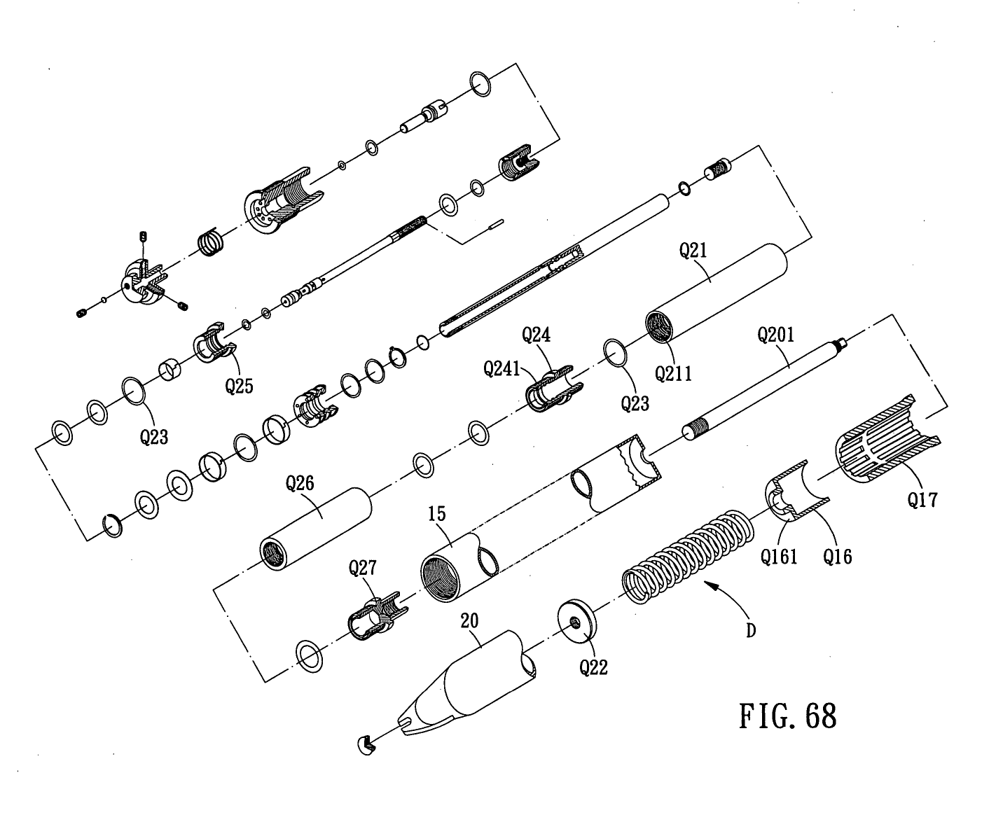

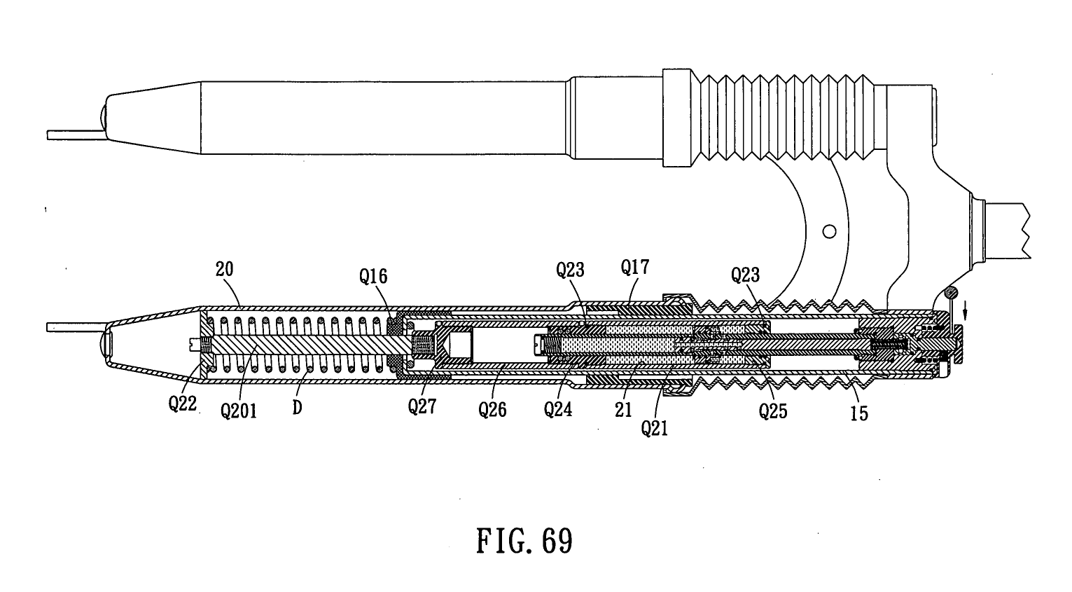

Referring to FIGS. 68 and 69, an oil shock absorber in accordance with a nineteenth embodiment of the present invention is revised by reversing the connection between the sleeve 15 and the sleeve B of the second embodiment, and the retainer Q201 is used to fix the oil cylinder Q21 in the housing 20 of the damper B, therefore, in the following, only the differences are explained.

An end of the sleeve 15 is screwed to the control assembly A, and another end of the sleeve 15 is movably received in the housing 20 of the damper assembly B by using a sliding bush Q16 and a mid-bush Q17. At the bottom of the sliding bush Q16 is provided a spring retaining portion Q161, and a bedplate Q22 is disposed close to the bottom of the housing 20. The buffering spring D is biased between the spring retaining portion 161 of the sliding bush Q16 and the bedplate Q22.

The oil cylinder Q21 is provided with a bore 21, and at both ends of the bore 21 are formed inner threads Q211 for screwing together the first and the second leak proof member Q24, Q25 by using an oil seal Q23. The first leak proof member Q24 is provided at another end thereof with outer threads Q241 for screwing with a positioning sleeve Q26 whose another end is screwed a connecting member Q27. The connecting member Q27 is connected with the retainer Q201. Another end of the retainer Q201 is fixed on the bedplate Q22.

The oil shock absorber of this embodiment also can operate in the same manner of the second embodiment.

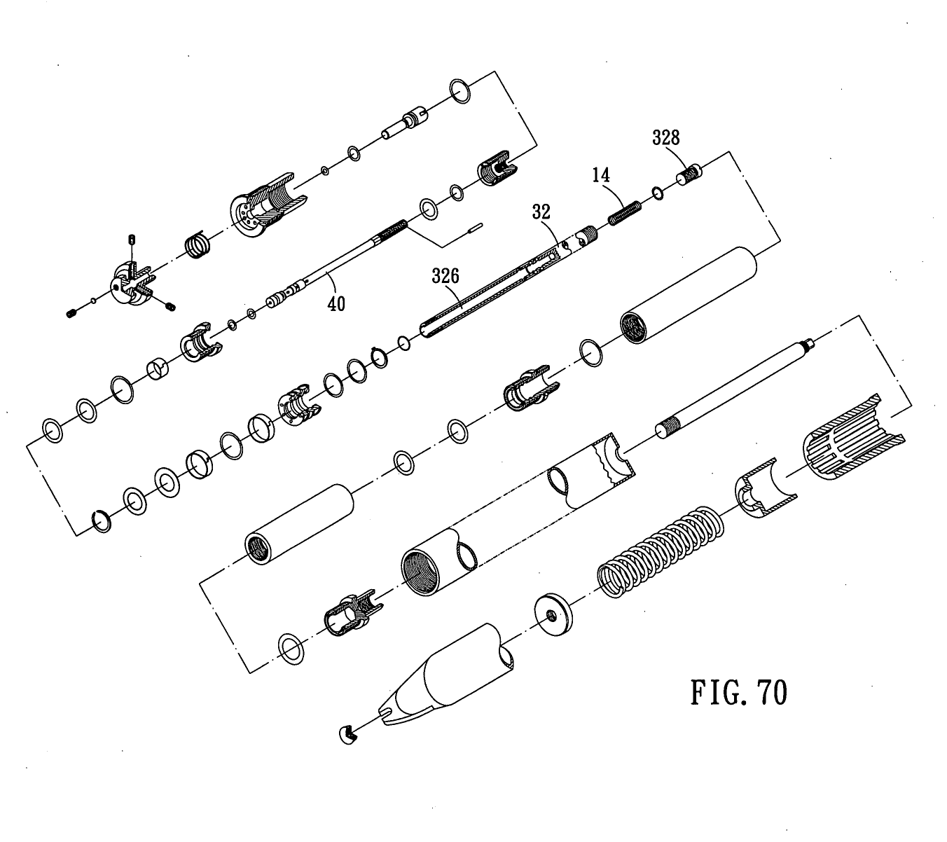

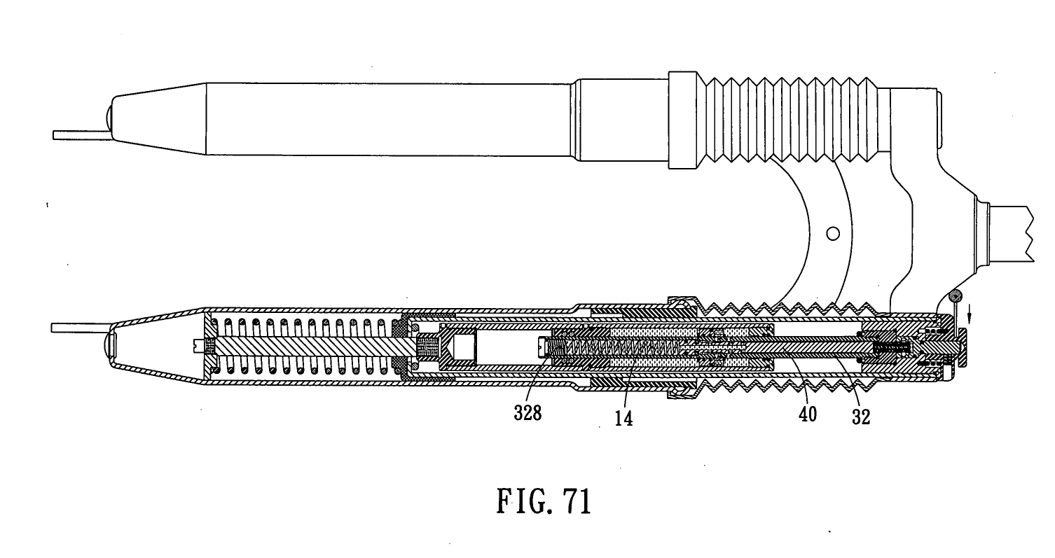

Referring to FIGS. 70 and 71, an oil shock absorber in accordance with a twentieth embodiment of the present invention is revised from the nineteenth embodiment by adding a control spring 14, therefore, in the following, only the differences are explained.

The control spring 14 is received in the bore 326 of the shaft 32 and biased between the control valve rod 40 and the leak proof screw 328, the control spring 14 pushes the control valve rod 40 with its elastic force so as to eliminate the clearances between the respective motion-transmitting components.

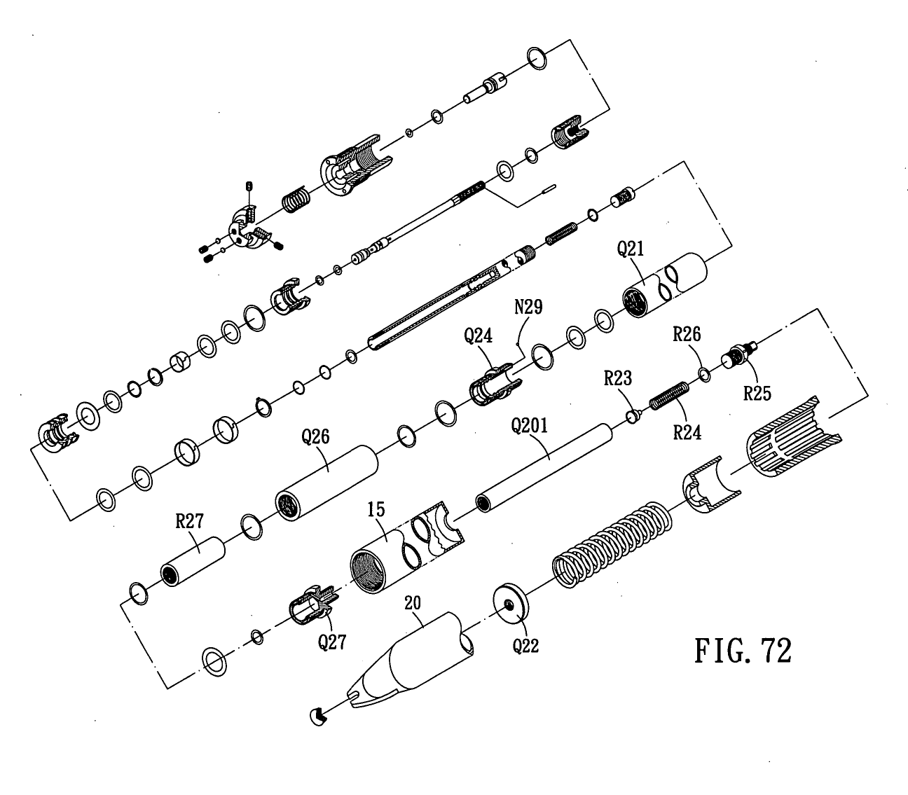

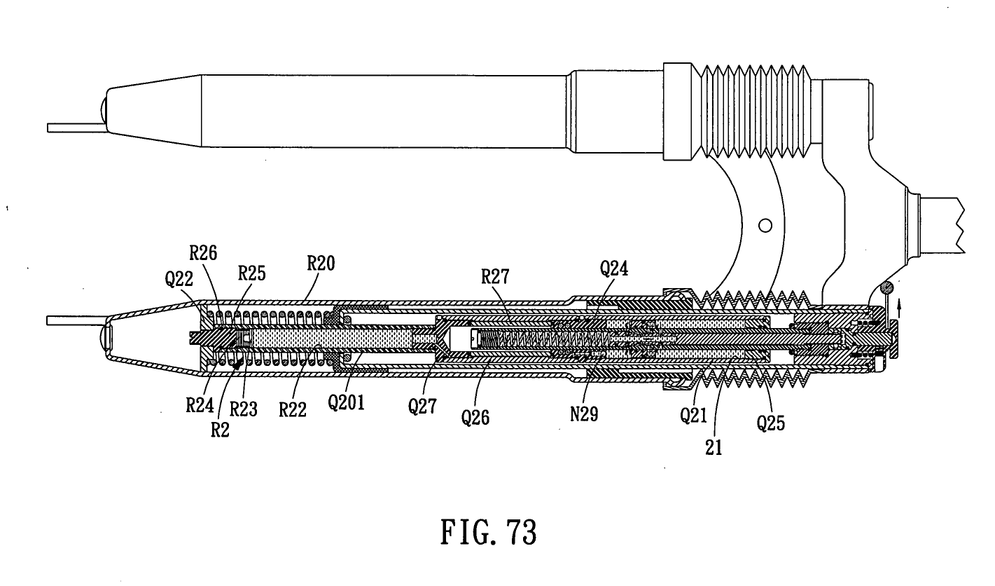

Referring to FIGS. 72 and 73, an oil shock absorber in accordance with a twenty first embodiment of the present invention is revised by adding an oil feeding assembly R2 to the twentieth embodiment, therefore, in the following, only the differences are explained.

The oil shock absorber in this embodiment is additionally provided with oil feeding assembly R2 which is disposed in the housing 20 of the damper assembly B, and the bore of the retainer Q201 acts as an oil feeding bore R22 in which are disposed a plug R23 and an oil feeding spring R24 which are sealed therein by screwing a screw R25 and an oil seal R26 in the inner threads R221 of the oil feeding bore R22 of the retainer Q201. Another end of the screw R25 is screwed to the bedplate Q22 of housing 20. Another end of the oil feeding bore R22 is screwed with the connecting member Q27 by cooperating with an oil seal. The connecting member Q27 is connected to the positioning sleeve Q26 through an oil seal. The positioning sleeve Q26 is connected to the first leak proof member Q24 of the damper assembly B by cooperating with an oil seal. In the positioning sleeve Q26 is provided oil feeding tube R27, and the space between the inner surface of the positioning sleeve Q26 and the outer surface of the oil feeding tube R27 works as an oil feeding passage N23 which enables the oil feeding bore R22 to be connected to the bore 21, and in the first leak proof member Q24 is also provided an oil feeding passage N23 in which is arranged a check valve N29.

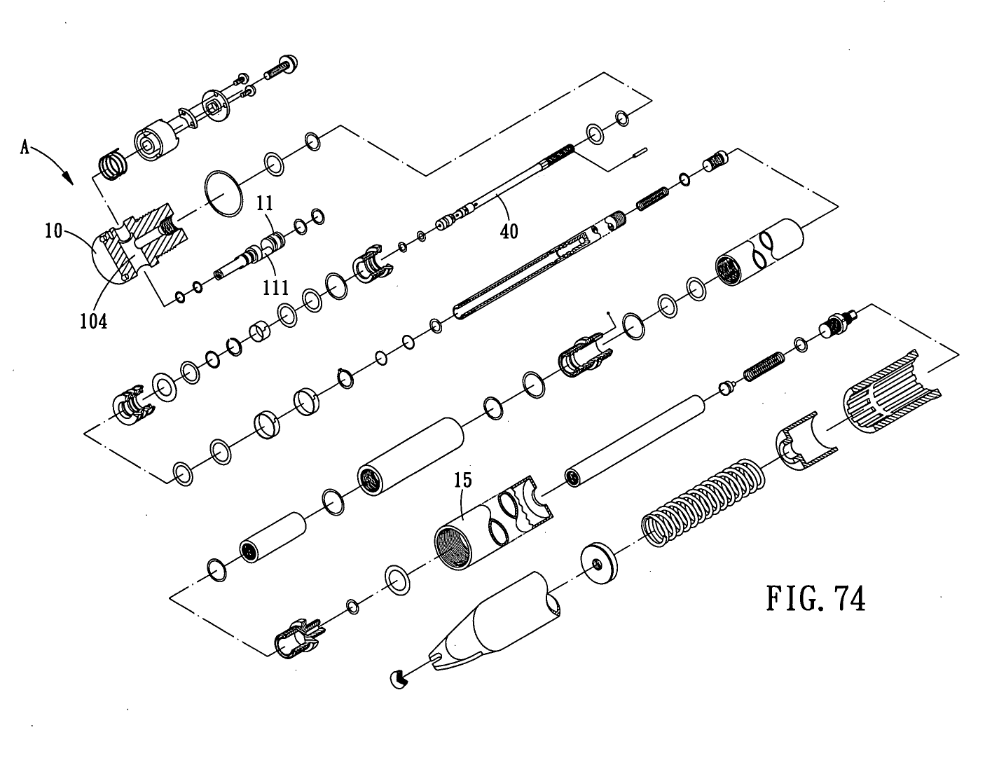

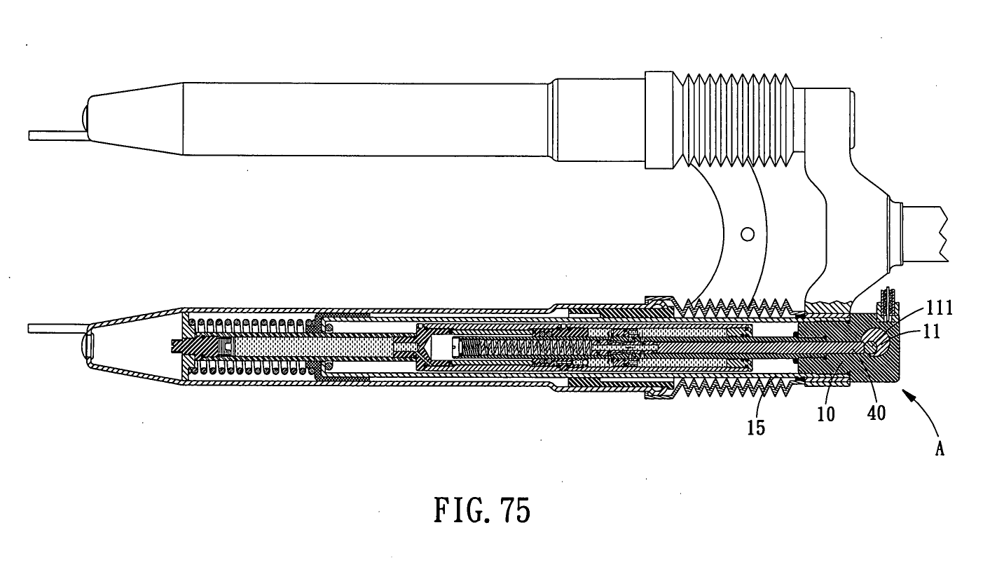

Referring to FIGS. 74 and 75, an oil shock absorber in accordance with a twenty-second embodiment of the present invention is revised by using the control shaft in the eighteenth embodiment, therefore, in the following; only the differences are explained.

The base 10 of the control assembly A is screwed to an end of the sleeve 15.

The control shaft 11 is sealed in the control hole P104 by an oil seal P12 and is free to rotate therein. An eccentric abutting portion 111 formed on the control shaft 11 is used to move the control valve rod 40 of the moving assembly C.

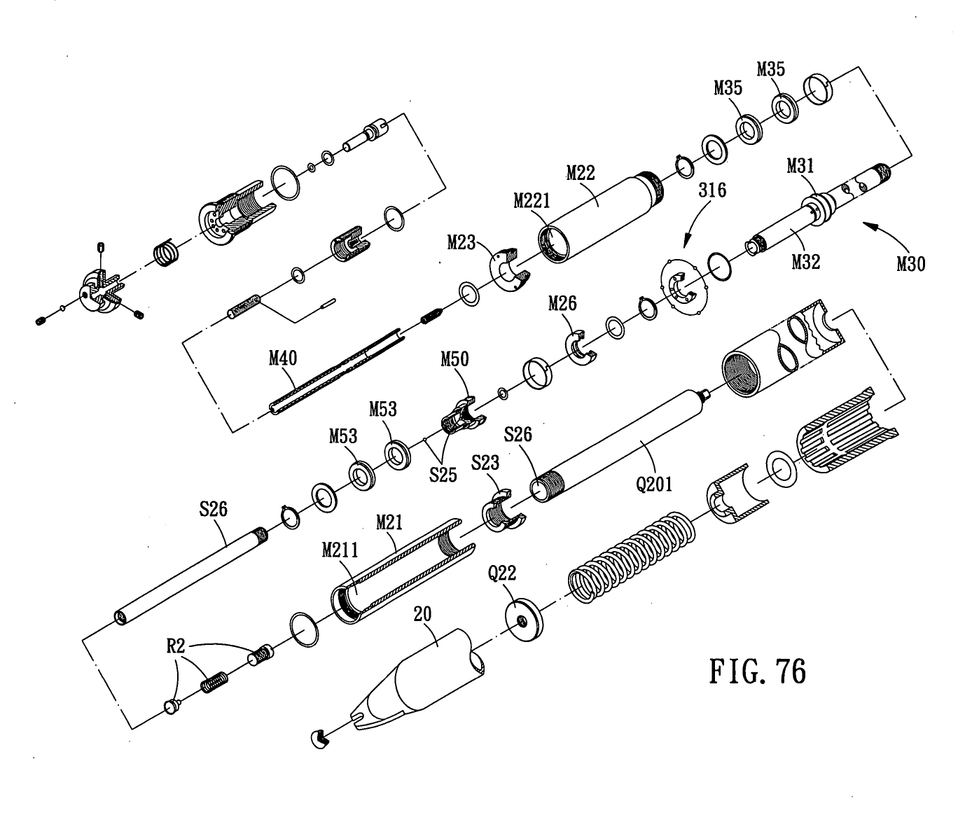

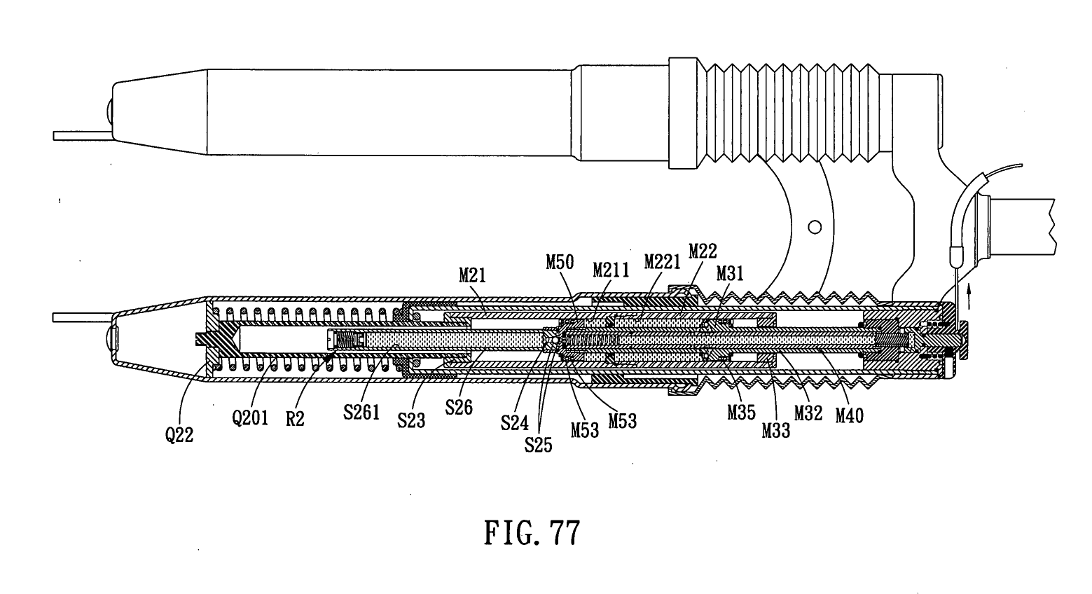

Referring to FIGS. 76 and 77, an oil shock absorber in accordance with a twenty-third embodiment of the present invention is revised by applying the first oil cylinder M21, the second oil cylinder M22, and the assembly consisted of the piston unit M30, the control valve rod M40 and the leak proof seat M50 of the fourteenth embodiment to the twenty-first embodiment, therefore, in the following, only the differences are explained.

A ring M26 is screwed between the first oil cylinder M21 and the second oil cylinder M22, at the bottom of the first oil cylinder M21 is screwed a lower ring S23 whose another end is connected to the retainer Q201. Another end of the retainer Q201 is screwed to the bedplate Q22 of the housing 20. An annular screw member M23 is screwed to the front end of the second oil cylinder M22. The moving assembly C comprises a piston unit M30, a control valve rod M40 and a leak proof seat M50. The piston M31 of the piston unit M30 comes into tight contact with the second oil cylinder M22 through oil seal M35 and a check valve 316 and is free to move in the bore M221 thereof. An end of the leak proof seat M50 is screwed to the shaft M32 and is free to move in the bore M211 of the first oil cylinder M21 by cooperating with an oil seal M53. Another end of the leak proof seat M50 is provided with an oil feeding passage S24 to be screwed with the check valve S25 and an oil feeding cylinder S26 whose bore S261 is in communication with the bore M211, M221 of the first and the second oil cylinders M21, M22. In the bore S261 of the oil feeding cylinder S26 is disposed an oil feeding assembly R2.

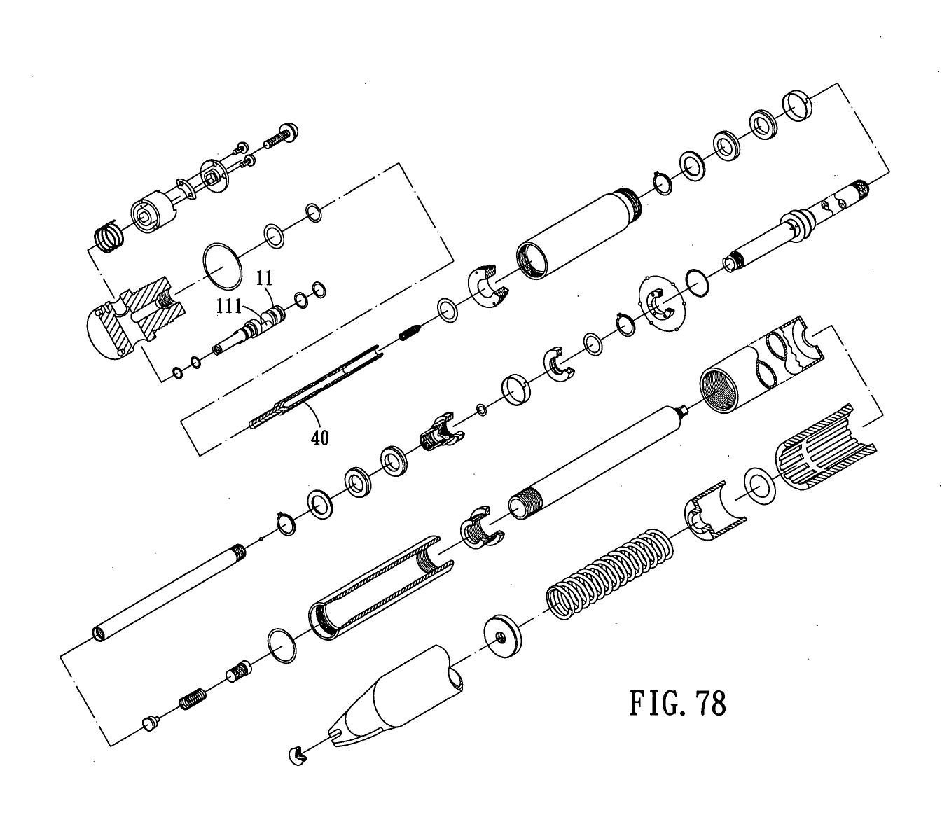

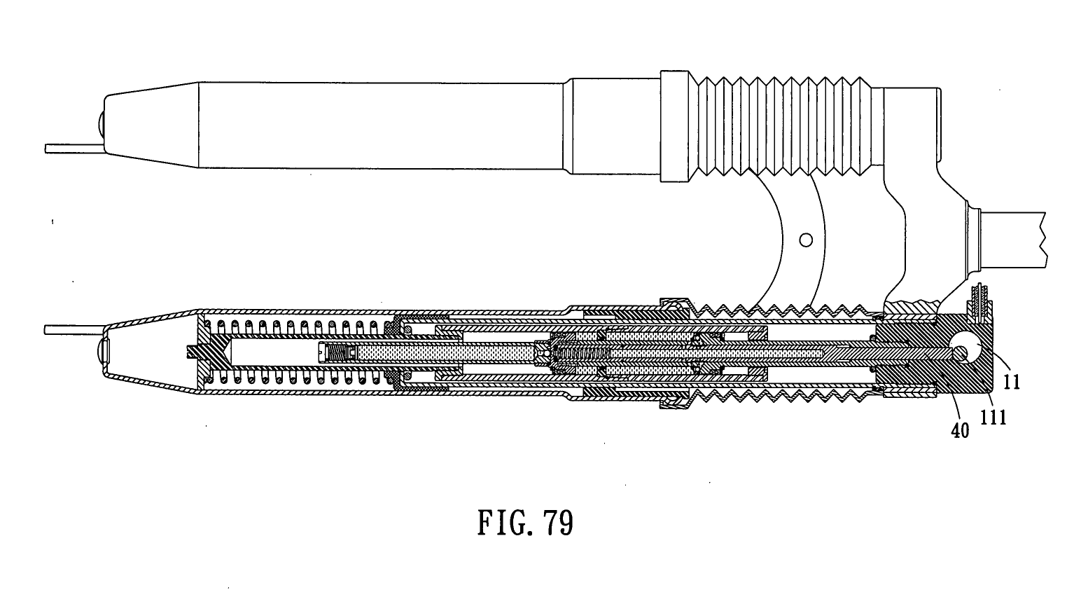

Referring to FIGS. 78 and 79, an oil shock absorber in accordance with a twenty-fourth embodiment of the present invention is revised by applying the control shaft 11 of the eighteenth embodiment to the twenty-third embodiment, therefore, in the followings, only the differences are explained.

The control shaft 11 also uses the eccentric abutting portion 111 to pushes the control valve shaft 40 to move, and thus, the buffering force of the oil shock absorber can be adjusted.

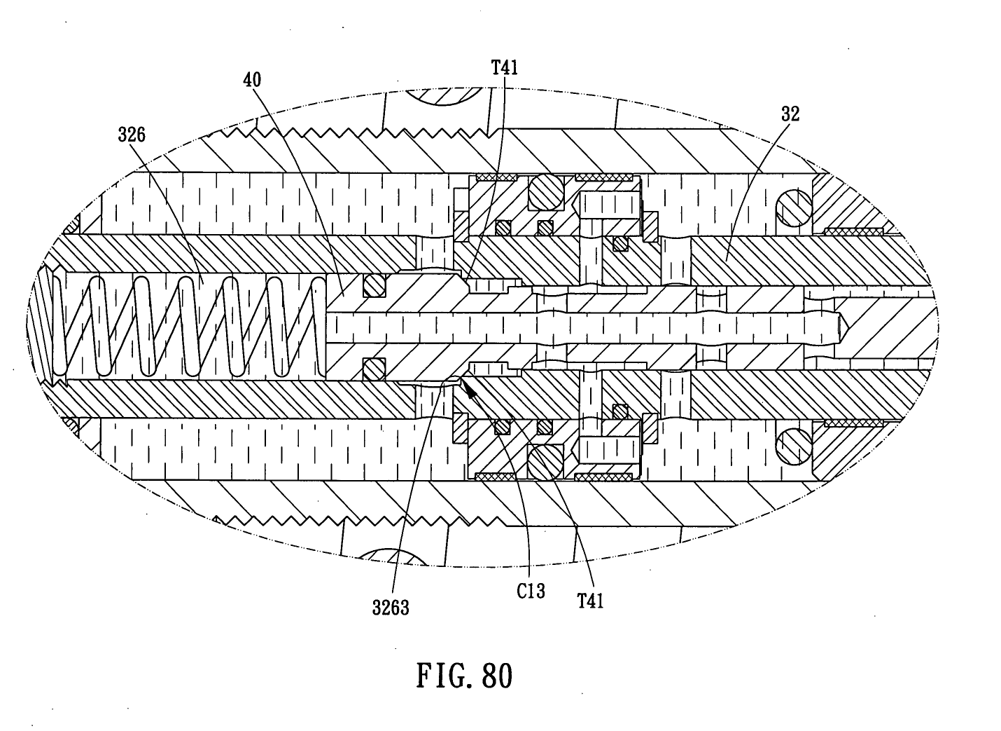

Referring to FIG. 80, which shows an oil shock absorber in accordance with a twenty-fifth embodiment of the present invention, the valve C13 of the control valve rod 40 of the previous embodiment can be provided with a slant surface T41 for cooperating with the valve port 3263 in the bore 326 of the shaft 32 of the moving assembly C, the slant surface T41 can be precisely machined up to a precise size by precision machining. Therefore, the buffering force can be fixed when the slant surface T41 abuts against the valve port 3263 in the bore 326 of the shaft 32 of the moving assembly C.

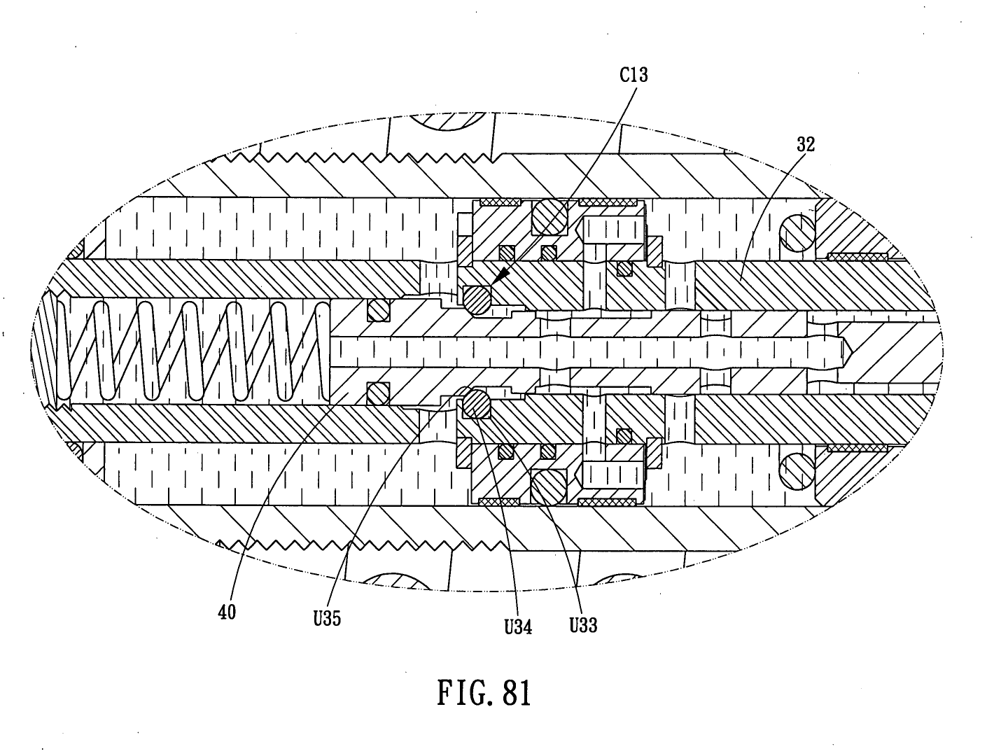

Referring to FIG. 81, which shows an oil shock absorber in accordance with a twenty-sixth embodiment of the present invention, in the valve port 3263 in the bore 326 of the shaft 32 of the moving assembly C of the previous embodiment can be defined an annular groove U33 in which is disposed an oil seal U34. Therefore, the buffering force can be fixed when the slant surface U35 of the valve C13 of the control valve rod 40 abuts against the oil seal U34 in the valve port 3263 in the bore 326 of the shaft 32 of the moving assembly C.

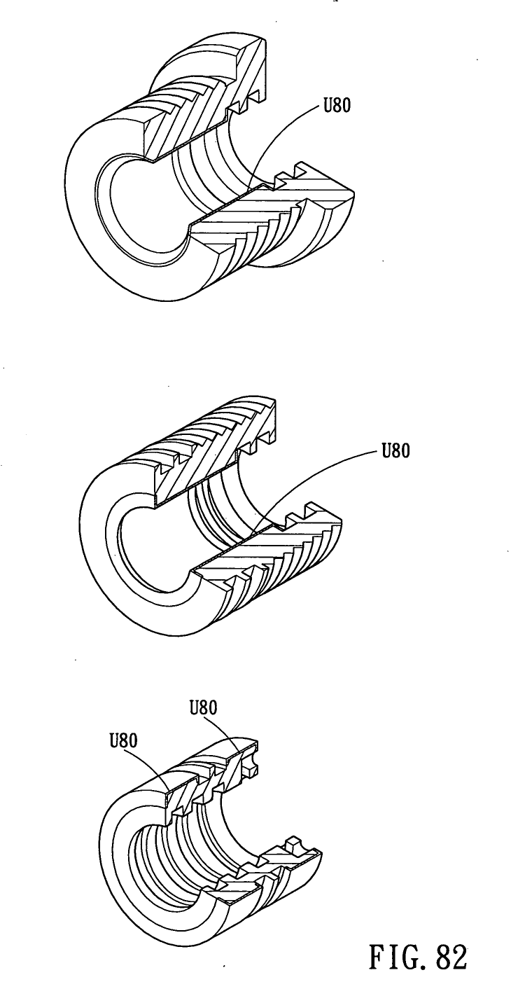

Referring to FIG. 82, which shows an oil shock absorber in accordance with a twenty-seventh embodiment of the present invention, the sliding components of the respective embodiments can be coated on the outer and the inner surfaces thereof with friction-resistant material U80, so as to improve the connecting effect of the sliding components relative to the contacting surface of the corresponding components.

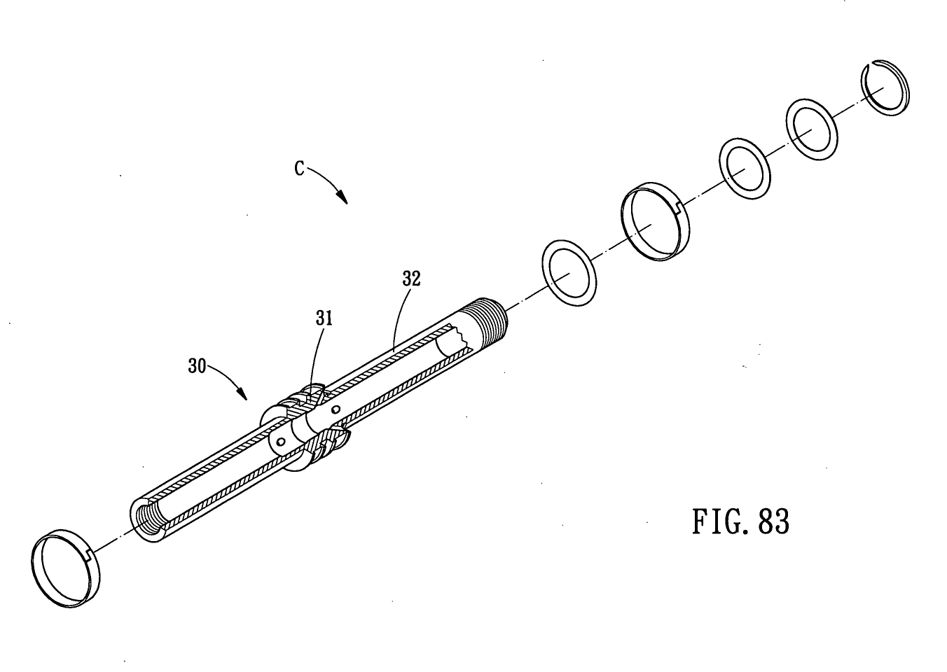

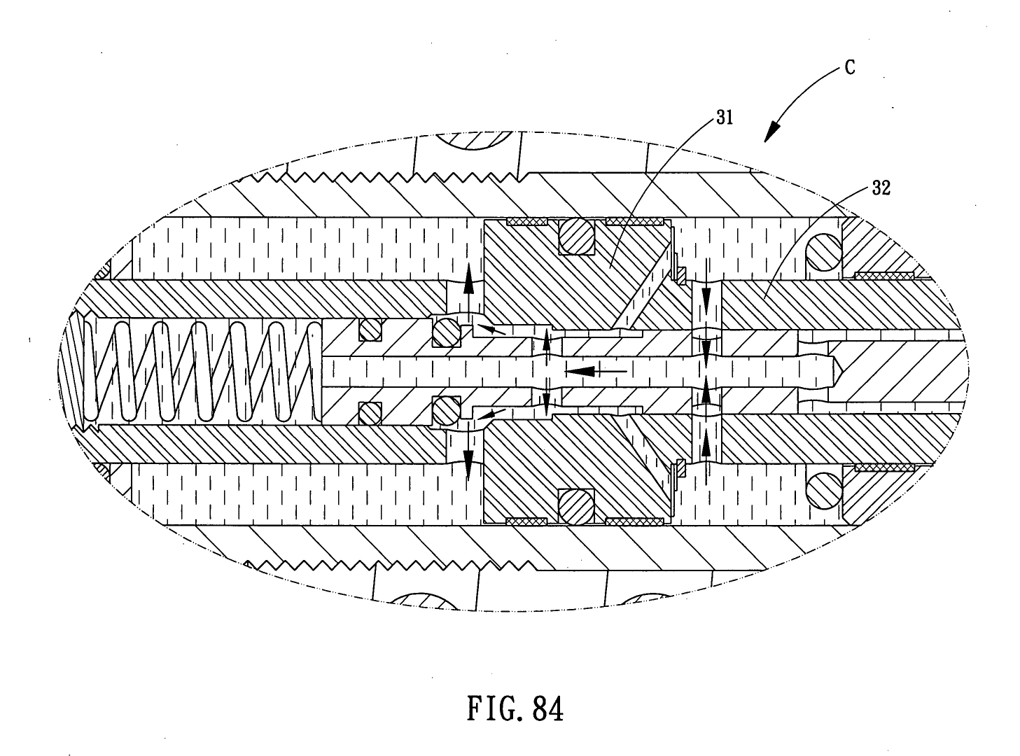

Referring to FIGS. 83 and 84, which show an oil shock absorber in accordance with a twenty-eighth embodiment of the present invention, the piston 31 and the shaft 32 of the piston unit 30 in the previous corresponding embodiments can be integrally formed together.

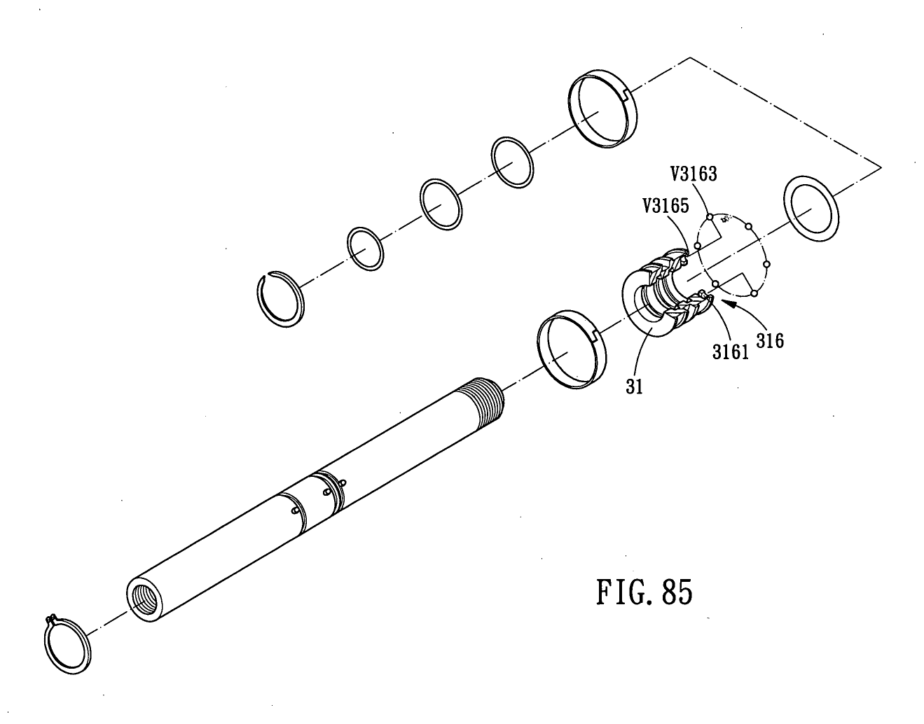

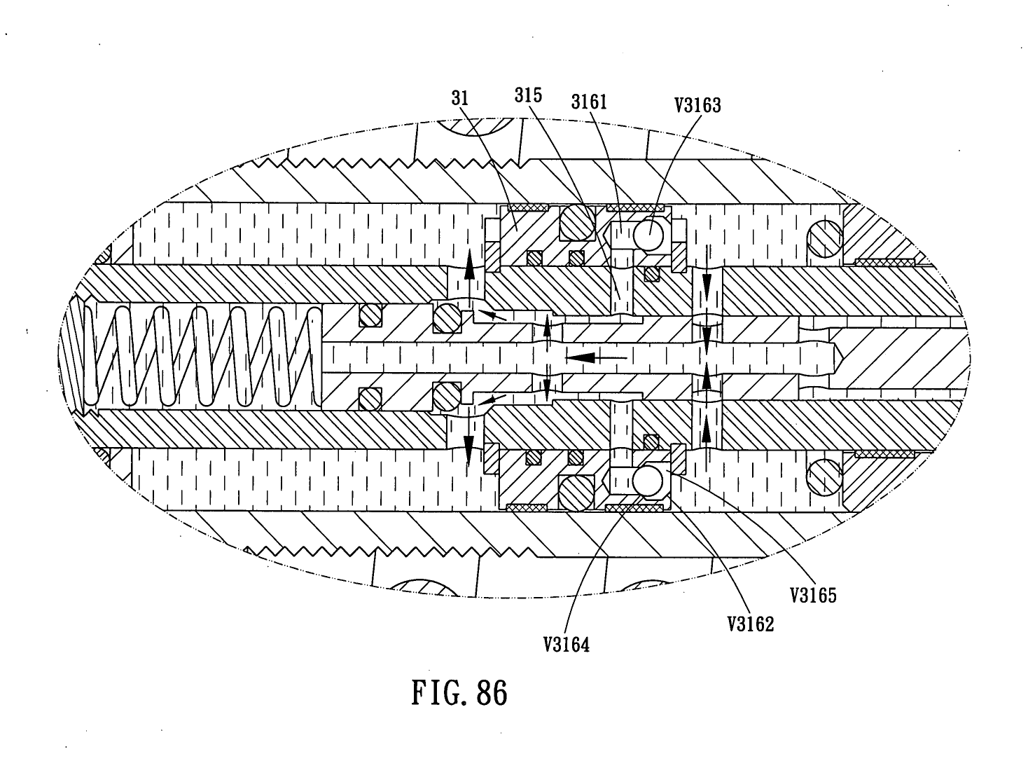

Referring to FIGS. 85 and 86, which show an oil shock absorber in accordance with a twenty-ninth embodiment of the present invention, the valve 3163 of the check valve 316 of piston 31 in the previous corresponding embodiments can be such a structure that has valve balls V3163 which are received in the check valve port 3161, and the end surface of the check valve port 3161 is provided with concave deformations V3162 for confining the motion of the valve balls V3163 in the check valve port 3161. The end of the check valve port 3161 connected to the annular oil groove 315 is a close mouth V3164, and another end of the check valve port 3161 is an open mouth V3165. Therefore, the check valve 316 will be closed when the valve balls V3163 move toward the close mouth V3164, and the check valve 316 will be opened when the valve balls V3163 move close to the open mouth V3165.

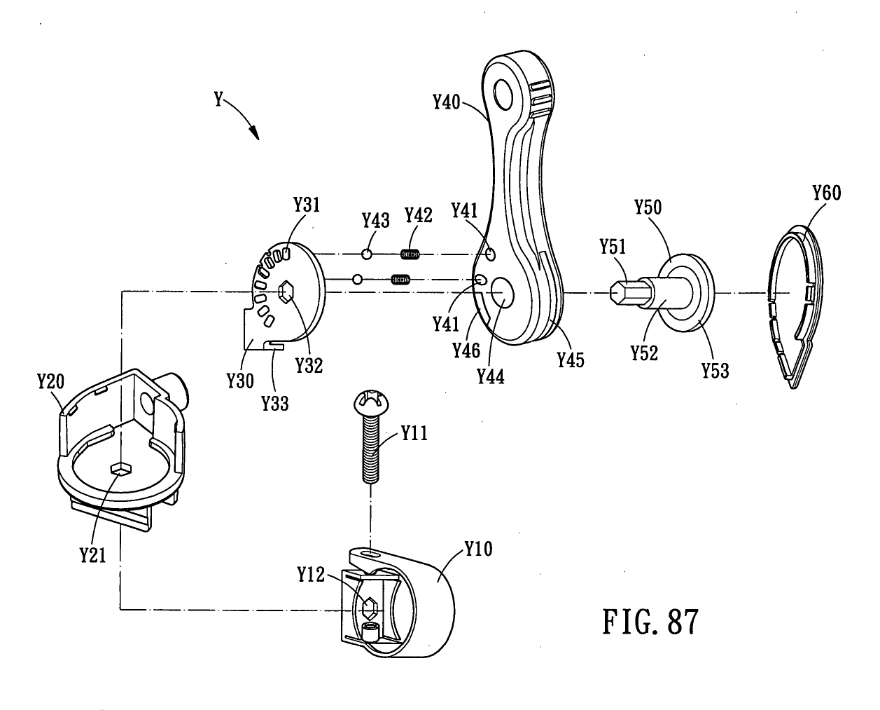

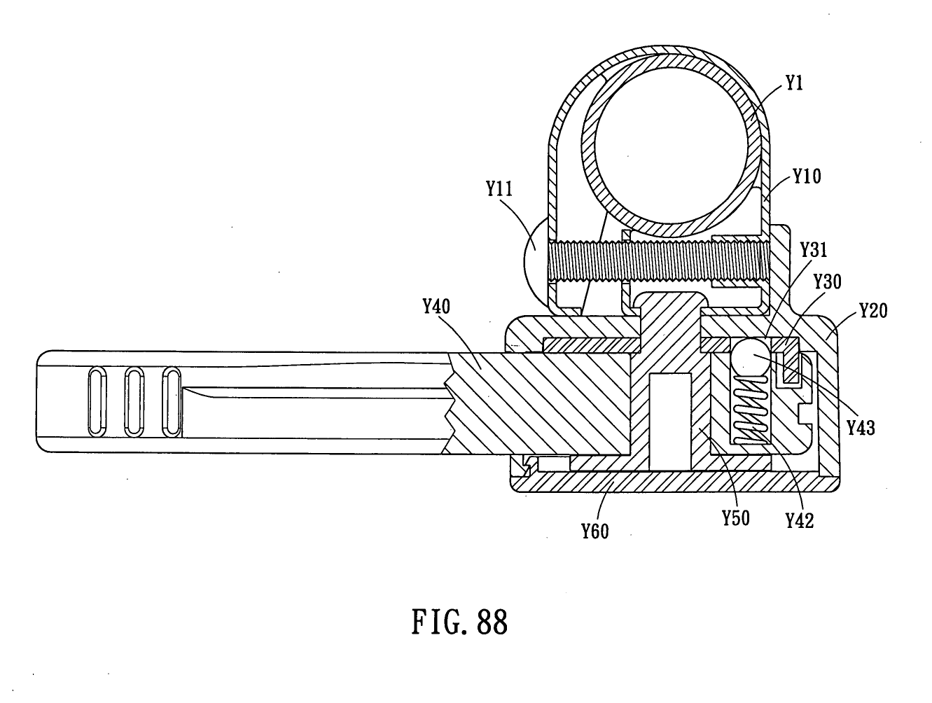

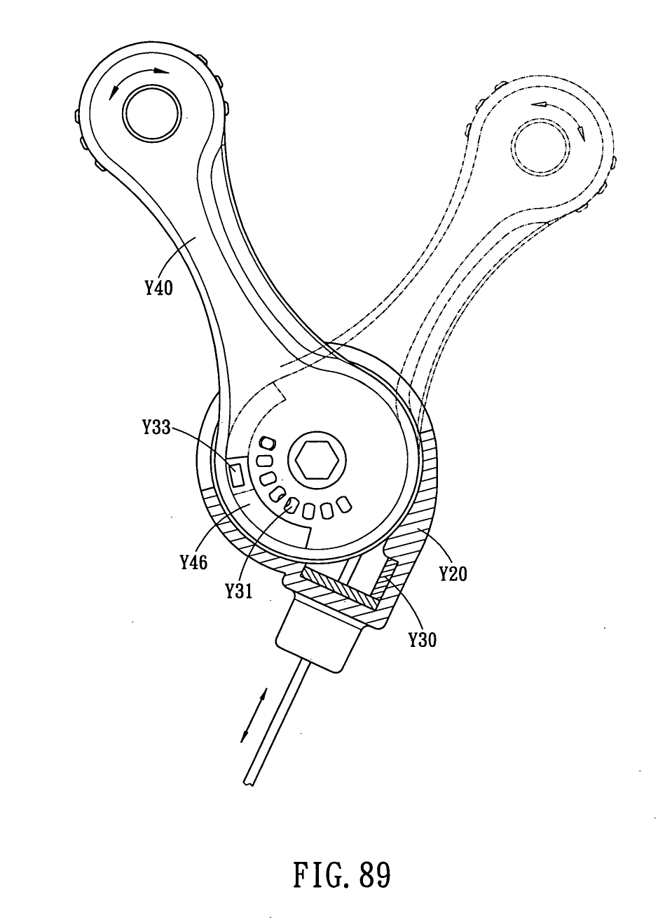

Referring to FIGS. 87-89, which show an oil shock absorber in accordance with a thirtieth embodiment of the present invention, in this embodiment, a steel cord positioning assembly Y is used to position the steel cord T.

The steel cord positioning assembly Y is fixed on the handlebar Y1 and comprises a seat Y10, a cover Y20, a positioning seat Y30, a handle Y40, screw Y50 and lower cover Y60.

The seat Y10 is attached to the handlebar of a bicycle using a screw Y11, in the seat Y10 is defined a hexagonal hole Y12.

The cover Y20 is interiorly defined with a hexagonal hole Y21.

The positioning seat Y30 is provided with elongated holes Y31 in which is received a hexagonal hole Y32, at the end thereof is defined a positioning flange Y33.

The handle Y40 is provided with blind holes Y41 in each of which is received a spring Y42 and a steel ball Y43. On the handle Y40 is further provided with an inner hole Y44. And end of the steel cord is positioned on the outer peripheral surface of the handle Y40, and on the end surface of the handle Y40 is defined a positioning groove Y46 for engaging with the flange Y33 of the positioning seat Y30.

On an end of the outer diameter of the screw Y50 is provided a hexagonal rod Y51 which is inserted to the hexagonal holes Y12, Y21, Y32 of the cover Y20 and the positioning seat Y30. The outer diameter of the screw Y50 close to the mid portion thereof is inserted in the inner hole Y44 of the handle Y40. Another end of the outer diameter of the screw Y50 is provided with an annular flange Y53 serving to position the handle Y40.

The lower cover Y60 serves to engage with the bottom of the cover Y20.

When the user rotates the handle Y40 to pull the steel cord, the spring Y42 will push the steel balls Y43 into one of the elongated hole Y31 of the positioning seat Y30, so that the steel cord is fixed. Meanwhile, the flange Y33 of the positioning seat Y30 will cooperate with the positioning grooves Y46 of the handle Y40 to limit the rotation angle of the handle Y40.

While we have shown and described various embodiments in accordance with the present invention, it should be clear to those skilled in the art that further embodiments may be made without departing from the scope of the present invention.

What is claimed is:

1. An oil shock absorber comprising a control assembly, a moving assembly, a damper assembly and a buffering spring, the buffering spring serving to provide elastic buffering force for respective components of the oil shock absorber; wherein:
the control assembly includes a control shaft;
the moving assembly includes a piston unit and control valve rod, the piston unit comprises a piston and a shaft which are disposed in the damper assembly, the piston and the shaft serve to control flow of oil, the control valve rod is disposed in the shaft and is moved by the control shaft of the control assembly, the piston unit is provided with guiding holes, the control valve rod is provided with holding portions corresponding to the guiding holes, the holding portions of the control valve rod are used to adjust opening size of the guiding holes, a motion of the shaft with respect to the control valve rod creates a valve which is opened and closed by displacement of the control valve rod, therefore, user can adjust buffering force of the oil shock absorber and turn the oil shock absorber on and off according real road condition, at any time.

2. The oil shock absorber as claimed in claim 1, wherein the control shaft is provided in the control assembly, the damper assembly is provided with an oil cylinder, the piston unit and the shaft of the moving assembly are moveably disposed in the oil cylinder, the guiding holes are formed on the shaft of the piston unit, and in a bore of the shaft of the piston unit is provided a valve port, the control valve rod is disposed in the bore of the shaft of the piston unit and moves under the control of the control shaft of the control assembly, on an outer diameter of the control valve rod are provided the holding portions and the valve, the holding portions of the control valve rod are used to change the opening size of the guiding holes of the shaft of the piston unit, thus adjusting the buffering force of the oil shock absorber, the valve will be closed when the valve of the control valve rod abuts against the valve port of the valve of the shaft of the piston unit, and it will be closed when the valve of the control valve rod moves away from the valve port of the valve of the shaft of the piston unit.

3. The oil shock absorber as claimed in claim 2, wherein a leak proof member is disposed at either end of the oil cylinder, the piston unit, a check valve unit and the shaft of the moving assembly are moveably disposed in the oil cylinder, both ends of the shaft of the piston unit are inserted in the leak proof members of the oil cylinder, so as to create a first oil chamber and a second oil chamber in the oil cylinder of the damper assembly, the oil flows between the first and the second oil chambers via the guiding holes and the valve port on the shaft of the piston unit, and the control valve rod is disposed in the bore of the shaft of the piston unit under the control of the control shaft of the control assembly.

4. The oil shock absorber as claimed in claim 1, wherein the control shaft of the control assembly can rotates under control, an eccentric abutting portion is formed on the outer diameter of the control shaft and is used to push the control valve rod to move.

5. The oil shock absorber as claimed in claim 1, wherein a displacement threaded hole is formed in a base of the control assembly, an elongated groove is formed on the control shaft of the control assembly, at an end of the control valve rod are formed displacement threads for meshing with the displacement threaded hole of the base of the control assembly, a pin is provided at the same side on the control valve rod as the displacement threads, the elongated groove of the control shaft of the control assembly drives the pin to rotate so that the control valve rod is rotated, therefore, rotation of the displacement threads in the displacement threaded hole of the control assembly will effect a displacement of the control valve rod.

6. The oil shock absorber as claimed in claim 1, wherein a bevel gear is provided at a side of the control shaft of the control assembly, an annular screw member and a sleeve are disposed in the shaft of the piston unit, the annular screw member is defined with a displacement threaded hole, another bevel gear is disposed at an end of the sleeve, in the sleeve are provided motion-transmitting surfaces, at an end of the outer surface of the control valve rod are provided displacement threads and motion-transmitting surfaces, the bevel gear of the control shaft serves to rotate the bevel gear of the sleeve, the motion-transmitting surfaces of the sleeve will move together with the motion-transmitting surfaces of the control valve rod, consequently the displacement threads of the control valve rod will rotate in the displacement threaded hole of the annular screw member, thus causing a displacement of the control valve rod.

7. The oil shock absorber as claimed in claim 1, wherein a rotary button is disposed at an end of the control shaft of the control assembly and comprises a first rotary member, a second rotary member and a positioning block, at both sides of a bore of the first rotary member are formed flat surfaces, on outer surface of the rotary member is formed an arc groove, at both sides of a bore of the second rotary member are formed flat surfaces, the positioning block is disposed between the first rotary member and the second rotary member, the control shaft is provided at its end with a threaded hole, at both sides of the outer diameter of the threaded hole of the control shaft are formed flat surfaces, the flat surfaces in the bore of the first rotary member and the second rotary member serve to cooperate with the flat surfaces on the outer diameter of the threaded hole of the control shaft for transmitting motion.

8. The oil shock absorber as claimed in claim 3, wherein the check valve unit is provided with a check valve port and a valve, the piston is defined with a bore which is mounted onto the outer diameter of the shaft by using oil seals, the shaft is provided with a bore, on the shaft are provided a first guiding hole, a second guiding hole and a third guiding hole, a main oil passage and the valve port are formed in the bore of the shaft, a first holding portion, a second holding portion and the valve are provided on the outer diameter of the control valve rod, in the control valve rod is provided oil guiding passage, a first oil guiding hole is formed between the outer diameter and the oil guiding passage of the control valve rod, the first oil guiding hole is located in line with the first guiding hole of the shaft, adjacent to the first oil guiding hole is the first holding portion which is located in line with the first guiding hole, a second oil guiding hole is arranged between the outer diameter and the oil guiding passage of the control valve rod and located adjacent to the first holding portion, on the outer diameter of the control valve rod and adjacent to the second oil guiding hole is provided the second holding portion which is located in line with the main oil passage, the valve is formed on the outer diameter of the control valve rod adjacent to the second holding portion and located in line with the valve port in the bore of the shaft, the first holding portion of the control valve rod serves to adjust the opening size of first guiding hole, so as further to adjust the buffering force of the oil shock absorber, the second holding portion of the control valve can adjust oil-flowing space of the main oil passage, so as further to adjust oil flow resistance, the buffering function of the oil shock absorber will be turned off when the valve on the outer diameter of the control valve abuts against the valve port of the shaft of the piston unit, and the buffering function of the oil shock absorber will be turned on when the valve on the outer diameter of the control valve moves away from the valve port of the shaft of the piston unit.

9. The oil shock absorber as claimed in claim 1, wherein the base of the control assembly is provided with an oil feeding assembly comprising a feed passage, an oil feeding cylinder, a plug and an oil-feeding check valve, the oil feeding cylinder is in communication with the oil cylinder of the damper assembly, the spring serves to move the plug, so as to feed the oil to the oil cylinder of the damper assembly, the oil-feeding check valve is disposed between the oil-feeding cylinder and the oil cylinder of the damper assembly, the oil-feeding check valve make the oil in the oil-feeding cylinder flow to the oil cylinder of the damper assembly while preventing the oil in the oil cylinder of the damper assembly from flowing back to the oil-feeding assembly.

10. The oil shock absorber as claimed in claim 9, wherein a threaded hole is formed on the outer diameter of the oil-feeding cylinder, in the threaded hole is provided a viewport for enabling the user to observe oil level in the oil-feeding cylinder.

11. The oil shock absorber as claimed in claim 1, wherein the control assembly is provided with a storage hole for storage of an adjusting tool, on the base of the control assembly is formed a spring retaining portion, a housing of the damper assembly is provided with outer threads, and at an end of outer diameter of the housing is formed an engaging groove in which is received a retainer, a movable ring is provided with inner threads for meshing with the outer threads of the housing of the damper assembly, another spring retaining portion is formed at an end of the movable ring, so that the buffering spring is biased between the spring retaining portion of the base of the control assembly and the spring retaining portion of the moveable ring, on the outer diameter of the movable ring are formed locking portions, a rotary ring is mounted on the movable ring, at an end of the inner diameter of the rotary ring are formed locking portions for locking with the locking portions of the movable ring, at another end of inner diameter of the rotary ring are provided inner threads, and between the inner threads and the locking portions of the rotary ring are formed positioning surfaces, an annular screw nut is screwed with the inner threads of the rotary ring, an end surface of the annular screw nut and the positioning surfaces of the rotary ring are positioned by the retainer in the housing of the damper, so that the rotary ring is rotatable but not axially displaceable relative to the housing, the rotation of the rotary ring will give rise to a displacement of the adjusting ring relative to the housing of the damper assembly, so that the elastic force of the buffering spring is adjusted.

12. The oil shock absorber as claimed in claim 1, wherein the base of the control assembly is provided with oil feeding assembly comprising feed passage, oil feeding cylinder, plug and oil-feeding check valve, the oil feeding cylinder is in communication with the oil cylinder of the damper assembly, the spring serves to move the plug, so as to feed the oil to the oil cylinder of the damper assembly, the oil-feeding check valve is disposed between the oil-feeding cylinder and the oil cylinder of the damper assembly, the oil-feeding check valve make the oil in the oil-feeding cylinder flow to the oil cylinder of the damper assembly while preventing the oil in the oil cylinder of the damper assembly from flowing back to the oil-feeding assembly.

13. The oil shock absorber as claimed in claim 1, wherein a leak proof member is disposed at either end of the oil cylinder, the piston unit, a check valve unit and the shaft of the moving assembly are moveably disposed in the oil cylinder, both ends of the shaft of the piston unit are inserted in the leak proof members of the oil cylinder.

14. The oil shock absorber as claimed in claim 1, wherein the moving assembly includes the piston unit and the control valve rod, the piston unit comprises the piston and the shaft, the shaft is defined with a bore in which is formed a valve port, a valve is disposed at an end of the outer diameter of the control valve rod, and the valve is equipped with an oil seal, the oil shock absorber will be turned off when the oil seal of the valve on the control valve rod abuts against the valve port in the shaft.

15. The oil shock absorber as claimed in claim 1, wherein the valve is provide with a slant surface, and the oil shock absorber will be turned off when the slant surface abuts against the valve port of the shaft of the control assembly.

17. The oil shock absorber as claimed in claim 1, wherein two engaging grooves are formed on the outer diameter of the shaft, in each of the engaging grooves is received a retainer, the inner diameter of the piston is mounted onto the outer diameter of the shaft by using oil seals, the piston is positioned between the two engaging grooves by the retainer.

18. The oil shock absorber as claimed in claim 1, wherein the piston and the shaft of the piston unit are integrally formed together.

19. The oil shock absorber as claimed in claim 1, wherein the damper is provided with a first oil cylinder and a second oil cylinder, between the first and the second oil cylinders is screwed a ring and an oil seal is disposed in the ring;
the control valve rod, the piston unit and a leak proof seat of the moving assembly are moveably disposed in the first and the second oil cylinders, an end of the shaft of the piston unit is connected to the control assembly, and another end of the shaft passes through the inner diameter of the ring and is connected to the leak proof seat, the control valve rod is moveably inserted in the bore of the shaft, an end of the control valve rod moves under the control of the control shaft, another end of the control valve rod is provided with a contacting surface, inside the leak proof seat are provided an oil guiding blind hole in which, is disposed a valve, the oil shock absorber will be turned on when the contacting surface of the control valve rod moves away from the valve in the leak proof seat.

20. The oil shock absorber as claimed in claim 1, wherein a steel cord positioning assembly is used to control the steel cord so as further to control the control shaft of the control assembly, the steel cord assembly comprises: a seat, a cover, a positioning seat, a handle, screw and lower cover, in the seat is defined a hexagonal hole, the cover is interiorly defined with a hexagonal hole, the positioning seat is provided with elongated holes in which is received a hexagonal hole, the handle is provided with blind holes in each of which is received a spring and a steel ball, on the handle is further provided with an inner hole, an end of the screw is a hexagonal rod which is inserted to the hexagonal holes of the cover, and the positioning seat, the outer diameter of the screw close to the mid portion thereof is inserted in the inner hole of the handle.
